(19) United States
(12) Patent Application Publication
(10) Pub. No.: US 2026/0316510 A1
(43) Pub. Date: Oct. 15, 2026

(54) ADJUSTABLE SUSPENSION ASSEMBLIES AND METHODS OF USE THEREOF

(71) Applicant: POLARIS INDUSTRIES INC.., Medina, MN (US)

(72) Inventors: Adam J. Lemay, Jackson, MN (US); Andrew Smisek, Wyoming, MN (US); James Whisler, Wyoming, MN (US); Christopher M. Huntress, Plymouth, MN (US); Jonathon P. Graus, Stacy, MN (US); David D. Helgeson, Vadnais Heights, MN (US); Kyle W. Olson, Coon Rapids, MN (US); Justin T Anderson, Stacy, MN (US)

(21) Appl. No.: 19/504,836

(22) PCT Filed: Jul. 24, 2024
(86) PCT No.: PCT/US2024/039372

§ 371 Date: Jan. 23, 2026

Related U.S. Application Data
(60) Provisional application No. 63/528,547, filed on Jul. 24, 2023.

(51) Int. Cl. B60G 17/0195; B60G 17/005; B60G 17/016; B60G 21/055

(52) U.S. Cl. CPC B60G 17/0195; B60G 17/005; B60G 17/0164; B60G 21/055; B60G 2202/135; B60G 2400/0513; B60G 2400/104; B60G 2400/204; B60G 2400/40; B60G 2500/22

(57) ABSTRACT

A vehicle comprises a frame supported by ground engaging members. A prime mover is supported by the frame operably coupled to at least one of the ground engaging members. The prime mover is operable in a first condition and a second condition. A first suspension is coupled between at least one ground engaging member and the frame. A stabilizer bar is coupled between the first suspension and the frame and operable in a first operating state and a second operating state. A controller operates the prime mover between the first condition and the second condition and the stabilizer bar between the first operating state and the second operating state. The controller alters the stabilizer bar from the first operating state to the second operating state in response to the controller changing the prime mover between the first condition and the second condition.

### CROSS REFERENCE TO RELATED APPLICATIONS

The present disclosure claims priority to U.S. Provisional Application No. 63/528,547, filed Jul. 24, 2023, titled ADJUSTABLE SUSPENSION ASSEMBLIES AND METHODS OF USE THEREOF, attorney docket no. PLR-15-30316.01P-US, the complete disclosure of which is expressly incorporated by reference herein.

### FIELD OF THE DISCLOSURE

The present disclosure relates to adjustable suspensions for recreational or utility vehicles.

### BACKGROUND OF THE DISCLOSURE

Utility and recreational vehicles have suspensions capable of traversing various terrains at low and high speeds. Stabilizer bars and shock absorbers assist in maintaining control during various terrain. Adjustable stabilizer bars and adjustable shock absorbers make up adjustable suspensions giving operators smoother and more stable ride handling characteristics.

### SUMMARY OF THE DISCLOSURE

In embodiments of the present disclosure, a vehicle is provided. The vehicle comprises a plurality of ground engaging members and a frame supported by the plurality of ground engaging members. A prime mover may be supported by the frame, and the prime mover may be operably coupled to at least one of the plurality of ground engaging members. The prime mover is operable in a first operating condition and a second operating condition. A first suspension is coupled between at least one of the plurality of ground engaging members and the frame, and a stabilizer bar is coupled between the first suspension and the frame. The stabilizer bar is operable in a first stabilizer bar operating state and a second stabilizer bar operating state. Further, a controller is configured to operate the prime mover between the first operating condition and the second operating condition and operate the stabilizer bar between the first stabilizer bar operating state and the second stabilizer bar operating state. The controller is configured to alter the stabilizer bar from the first stabilizer bar operating state to the second stabilizer bar operating state in response to the controller changing the prime mover between the first operating condition and the second operating condition.

In yet another embodiment of the present disclosure, a method of controlling a suspension assembly for a vehicle is provided. The method comprising providing a stabilizer bar configured to operate between a first stabilizer bar operating state and a second stabilizer bar operating state, providing a prime mover configured to operate between a first operating condition and a second operating condition, and providing a controller configured to operate the prime mover between the first operating condition and the second operating condition. Further, changing the prime mover from the first operating condition to the second operating condition, and altering, in response to the changing, the stabilizer bar from the first stabilizer bar operating state to the second stabilizer bar operating state.

In yet another embodiment of the present disclosure, a suspension system for a vehicle is provided. The suspension system comprising a first suspension assembly coupled between a ground engaging member and a frame, and a stabilizer bar operably coupled to the first suspension, the stabilizer bar comprising an adjustable link and the adjustable link operable between a locked condition and an unlocked condition. A controller is configured to control a current provided to the adjustable link, and the controller further configured to receive a user input. Further, the controller configured to provide a first current to the adjustable link in the locked condition, and in response to the user input, the controller is configured to provide a second current to the adjustable link to operate the adjustable link in the unlocked condition, and the second current is different from the first current.

In yet another embodiment of the present disclosure, a method of controlling a suspension system of a vehicle is provided. The method comprises providing a stabilizer bar configured to operate between a first state and a second state, and providing a controller configured to control delivery of a current to the stabilizer bar. Delivering, at a first time when the stabilizer bar is in the first state, a first current to the stabilizer bar, delivering, at a second time subsequent to the first time, a second current to the stabilizer bar, and changing, by the second current, the stabilizer bar from the first state to the second state. Further, delivering, at a third time subsequent to the second time when the stabilizer bar is in the second state, a third current to the stabilizer bar; and the second current is greater than the third current.

In yet another embodiment of the present disclosure, a vehicle is provided. The vehicle comprises a plurality of ground engaging members, a frame supported by the plurality of ground engaging members, and a first suspension coupled between a first ground engaging member of the plurality of ground engaging members and the frame. A second suspension is coupled between a second ground engaging member of the plurality of ground engaging members and the frame, the first ground engaging member being on a first side of a centerline vertical plane of the vehicle and the second ground engaging member being on a second side of the centerline vertical plane of the vehicle, the second side being opposite the first side. An adjustable stabilizer bar is coupled to the first suspension on a first end and coupled to the second suspension on a second end, the adjustable stabilizer bar having a first configuration with a first stiffness and a second configuration with a second stiffness, the second stiffness being higher than the first stiffness. An adjustable shock absorber coupled between the frame and the first suspension, the adjustable shock absorber having at least one adjustable damping characteristic. At least one sensor is supported by the frame, and a controller is operably coupled to the adjustable shock absorber, the adjustable stabilizer bar, and the at least one sensor, the controller operable to determine a lateral acceleration of the vehicle based upon the at least one sensor. In response to the controller determining a first lateral acceleration of the vehicle based on the at least one sensor, the controller is operable to adjust the at least one adjustable damping characteristic of the adjustable shock absorber to a first damping value and the adjustable stabilizer bar to the first configuration, and in response to the controller determining a second lateral acceleration based on the at least one sensor greater than the first lateral acceleration, the controller is operable to adjust the adjustable stabilizer bar to the second configuration.

In yet another embodiment of the present disclosure, a vehicle is provided. The vehicle comprises a plurality of ground engaging members, a frame supported by the plurality of ground engaging members, and a suspension coupled between a first ground engaging member of the plurality of ground engaging members and the frame. An adjustable shock absorber is coupled between the frame and the suspension, the adjustable shock absorber having an adjustable damping characteristic. At least one sensor is supported by the frame, and a controller operably coupled to the adjustable shock absorber and the at least one sensor, the controller operable to determine a predicted lateral acceleration based upon the at least one sensor. The controller is operable to adjust the adjustable damping characteristic to a first damping value in response to the predicted lateral acceleration being a first predicted lateral acceleration, adjust the adjustable damping characteristic to a second damping value greater than the first damping value in response to the predicted lateral acceleration being a second predicted lateral acceleration greater than the first predicted lateral acceleration, and adjust the adjustable damping characteristic to a third damping value greater than the first damping value and less than the second damping value in response to the predicted lateral acceleration being a third predicted lateral acceleration greater than the first predicted lateral acceleration and less than the third predicted lateral acceleration.

In yet another embodiment of the present disclosure, a vehicle is provided. The vehicle comprises a plurality of ground engaging members, a frame supported by the plurality of ground engaging members, and a first suspension coupled between a first ground engaging member of the plurality of ground engaging members and the frame. An adjustable suspension assembly comprising a stabilizer bar and an adjustable suspension member coupled between the stabilizer bar and the first suspension, the adjustable suspension member having an adjustable suspension characteristic. At least one sensor supported by the frame, and a controller operably coupled to the at least one sensor and the adjustable suspension member, the controller operable to determine an airborne condition based upon the at least one sensor and to control the adjustable suspension characteristic of the adjustable suspension member. In response to the controller determining an airborne condition and determining that a yaw characteristic exceeding a yaw characteristic threshold, the controller is operable to adjust the adjustable suspension characteristic.

In yet another embodiment of the present disclosure, a method is provided. A method of operating an adjustable stabilizer bar of a vehicle, the adjustable stabilizer bar being operably coupled between a first suspension and a second suspension and having a first configuration having a first stiffness and a second configuration having a second stiffness, the second stiffness being higher than the first stiffness. The method comprises determining the vehicle is in an airborne condition based upon at least one sensor, determining a yaw angle of the vehicle, and adjusting the adjustable stabilizer bar from the first configuration to the second configuration in response to the yaw angle exceeding a yaw angle threshold.

In yet another embodiment of the present disclosure, a vehicle is provided. The vehicle comprising a plurality of ground engaging members, a frame supported by the plurality of ground engaging members, and a first suspension coupled between a first ground engaging member of the plurality of ground engaging members and the frame. An adjustable suspension assembly comprising a stabilizer bar and an adjustable suspension member coupled between the stabilizer bar and the first suspension, the adjustable suspension member having an adjustable suspension characteristic. At least one sensor supported by the frame and a controller operably coupled to the at least one sensor and the adjustable suspension member, the controller operable to determine a braking condition and a cornering condition based upon the at least one sensor, the controller operable to control the adjustable suspension characteristic of the adjustable suspension member. In response to the controller determining an occurrence of both the cornering condition and the braking condition, the controller is operable to adjust the adjustable suspension characteristic.

In yet another embodiment of the present disclosure, a method is provided. A method of operating a vehicle with an adjustable stabilizer bar and at least one sensor. The method comprising determining if the vehicle is in a braking condition based upon the at least one sensor, determining if the vehicle is in a cornering condition based upon the at least one sensor, and adjusting the adjustable stabilizer bar to a locked configuration based upon the vehicle being in a cornering condition while in a braking condition.

### BRIEF DESCRIPTION OF THE DRAWINGS

FIG. 1 illustrates a representative view of an exemplary recreational vehicle;

FIG. 2 illustrates a representative view of an exemplary controller of the exemplary recreational vehicle of FIG. 1;

FIG. 3 illustrates a representative view of exemplary sensors of the exemplary recreational vehicle of FIG. 1;

FIG. 4 illustrates a front, left perspective view of an exemplary side-by-side recreational vehicle of the exemplary recreational vehicle of FIG. 1;

FIG. 5 illustrates the pitch, roll, and yaw axes of the exemplary side-by-side recreational vehicle of FIG. 4;

FIG. 6 illustrates a rear, right perspective view of the exemplary side-by-side recreational vehicle of FIG. 4;

FIG. 7 illustrates a left or driver side view of the exemplary side-by-side recreational vehicle of FIG. 4;

FIG. 8 illustrates a right or passenger side view of the exemplary side-by-side recreational vehicle of FIG. 4;

FIG. 9 illustrates a top view of the exemplary side-by-side recreational vehicle of FIG. 4;

FIG. 10 illustrates a front view of the exemplary side-by-side recreational vehicle of FIG. 4;

FIG. 11 illustrates a rear view of the exemplary side-by-side recreational vehicle of FIG. 4;

FIG. 11A illustrates a steering wheel of the exemplary side-by-side recreational vehicle of FIG. 4;

FIG. 12 illustrates a front, left perspective view of the frame of the exemplary side-by-side recreational vehicle of FIG. 4;

FIG. 13 illustrates a right, rear perspective view of the frame of the exemplary side-by-side recreational vehicle of FIG. 4;

FIG. 14 illustrates a front, left perspective view of a driver side and passenger side front suspensions of the exemplary side-by-side recreational vehicle of FIG. 4;

FIG. 15 illustrates a rear perspective view of the driver side and passenger side front suspensions of the exemplary side-by-side recreational vehicle of FIG. 4;

FIG. 16 illustrates an exploded view of portions of a driver side and a passenger side rear suspensions of the exemplary side-by-side recreational vehicle of FIG. 4 including a rear stabilizer bar;

FIG. 17 illustrates an exploded view of the rear stabilizer bar of FIG. 16 of the exemplary side-by-side recreational vehicle of FIG. 4;

FIG. 18 illustrates a representative view of the power train of the exemplary side-by-side recreational vehicle of FIG. 4;

FIG. 19 illustrates an exemplary suspension control system of the exemplary side-by-side recreational vehicle of FIG. 4;

FIG. 20 illustrates an exemplary shock damping logic of the exemplary control system of FIG. 19;

FIG. 21 illustrates another exemplary shock damping logic of the exemplary control system of FIG. 19;

FIG. 22 illustrates an exemplary shock damping logic of the exemplary control system of FIG. 19;

FIG. 23 illustrates a schematic suspension diagram of a vehicle of the present disclosure;

FIG. 23A illustrates a schematic suspension diagram of a vehicle of the present disclosure;

FIG. 23B illustrates a schematic suspension diagram of a vehicle of the present disclosure;

FIG. 24 illustrates an alternative schematic suspension diagram of a vehicle of the present disclosure;

FIG. 25 illustrates a schematic of a shock absorber of a suspension of the present disclosure;

FIG. 26 illustrates a schematic of a preload system with of a shock absorber of a suspension of the present disclosure with no preload;

FIG. 27 illustrates a schematic of the preload system of FIG. 26 with preload;

FIG. 28 illustrates an exemplary preload logic of the preload system of FIG. 26;

FIG. 29 illustrates an exemplary display of inputs to the preload system of FIG. 26;

FIG. 30 illustrates an exemplary display of additional inputs to the preload system of FIG. 26;

FIG. 31 illustrates a schematic layout of a suspension diagram and seating areas of a vehicle of the present disclosure;

FIG. 32 illustrates a schematic layout of a suspension diagram with stabilizer bars in a locked configuration;

FIG. 33 illustrates a schematic layout of a suspension diagram with stabilizer bars in an unlocked configuration;

FIG. 34 illustrates a schematic layout of a suspension diagram with a rear stabilizer bar in a locked configuration and a front stabilizer bar in an unlocked configuration;

FIG. 35 illustrates a schematic layout of a suspension diagram with a front stabilizer bar in a locked configuration and a rear stabilizer bar in an unlocked configuration;

FIG. 36A illustrates a process for altering a stabilizer bar of the present disclosure;

FIG. 36B illustrates an alternative process for altering a stabilizer bar of the present disclosure;

FIG. 36C illustrates an alternative process for altering a stabilizer bar of the present disclosure;

FIG. 36D illustrates an alternative process for altering a stabilizer bar of the present disclosure;

FIG. 36E illustrates an alternative process for altering a stabilizer bar of the present disclosure;

FIG. 36F illustrates an alternative process for altering a stabilizer bar of the present disclosure;

FIG. 36G illustrates an alternative process for altering a stabilizer bar of the present disclosure;

FIG. 36H illustrates an alternative process for altering a stabilizer bar of the present disclosure;

FIG. 37A illustrates a process for altering a stabilizer bar;

FIG. 37B illustrates an alternative process for altering a stabilizer bar;

FIG. 37C illustrates an alternative process for altering a stabilizer bar;

FIG. 37D illustrates an alternative process for altering a stabilizer bar;

FIG. 38A illustrates an alternative process for altering a stabilizer bar;

FIG. 38B illustrates an alternative process for altering a stabilizer bar;

FIG. 39 illustrates an exemplary process for altering a current provided to a stabilizer bar;

FIG. 40 illustrates a graph of current supplied to the stabilizer bar according to the process of FIG. 39;

FIG. 41 illustrates a user interface showing a suspension system in a first configuration;

FIG. 42 illustrates a user interface showing a suspension system in a second configuration;

FIG. 43 illustrates a user interface showing a suspension system in a third configuration;

FIG. 44 illustrates a user interface showing a suspension system in a fourth configuration;

FIG. 45 illustrates a plurality of profiles indicating a status of a stabilizer bar for a user interface;

FIG. 46A illustrates a user interface showing selectable modes for a suspension system;

FIG. 46B illustrates a user interface showing a selection screen for selectable modes for a suspension system;

FIG. 47 illustrates a user interface showing a notification bar;

FIG. 48 illustrates a user interface showing a notification icon related to a suspension system;

FIG. 49 illustrates a schematic of a vehicle showing lateral acceleration at the front and rear axle;

FIG. 50A illustrates a coupler for a stabilizer bar of the present disclosure;

FIG. 50B illustrates an exploded view of the coupler of FIG. 50A;

FIG. 51 illustrates a graph showing spring rates for various embodiments of a stabilizer bar of the present disclosure;

FIG. 52 illustrates a suspension member of the present disclosure;

FIG. 53 illustrates an exploded view of the suspension member of FIG. 52;

FIG. 54 illustrates a suspension member of the present disclosure;

FIG. 55 illustrates an exploded view of the suspension member of FIG. 54;

FIG. 56 illustrates a graph displaying a discrete event model of the present disclosure;

FIG. 57 illustrates a control diagram of the present disclosure;

FIG. 57A illustrates a control diagram of the present disclosure;

FIG. 58 illustrates a graph displaying a continuous event model of the present disclosure;

FIG. 59 illustrates a process of determining a cornering characteristic of the present disclosure;

FIG. 60A illustrates a control diagram of a vehicle making a left turn of the present disclosure;

FIG. 60B illustrates a control diagram of a vehicle making a right turn of the present disclosure;

FIG. 61 illustrates a control diagram of the present disclosure;

FIG. 62 illustrates a process of controlling a stabilizer bar of the present disclosure;

FIG. 63 illustrates a stop member of the present disclosure;

FIG. 64 illustrates a stabilizer bar in a first position with the stop member of FIG. 63;

FIG. 65 illustrates a stabilizer bar in a second position with the stop member of FIG. 63;

FIG. 66 illustrates a portion of a stabilizer bar of the present disclosure;

FIG. 67 illustrates the stabilizer bar of FIG. 66 in a first position;

FIG. 68 illustrates the stabilizer bar of FIG. 66 in a second position;

FIG. 69 illustrates a rear suspension with a stop member with a stabilizer bar assembly in a first position; and

FIG. 70 illustrates the rear suspension with the stop member of FIG. 69 with the stabilizer bar assembly in a second position.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a side-by-side vehicle, it should be understood that the features disclosed herein may have application to other types of vehicles such as all-terrain vehicles, snowmobiles, and golf carts.

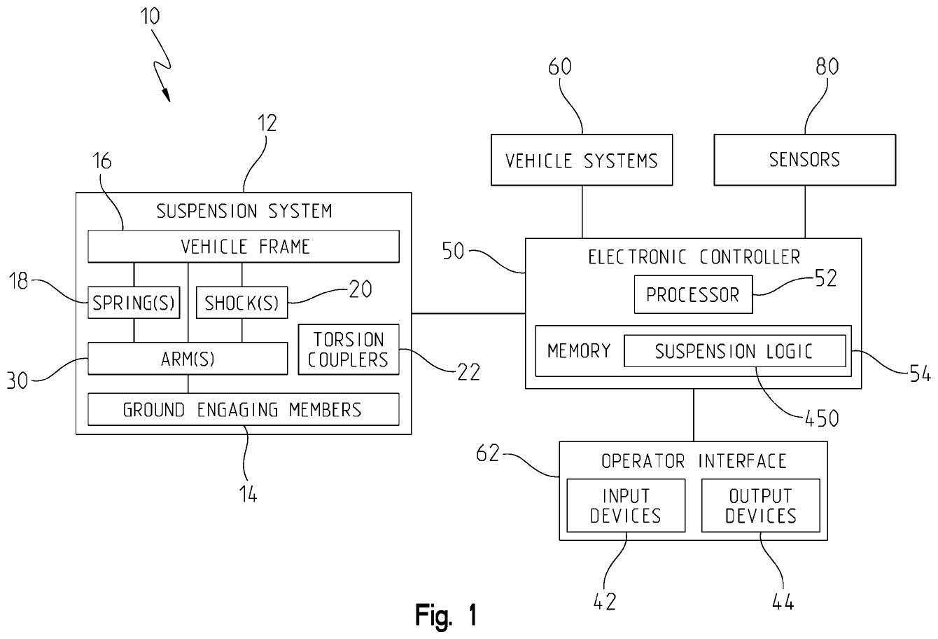

Referring now to FIG. 1, the present disclosure relates to a vehicle 10 having suspension systems 12 coupling a plurality of ground engaging members 14 and a vehicle frame 16. Exemplary ground engaging members 14 include wheels, skis, guide tracks, treads or other suitable devices for supporting the vehicle relative to the ground.

Suspension systems 12 typically include springs 18 and shock absorbers 20 coupled between the ground engaging members 14 and the frame 16. Springs 18 may include, for example, coil springs, leaf springs, air springs or other gas springs. The air or gas springs 18 may be adjustable. See, for example, U.S. Pat. No. 7,950,486, assigned to the current assignee, the entire disclosure of which is incorporated herein by reference. Shocks 20 may be electronically controlled to adjust one or both of a compression damping characteristic of the shock and a rebound damping characteristic of the shock. Exemplary adjustable shocks include the FOX 3.0 Live Valve X2 Internal Bypass shock having electronic independent compression damping control and rebound damping control available from FOX located at 6634 Highway 53 in Braselton, Georgia 30517. In embodiments, shocks 20 include a first controllable valve to adjust compression damping and a second controllable valve to adjust rebound damping. In embodiments, shocks 20 include a combination valve which controls both compression damping and rebound damping. Additional exemplary adjustable shocks are described in U.S. patent application Ser. No. 17/325,062, filed May 19, 2021, titled SYSTEMS AND METHODS OF ADJUSTABLE SUSPENSIONS FOR OFF-ROAD RECREATIONAL VEHICLES, docket PLR-01-29147.02P-US, the entire disclosure of which is expressly incorporated by reference herein.

In embodiments, each ground engaging member 14 is coupled to vehicle frame 16 through a separate suspension system 12 having one or more springs 18 and adjustable shocks 20. In embodiments, a single suspension system 12 may couple at least two ground engaging members 14 to the vehicle frame 16.

Further, suspension systems 12 may further include one or more torsion couplers 22 which couple individual suspension systems 12 together such that a movement of a first suspension system 12 influences the movement of a second suspension system 12. An exemplary torsion coupler 22 is a stabilizer bar.

Each of ground engaging members 14 are coupled to vehicle frame 16 through one or more suspensions arms 30 of the respective suspension system 12, such as A-arms, trailing arms, control arms, and other suitable arms. The respective arms 30 permit vertical movement of the ground engaging member 14 relative to the vehicle frame 16. Springs 18 and shocks 20 are typically coupled to one of the respective arms 30 and vehicle frame 16 and the damping characteristics of springs 18 and shocks 20 control the vertical movement of ground engaging member 11 relative to vehicle frame 16. These damping characteristics, as described herein, may be adjusted to improve the handling, comfort, ride height, performance, and other characteristics of vehicle 10. In the case of a snowmobile, a first portion of the springs 18 and shocks 20 may be located between suspension arms coupled to front skis and the snowmobile frame and a second portion of the springs 18 and shocks 20 are located within an interior of an endless track ground engaging member, as described in U.S. patent application Ser. No. 17/325,062, filed May 19, 2021, titled SYSTEMS AND METHODS OF ADJUSTABLE SUSPENSIONS FOR OFF-ROAD RECREATIONAL VEHICLES, docket PLR-01-29147.02P-US, the entire disclosure of which is expressly incorporated by reference herein.

Vehicle 10 further includes an electronic controller 50 operatively coupled to adjustable shocks 20 of suspension systems 12 and other adjustable components, such as torsion couplers 22. Electronic controller 50 includes at least one processor 52 and at least one non-transitory computer readable medium, memory 54. In embodiments, electronic controller 50 is a single unit that controls the operation of various systems 60 of vehicle 10. In embodiments, electronic controller 50 is a distributed system comprised of multiple controllers each of which control one or more systems of vehicle 10 and may communicate with each other over one or more wired and/or wireless networks. In embodiments, the multiple controllers communicate over a CAN network.

Further, electronic controller 50 is operatively coupled to a plurality of sensors 80 which monitor various parameters of vehicle 10 or the environment surrounding vehicle 10. In embodiments, one or more of the sensors 80 may be incorporated as part of electronic controller 50, have a direct connection to electronic controller 50, and/or provide information regarding sensed characteristics over one or more wired and/or wireless networks. In embodiments, the multiple sensors and controllers communicate over a CAN network.

Controller 50 performs certain operations (e.g., provides commands) to control one or more subsystems of other vehicle components. In embodiments, controller 50 forms a portion of a processing subsystem including one or more computing devices having memory, processing, and communication hardware. Controller 50 may be a single device or a distributed device, and the functions of the controller 50 may be performed by hardware and/or as the execution of computer instructions stored on a non-transitory computer readable storage medium, such as memory 54, by one or more processors.

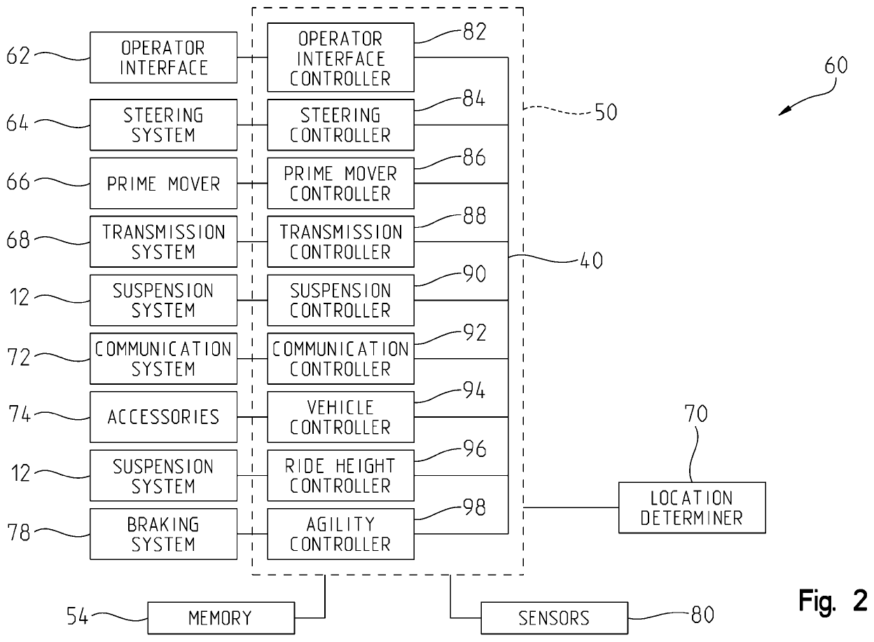

Referring to FIG. 2, controller 50 is represented as including several controllers. These controllers may each be single devices or distributed devices or one or more of these controllers may together be part of a single device or distributed device. The functions of these controllers may be performed by hardware and/or as the execution of computer instructions stored on a non-transitory computer readable storage medium, such as memory 54, by one or more processors.

In embodiments, controller 50 includes at least two separate controllers which communicate over a network 40. In one embodiment, network 40 is a CAN network. Details regarding an exemplary CAN network are disclosed in U.S. patent application Ser. No. 11/218,163, filed Sep. 1, 2005, the disclosure of which is expressly incorporated by reference herein. In embodiments, any suitable type of network or data bus may be used in place of the CAN network including wired, wireless, or combinations thereof. In embodiments, two wire serial communication is used for some connections.

Referring to FIG. 2, controller 50 includes an operator interface controller 82 which controls communication with an operator through operator interface 62. Operator interface 62 includes one or more input devices 42 (FIG. 1) which receive inputs from an operator of vehicle 10 and one or more output devices 44 (FIG. 1) which provide information to the operator of vehicle 10. Exemplary input devices 42 for operator interface 62 include levers, buttons, switches, soft keys, and other suitable input devices. Exemplary output devices 44 include lights, displays, audio devices, tactile devices, and other suitable output devices. In embodiments, at least a portion of the user input devices 42 are positioned so that an operator may actuate the input without removing their hands from a vehicle steering input device. In embodiments, at least a portion of the user input devices 42 are positioned on a steering wheel, handle bar, or other operator steering input device of vehicle 10 to facilitate actuation of the input devices 42. In embodiments, at least a portion of the user input devices 42 are actuatable by a foot of the operator or by other operator movement. Exemplary user input devices may be multi-purpose input devices.

A steering controller 84 controls portions of a steering system 64. In embodiments, steering system 84 is a power steering system and includes one or more steering sensors. Exemplary sensors and electronic power steering units are provided in U.S. patent application Ser. No. 12/135,107, filed Jun. 6, 2008, titled VEHICLE, docket PLR-06-22542.02P and U.S. patent application Ser. No. 63/071,855, filed Aug. 28, 2020, titled VEHICLE STEERING SYSTEMS AND METHODS, docket PLR-15-29282.01P-US, the disclosures of which is expressly incorporated by reference herein.

A prime mover controller 86 controls the operation of a prime mover 66. Exemplary prime movers provide motive power to a driveline of vehicle 10 and include two-cycle combustion engines, four-cycle combustion engines, electric motors, hybrid systems, and the associated energy providing systems, such as fuel and air control systems for internal combustion engines and battery systems for electric motors.

A transmission controller 88 controls the operation of transmission system 68. Exemplary transmission systems 68 include shiftable transmissions, automatic dual clutch transmissions, continuously variable transmissions, and combinations thereof.

A suspension controller 90 controls adjustable portions of suspension systems 12. Exemplary adjustable components include adjustable shocks 20, adjustable springs 18, and/or configurable torsion couplers 22, such as sway bars including stabilizer bars. Additional details regarding adjustable shocks, adjustable springs, and configurable torsion couplers are provided in U.S. patent application Ser. No. 16/013,210, filed Jun. 20, 2018, titled VEHICLE HAVING SUSPENSION WITH CONTINUOUS DAMPING CONTROL; U.S. patent application Ser. No. 16/529,001, filed Aug. 1, 2019, titled ADJUSTABLE VEHICLE SUSPENSION SYSTEM; U.S. patent application Ser. No. 15/816,368, filed Nov. 17, 2017, titled ADJUSTABLE VEHICLE SUSPENSION SYSTEM; U.S. patent application Ser. No. 16/198,280, filed Nov. 21, 2018, titled VEHICLE HAVING ADJUSTABLE COMPRESSION AND REBOUND DAMPING; US Provisional Application Ser. No. 63/027,833, filed May 20, 2020, titled SYSTEMS AND METHODS OF ADJUSTABLE SUSPENSIONS FOR OFF-ROAD RECREATIONAL VEHICLES, docket PLR-01-29147.01P-US; and U.S. patent application Ser. No. 17/379,675, filed Jul. 19, 2021, titled ADJUSTABLE SUSPENSIONS AND VEHICLE OPERATION FOR OFF-ROAD RECREATIONAL VEHICLES, docket PLR-15-29249.04P-US, the entire disclosures of which are expressly incorporated by reference herein.

Communication controller 92 controls communications between a communication system 72 of vehicle 10 and remote devices, such as other vehicles, personal computing devices, such as cellphones or tablets, a centralized computer system maintaining one or more databases, and other types of devices remote from vehicle 10 or carried by riders of vehicle 10 or otherwise supported by vehicle 10. In embodiments, communication controller 92 of vehicle 10 communicates with paired devices over a wireless network. An exemplary wireless network is a radio frequency network utilizing a BLUETOOTH protocol. In this example, communication system 72 includes a radio frequency antenna. Communication controller 92 controls the pairing of devices to vehicle 10 and the communications between vehicle 10 and the remote device. In embodiments, communication controller 92 of vehicle 10 communicates with remote devices over a cellular network. In this example, communication system 72 includes a cellular antenna and communication controller 92 receives and sends cellular messages from and to the cellular network. In embodiments, communication controller 92 of vehicle 10 communicates with remote devices over a satellite network. In this example, communication system 72 includes a satellite antenna and communication controller 88 receives and sends messages from and to the satellite network. In one embodiment, vehicle 10 is able to communicate with other vehicles 10 over a Radio Frequency mesh network and communication controller 92 and communication system 72 are configured to enable communication over the mesh network. Exemplary vehicle communication systems and associated processing sequences are disclosed in U.S. patent application Ser. No. 16/234,162, filed Dec. 27, 2018, titled RECREATIONAL VEHICLE INTERACTIVE TELEMETRY, MAPPING AND TRIP PLANNING SYSTEM, docket PLR-15-25635.04P-02-US; U.S. patent application Ser. No. 15/262,113, filed Sep. 12, 2016, titled VEHICLE TO VEHICLE COMMUNICATIONS DEVICE AND METHODS FOR RECREATIONAL VEHICLES, docket PLR- 09-27870.01P-US; U.S. Pat. No. 10,764,729, titled COMMUNICATION SYSTEM USING VEHICLE TO VEHICLE RADIO AS AN ALTERNATE COMMUNICATION MEANS, filed Dec. 12, 2018; US Published Patent Application No. US20190200189, titled COMMUNICATION SYSTEM USING CELLULAR SYSTEM AS AN ALTERNATE TO A VEHICLE TO VEHICLE RADIO, filed Dec. 12, 2018; US Published Patent Application No. US 20190200173, titled METHOD AND SYSTEM FOR FORMING A DISTANCED-BASED GROUP IN A VEHICLE TO VEHICLE COMMUNICATION SYSTEM, filed Dec. 12, 2018; US Published Patent Application No. US20190200188, titled VEHICLE-TO-VEHICLE COMMUNICATION SYSTEM, filed Dec. 12, 2018; U.S. patent application Ser. No. 16/811,865, filed Mar. 6, 2020, titled RECREATIONAL VEHICLE GROUP MANAGEMENT SYSTEM, docket PLR-15-27455.02P-03-US; U.S. patent application Ser. No. 63/016,684, filed Apr. 28, 2020, titled SYSTEM AND METHOD FOR DYNAMIC ROUTING, docket PLR-00TC-27721.01P-US; U.S. patent application Ser. No. 16/013,210, filed Jun. 20, 2018, titled VEHICLE HAVING SUSPENSION WITH CONTINUOUS DAMPING CONTROL, docket PLR-15-25091.04P-03-US; and U.S. patent application Ser. No. 15/816,368, filed Nov. 17, 2017, titled VEHICLE HAVING ADJUSTABLE SUSPENSION, docket PLR-15-25091.08P-US, the entire disclosures of which are expressly incorporated by reference herein.

A vehicle controller 94 controls accessories 74, such as lights, loads, chassis level functions, and other vehicle accessories.

A ride height controller 96 controls the preload and operational height of the vehicle. In embodiments, ride height controller 96 controls springs 16 and/or shocks 20 of suspension systems 12 to adjust a ride height of vehicle 10, either directly or through suspension controller 90. In embodiments, ride height controller 96 provides more ground clearance in a comfort ride mode compared to a sport ride mode. Additional details regarding exemplary ride height controllers are provided in U.S. patent application Ser. No. 16/198,280, filed Nov. 21, 2018, titled VEHICLE HAVING ADJUSTABLE COMPRESSION AND REBOUND DAMPING, attorney docket no. PLR-15-28021.01P-US, the entire disclosure of which is expressly incorporated by reference herein.

An agility controller 98 controls a braking system 78 of vehicle 10 and the stability of vehicle 10. Control methods of agility controller 98 may include integration into braking circuits (ABS) such that a stability control system can improve dynamic response (vehicle handling and stability) by modifying the shock damping of shocks 20 in conjunction with electronic braking control. Additional details regarding exemplary agility controllers and braking circuits and uses thereof are provided in U.S. patent application Ser. No. 16/401,933, filed May 2, 2019, titled OPERATING MODES USING A BRAKING SYSTEM FOR AN ALL TERRAIN VEHICLE, attorney docket no. PLR-15-28344.03P-US; U.S. patent application Ser. No. 17/235,322, filed Apr. 20, 2021, titled SYSTEMS AND METHODS FOR OPERATING AN ALL-TERRAIN VEHICLE, attorney docket no. PLR-15-29107.02P-US; U.S. Provisional Patent Application No. 63/440,313, filed Jan. 20, 2023, titled TERRAIN DETECTION AND METHODS OF USE THEREOF, attorney docket no. PLR-09-29613.01P-US, the entire disclosure of which is expressly incorporated by reference herein.

In embodiments, controller 20 either includes a location determiner 70 and/or communicates via communication system 72 to a location determiner 70. The location determiner 70 determines a current geographical location of vehicle 10. An exemplary location determiner 70 is a GPS unit which determines the position of vehicle 10 based on interaction with a global satellite system.

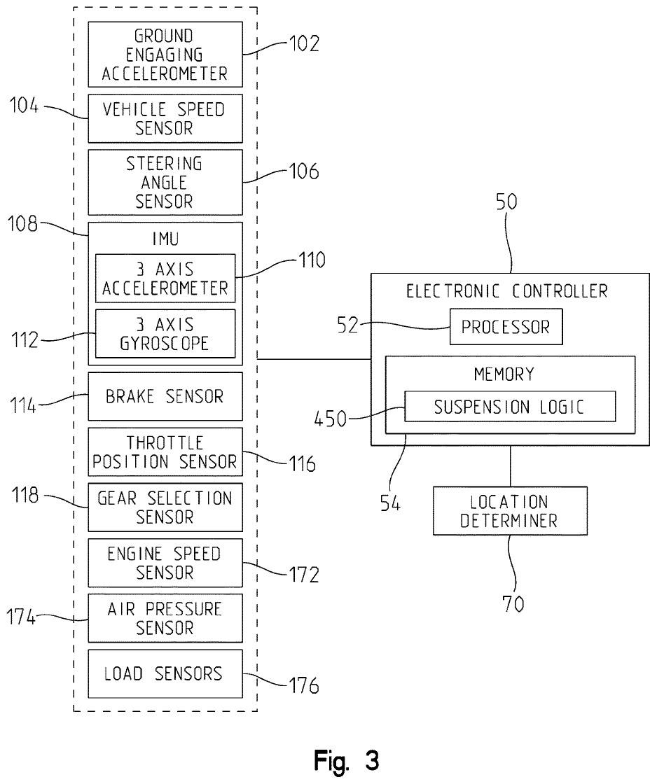

Referring to FIG. 3, electronic controller 50 is illustrated along with various sensors of the plurality of sensors 80. Exemplary sensors include a ground engaging member accelerometer 102 associated with each ground engaging member 14. Electronic controller 50 communicates with or otherwise receives information from each of ground engaging member accelerometers 102. For instance, the ground engaging member accelerometers 102 provide information indicating movement of the ground engaging members 14, adjustable shocks 18, and/or suspension arms 30 as the vehicle traverses different terrain. Other ground engaging member sensors may also be included, such as one or more sensors monitoring an angle of a suspension arm, an extension of a shock, or other suitable characteristics that provide an indication of a position of the ground engaging member. Exemplary sensors are disclosed in U.S. patent application Ser. No. 16/013,210, filed Jun. 20, 2018, titled VEHICLE HAVING SUSPENSION WITH CONTINUOUS DAMPING CONTROL, attorney docket no. PLR-15-25091.04P-03-US, the entire disclosure of which is expressly incorporated by reference herein.

Electronic controller 50 communicates with or otherwise receives vehicle speed information for vehicle 10 from a vehicle speed sensor 104.

Electronic controller 50 communicates with or otherwise receives steering information for vehicle 10 from a steering sensor 106. Exemplary steering sensors 106 include a sensor which monitors a position of an operator steering input, such as a steering wheel or handlebars, a sensor which monitors an acceleration of the operator steering wheel or handlebars, and a sensor associated with a power steering unit which provides an indication of a position of the operator steering input. Exemplary steering sensors are disclosed in U.S. patent application Ser. No. 17/410,781, filed Aug. 24, 2021, titled VEHICLE STEERING SYSTEMS AND METHODS, attorney docket no. PLR-15-29282.02P-US, the entire disclosure of which is expressly incorporated by reference herein.

Electronic controller 50 communicates with or otherwise receives information regarding vehicle 10 from an inertial measurement unit (IMU) 108. IMU 108 includes a 3 axis accelerometer 110 to provide information indicating acceleration forces of the vehicle 10 during operation and a 3 axis gyroscope 112 to provide indications of inertial measurements, such as roll rates, pitch rates, and/or yaw rates, of the vehicle during operation. In embodiments, IMU 108 is located at or close to a center position (e.g., a center of gravity position) of vehicle 10. In other instances, IMU 108 is located at a position that is not near the center of gravity of the vehicle 10. In an exemplary embodiment, IMU 108 is located along a longitudinal centerline plane of vehicle 50.

Electronic controller 50 communicates with or otherwise receives information regarding vehicle 10 from a brake sensor 114.

Electronic controller 50 communicates with or otherwise receives information regarding vehicle 10 from a throttle position sensor 116.

Electronic controller 50 communicates with or otherwise receives information regarding vehicle 10 from a gear selection sensor 118.

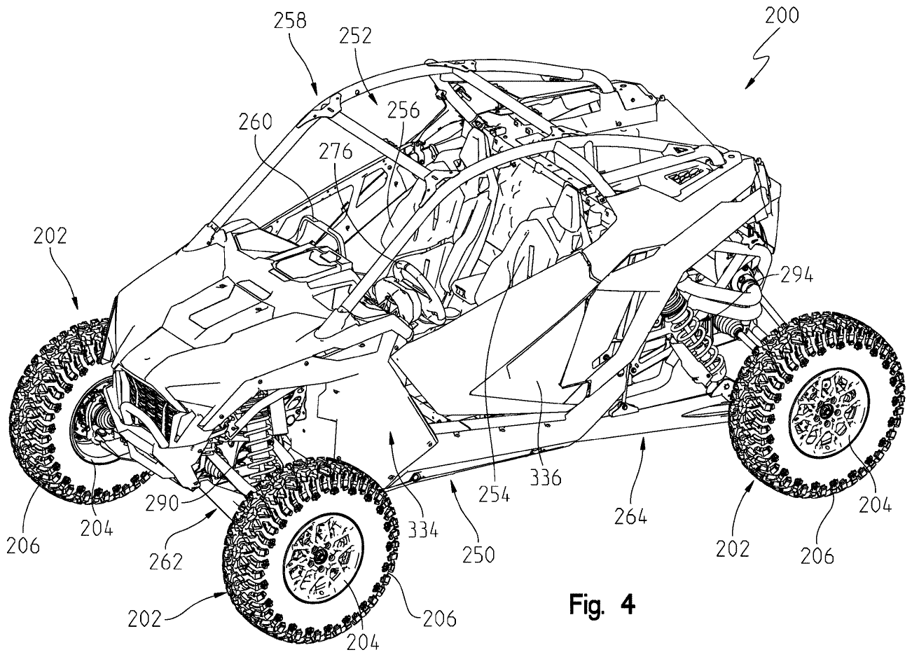

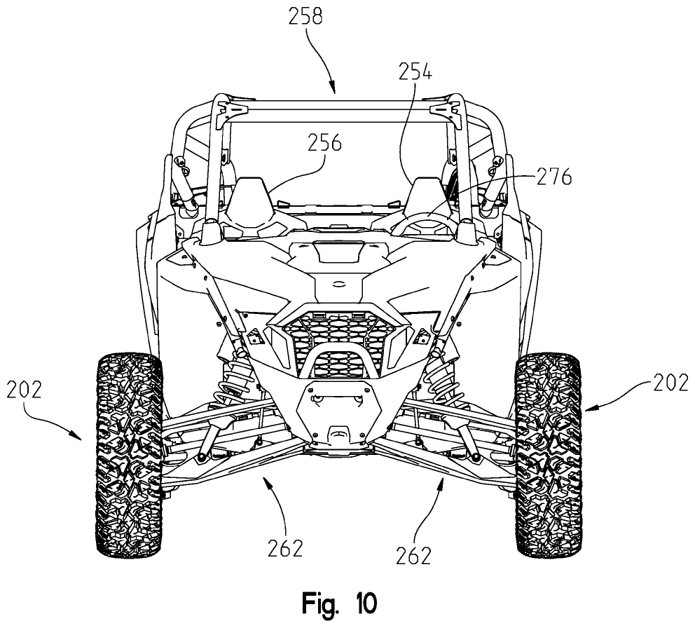

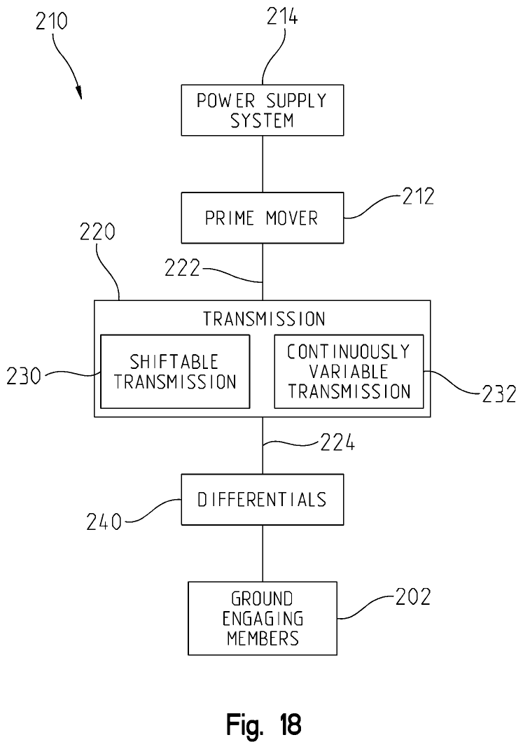

Referring to FIGS. 4-18, an exemplary vehicle 200 including the control systems and suspension systems disclosed herein is illustrated. Vehicle 200 is an exemplary side-by-side off-road recreational vehicle. Vehicle 200, as illustrated, includes a plurality of ground engaging members 202. Illustratively, ground engaging members 202 are wheels 204 and associated tires 206. Ground engaging members 202 are operatively coupled to power system 210 (see FIG. 18) to power the movement of vehicle 200.

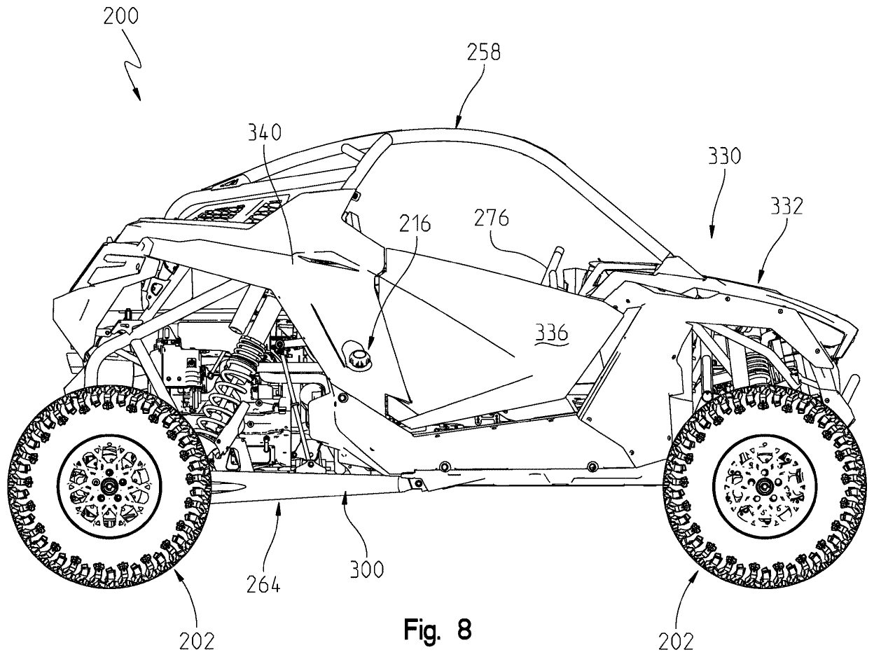

Referring to FIG. 18, power system 210 includes a prime mover 212. In embodiments, prime mover 212 is an internal combustion engine and receives fuel from a power supply system 214, such as a fuel pump positioned in a fuel tank 216 (see FIG. 8). Other exemplary prime movers include electric motors.

A transmission 220 is operatively coupled to prime mover 212. Transmission 220 converts a rotational speed of an output shaft 222 of prime mover 212 to one of a faster rotational speed or a slower rotational speed of an output shaft 224 of transmission 220. In embodiments, transmission 220 may additionally rotate output shaft 224 at the same speed as output shaft 222.

In the illustrated embodiment, transmission 220 includes a shiftable transmission 230 and a continuously variable transmission (“CVT”) 232. In one example, an input member of CVT 232 is coupled to prime mover 212. An input member of shiftable transmission 230 is in turn coupled to an output member of CVT 232. In embodiments, shiftable transmission 230 includes a forward high setting, a forward low setting, a neutral setting, a park setting, and a reverse setting. Gear selection sensor 118 monitors a gear setting of shiftable transmission 230. The power communicated from prime mover 212 to CVT 232 is provided to a drive member of CVT 232. The drive member in turn provides power to a driven member through a connecting member, such as a belt. Exemplary CVTs are disclosed in U.S. Pat. Nos. 3,861,229; 6,176,796; 6,120,399; 6,860,826; and 6,938,508, the disclosures of which are expressly incorporated by reference herein. The driven member provides power to an input shaft of shiftable transmission 230. Although transmission 220 is illustrated as including both shiftable transmission 232 and CVT 230, transmission 220 may include only one of shiftable transmission 232 and CVT 230. Further, transmission 220 may include one or more additional components.

Transmission 220 is further coupled to at least one differential 240 which is in turn coupled to at least one ground engaging members 202. Differential 240 may communicate the power from transmission 220 to one of ground engaging members 202 or multiple ground engaging members 202. In an ATV embodiment, one or both of a front differential and a rear differential are provided. The front differential powering at least one of two front wheels of the ATV and the rear differential powering at least one of two rear wheels of the ATV. In a side-by-side vehicle embodiment having seating for at least an operator and a passenger in a side-by-side configuration, one or both of a front differential and a rear differential are provided. The front differential powering at least one of two front wheels of the side-by-side vehicle and the rear differential powering at least one of multiple rear wheels of the side-by-side vehicle. In one example, the side-by-side vehicle has three axles and a differential is provided for each axle.

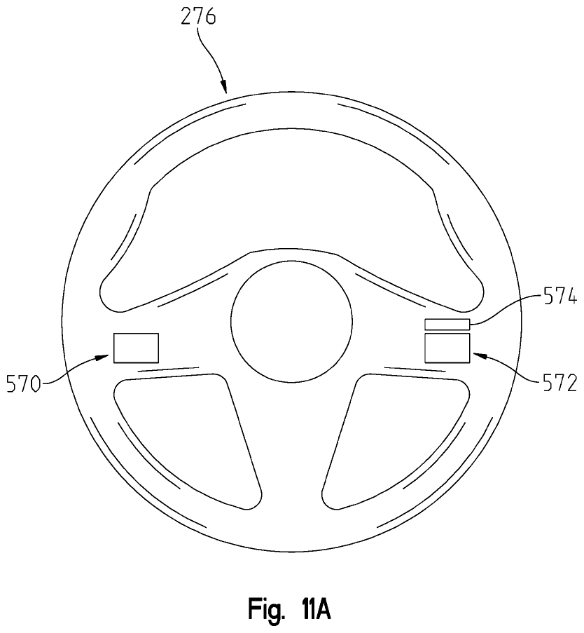

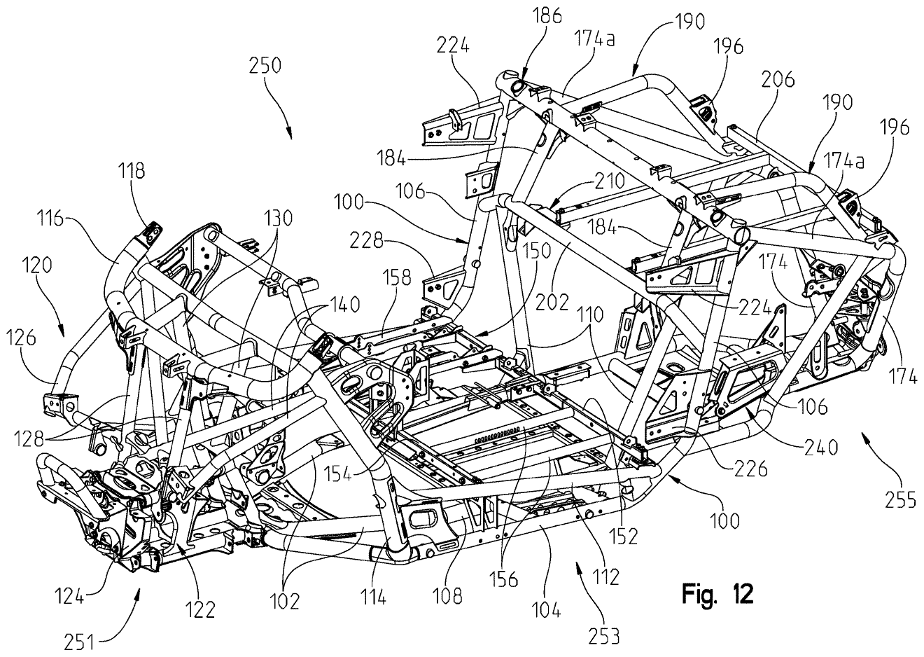

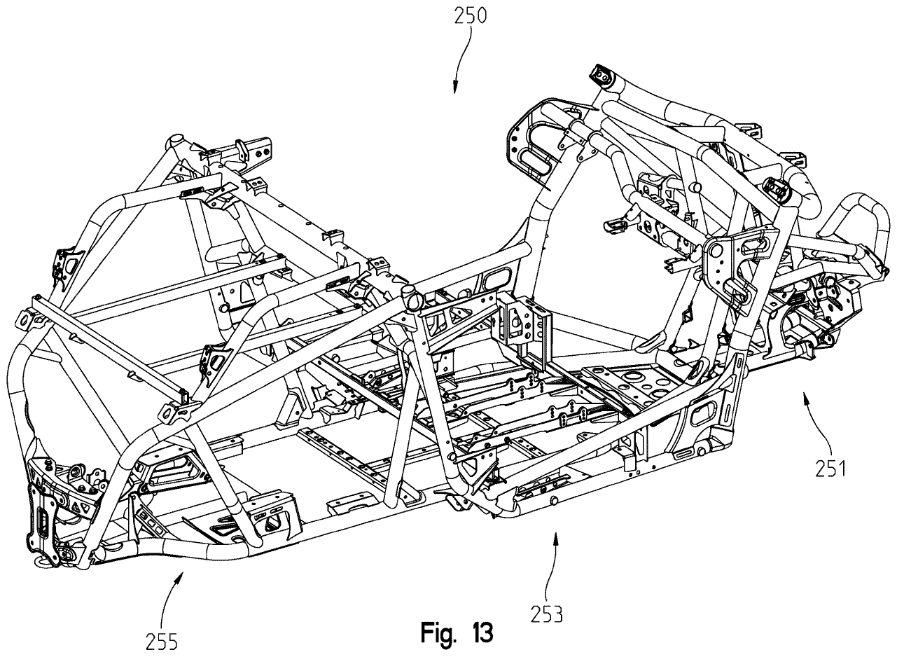

Returning to FIG. 4, ground engaging members 202 support a vehicle frame 250 which in turn supports a seating area 252 comprised of a driver's seat 254 and a passenger seat 256. In the illustrated embodiment, seating area 252 is an open air seating area. Referring to FIGS. 12 and 13, vehicle frame 250 includes a front frame section 251, a mid-frame portion 253, and a rear frame portion 255. Seating area 252 is supported by mid frame portion 253. A cab frame 258 extends over seating area 252 to protect the passengers from such objects as tree branches, etc. A passenger grab bar 260 is provided for the passenger in seat 256. In embodiments, prime mover 212 is positioned rearward of the seating area 252. In embodiments, prime mover 212 is positioned rearward of each of the driver's seat 254 and the passenger seat 256.

Vehicle 200 further includes a front suspension 262 for each of the front ground engaging members 202 and a rear suspension 264 for each of the rear ground engaging members 202. Front suspensions 262 are coupled to front portion 251 of vehicle frame 250. Rear suspensions 264 are coupled to rear portion 255 of vehicle frame 250 and a rear side of mid frame portion 253.

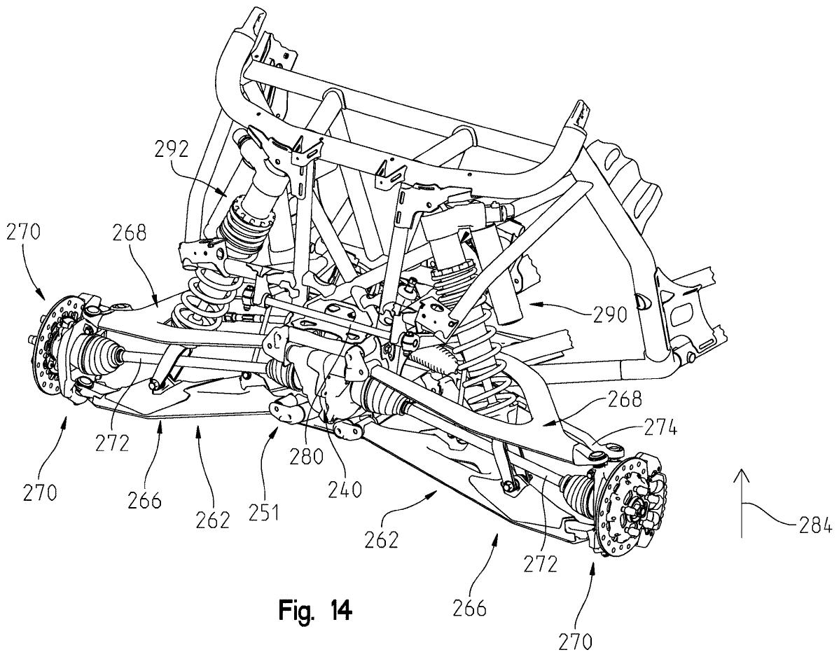

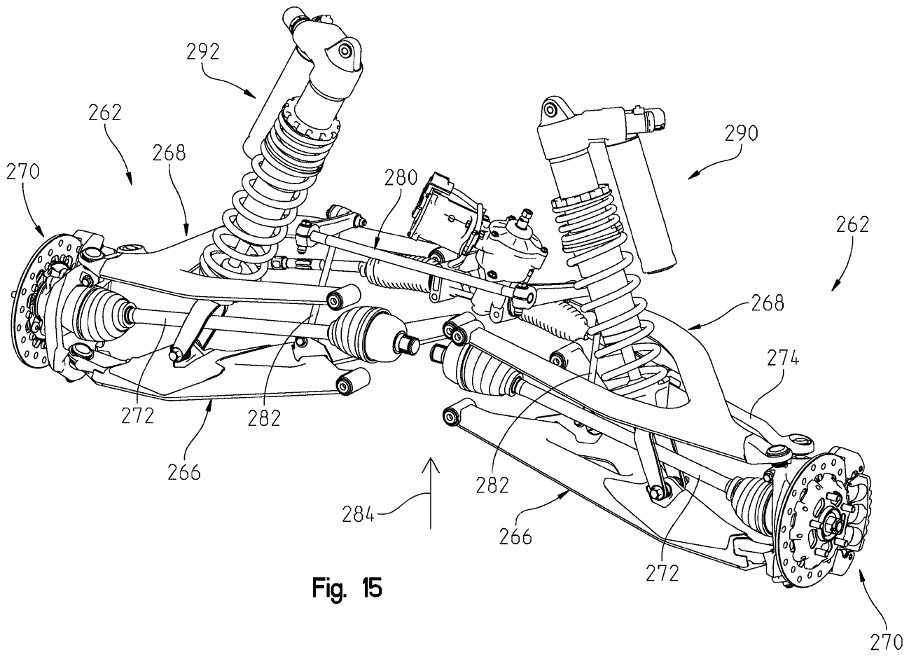

Referring to FIGS. 14 and 15, front suspensions 262 include lower A-arms 266 rotatably coupled to front portion 251 of vehicle frame 250 at a first end and upper A-arms 268 rotatably coupled to front portion 251 of vehicle frame 250 at a first end. The second ends of lower A-arms 266 and upper A-arms are rotatably coupled to respective wheel carriers 270. Tie rods 274 of steering system 64 are also coupled to wheel carriers 270 to control an angle of wheel carriers 270 and steer vehicle 200. A desired steering angle is input by the driver through actuation of an operator steering input, illustratively steering wheel 276 (see FIG. 4). A front differential 240 of power system 210 which is also supported by front portion 251 of vehicle frame 250 and is operatively coupled to wheel carriers 270 through half shafts 272 which rotate a portion of wheel carriers 270 to propel vehicle 200 relative to the ground. A front axle 261 is generally defined as the components coupled between front ground engaging members 202. A stabilizer bar 280 is rotatably coupled to front portion 251 of vehicle frame 250 through links 282 (see FIG. 15) which are coupled to lower A-arms 266 and to stabilizer bar 280 to couple the front suspensions 262, such that a vertical movement of one of front suspensions 262 will initially cause a twisting of stabilizer bar 280 and further movement thereafter will cause a movement of the other of the front suspensions 262 due to the interconnection through stabilizer bar 280. Links 282 include a front left link 282a and a front right link 282b. In embodiments, front left link 282a and front right link 282b are adjustable links, or adjustable members. In embodiments, at least one of front left link 282a and front right link 282b are adjustable links, or adjustable members. In embodiments, links 282 are solid links (i.e., solid rod). Adjustable links 282a, 282b may be adjustable shock absorbers with which couple stabilizer bar 280 to front suspensions 262. Adjustable links 282a, 282b are rotatably coupled at a lower end to lower A-arms 266 of the respective front suspensions 262 and are rotatably coupled at an upper end to stabilizer bar 280. Each of adjustable links 282a, 282b are operatively coupled to electronic controller 50 which controls a damping characteristic of each of links 282a, 282b. In embodiments, the adjustable links are adjustable between an unlocked state, a locked state, and a semi-active state.

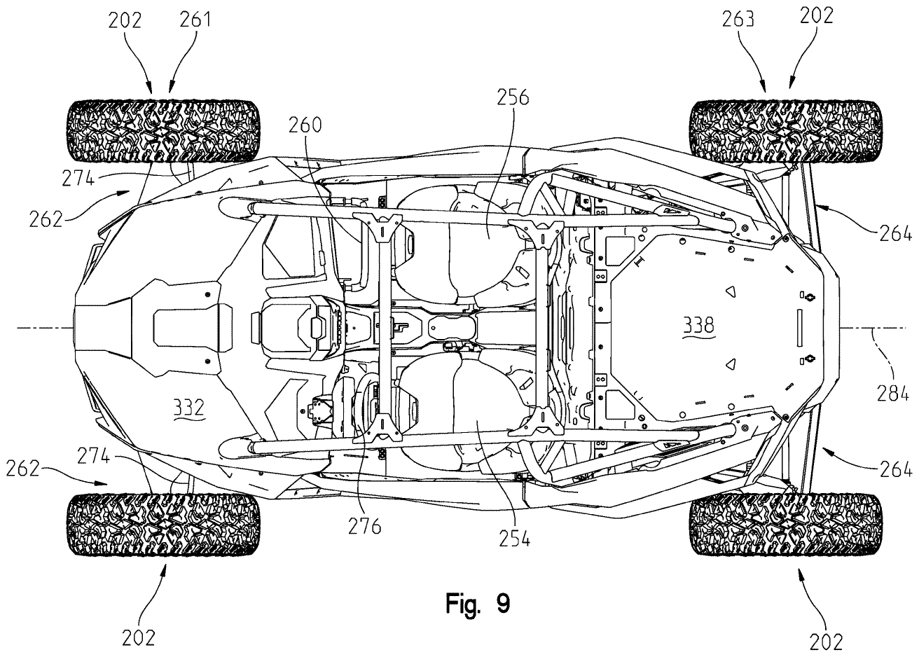

Referring to FIG. 24, front suspensions 262 further include adjustable shocks, illustratively left front electronically adjustable shock 290 on the operator side of centerline vertical plane 284 (see FIG. 9) of vehicle 200 and right front electronically adjustable shock 292 on the passenger side of centerline vertical plane 284. Left front electronically adjustable shock 290 and right front electronically adjustable shock 292 are rotatably coupled at a lower end to lower A-arms 266 of the respective front suspensions 262 and rotatably coupled at an upper end to front portion 251 of vehicle frame 250. Each of left front electronically adjustable shock 290 and right front electronically adjustable shock 292 are operatively coupled to electronic controller 50 which controls the compression damping characteristic and rebound damping characteristic of each of left front electronically adjustable shock 290 and right front electronically adjustable shock 292. In embodiments, each of shocks 290, 292 are not adjustable, or are manually adjustable (e.g., a clicker shock).

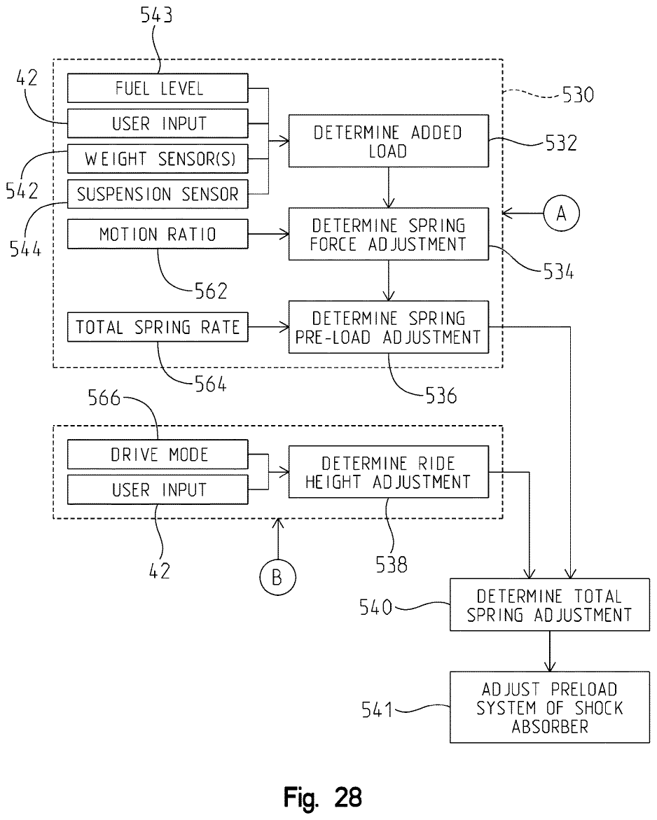

A suspension position sensor 544 (FIG. 28) may provide for real time measuring of shock length and wheel location in suspension travel. Suspension position sensor 544 is operatively coupled to electronic controller 50.

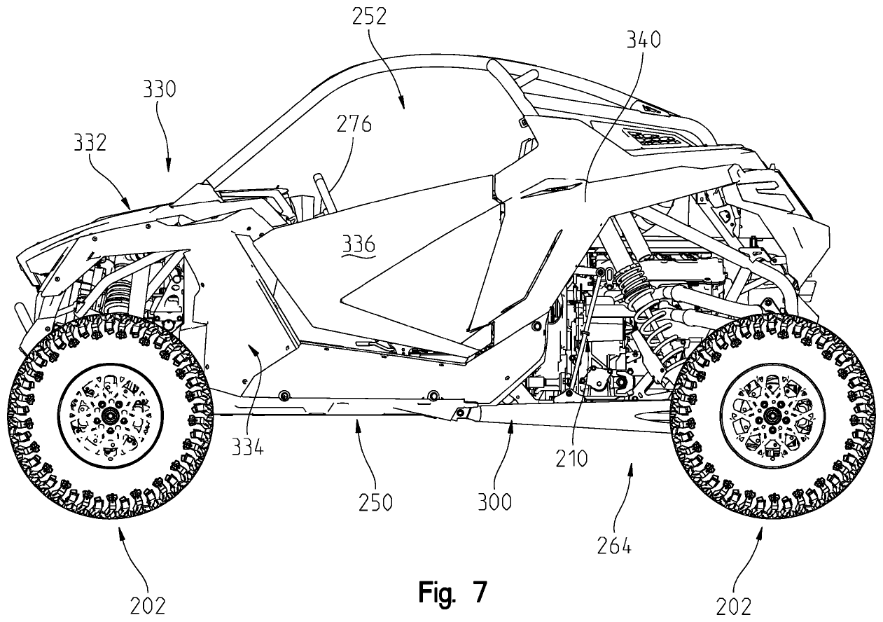

Referring to FIGS. 7, 8, and 11, rear suspensions 264 include trailing arms 300 rotatably coupled to a rear side of mid portion 253 of vehicle frame 250 at a first end and coupled to a wheel carrier (not shown) at a second end. Rear suspensions 264 further include lower control arms 302 and upper control arms 304 rotatably coupled to rear frame portion 255 of vehicle frame 250 at a first end and rotatably coupled to the wheel carrier at a second end. A rear differential 310 of power system 210 is also supported by rear portion 255 of vehicle frame 250 and is operatively coupled to the wheel carriers through half shafts 312 which rotate a portion of the wheel carriers to propel vehicle 200 relative to the ground. A rear axle 263 is generally defined as the components coupled between rear ground engaging members 202.

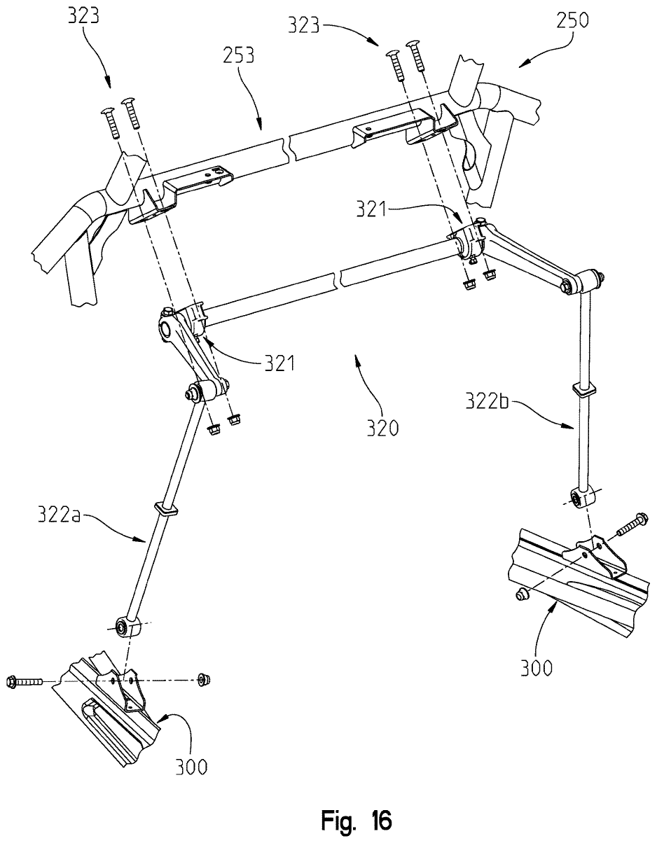

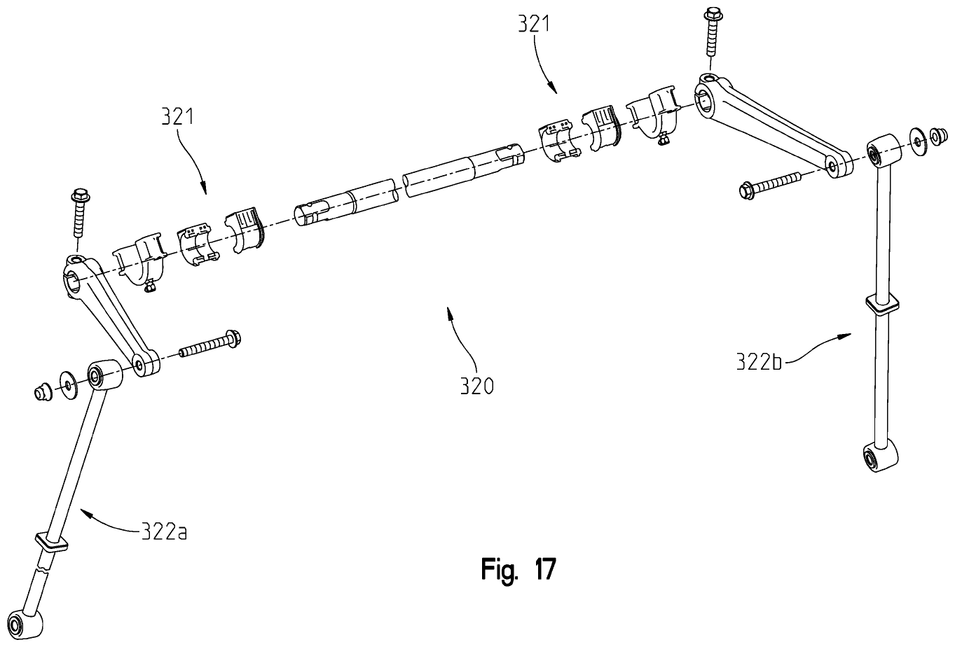

Referring to FIGS. 16 and 17, stabilizer bar 320 is rotatably coupled to a rear side of middle portion 253 of vehicle frame 250 through mounts 321 secured to vehicle frame 250 with fasteners 323. Links 322 are rotatably coupled to trailing arms 300 on a first end and are rotatably coupled to stabilizer bar 320 on a second end to couple rear suspensions 264, such that a vertical movement of one of rear suspensions 264 will initially cause a twisting of stabilizer bar 320 and further movement thereafter will cause a movement of the other of the rear suspensions 264 through the interconnection of stabilizer bar 320. In embodiments, links 322 include a rear left link 322a and a rear right link 322b. In embodiments, rear left link 322a and rear right link 322b are adjustable links, or adjustable members. In embodiments, at least one of rear left link 322a and rear right link 322b are adjustable links, or adjustable members. In embodiments, links 322a, 322b are solid links (i.e., solid rod). Adjustable links 322a, 322bb may be adjustable shock absorbers which couple stabilizer bar 320 to rear suspensions 264. Adjustable links 322a, 322b are rotatably coupled at a lower end to trailing arms 300 of the respective rear suspensions 264 and are rotatably coupled at an upper end to stabilizer bar 320. Each of adjustable links 322a, 322b are operatively coupled to electronic controller 50 which controls a damping characteristic, or operating state of each of links 322a, 322b. In embodiments, the adjustable links are adjustable between an unlocked state, a locked state, and a semi-active state. In embodiments, adjustable links are adjustable to an active state with variable damping.

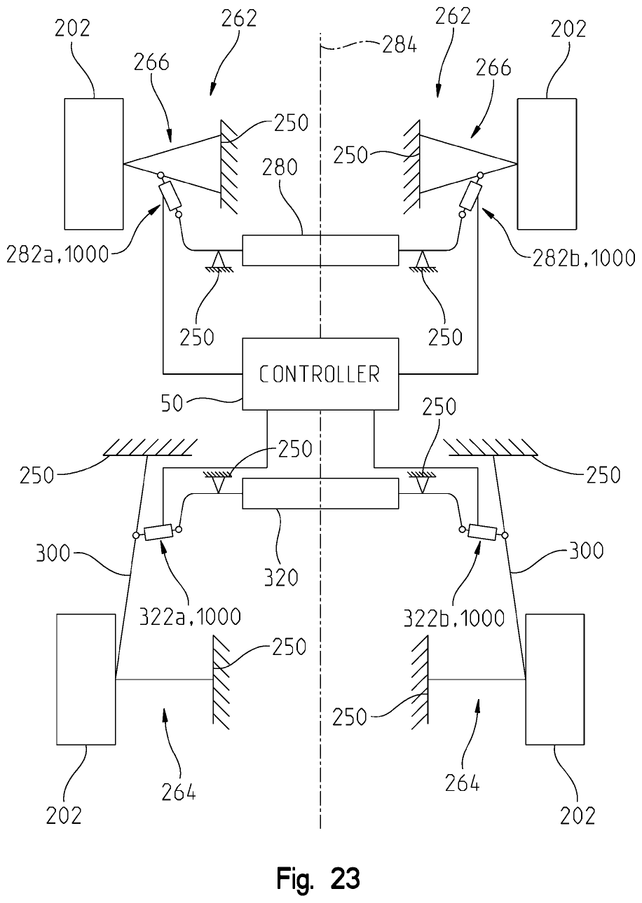

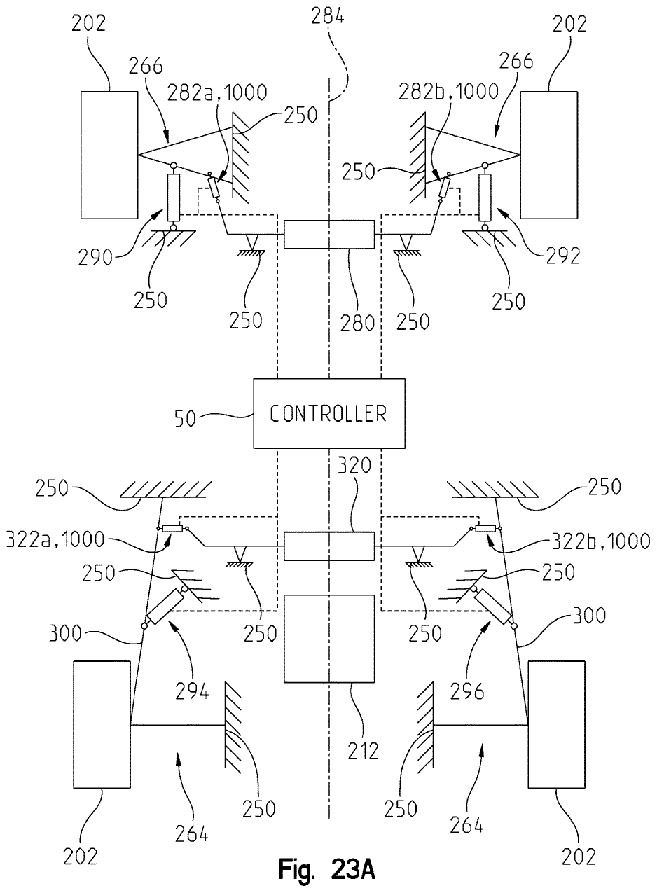

Referring to FIG. 23, each of front left link 282a and rear left link 322a are positioned on an operator side of centerline vertical plane 284 and each of front right link 282b and rear right link 322b are positioned opposite the operator side relative to centerline vertical plane 284 (e.g., right-side passenger). In embodiments, each of front left link 282a and front right link 282b are positioned longitudinally forward of seating area 252 and each of rear left link 322a and rear right link 322b are positioned longitudinally rearward of seating area 252.

Referring to FIG. 23A, in embodiments, rear stabilizer bar 320 may be positioned forwardly of prime mover 212. In embodiments, rear stabilizer bar 320 may be positioned longitudinally intermediate prime mover 212 and seating area 252. In embodiments, a portion of rear stabilizer bar 320 crosses over the vehicle centerline vertical plane 284 and the portion of rear stabilizer bar 320 that crosses over the vehicle centerline vertical plane 284 is positioned forwardly of prime mover 212.

Referring to FIG. 23B, in embodiments, rear stabilizer bar 320 may be positioned rearwardly of prime mover 212. In embodiments, rear stabilizer bar 320 may be positioned longitudinally intermediate a rearward extent of vehicle 200 and prime mover 212. In embodiments, a portion of rear stabilizer bar 320 crosses over the vehicle centerline vertical plane 284 and the portion of rear stabilizer bar 320 that crosses over the vehicle centerline vertical plane 284 is positioned rearwardly of prime mover 212.

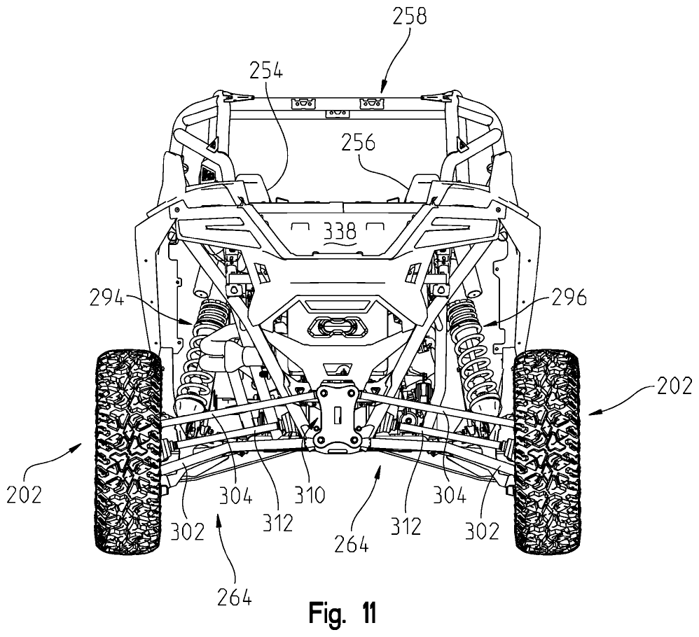

Referring to FIG. 24, rear suspensions 264 further include adjustable shocks, illustratively left rear electronically adjustable shock 294 on the operator side of vehicle centerline vertical plane 284 (see FIG. 11) of vehicle 200 and right rear electronically adjustable shock 296 on the passenger side of centerline vertical plane 284. Left rear electronically adjustable shock 294 and right rear electronically adjustable shock 296 are rotatably coupled at a lower end to trailing arms 300 of the respective rear suspensions 264 and rotatably coupled at an upper end to rear portion 255 of vehicle frame 250. Each of left rear electronically adjustable shock 294 and right rear electronically adjustable shock 296 are operatively coupled to electronic controller 50 which controls the compression damping characteristic and rebound damping characteristic of each of left rear electronically adjustable shock 294 and right rear electronically adjustable shock 296. In embodiments, each of shocks 294, 296 are not adjustable, or are manually adjustable (e.g., a clicker shock).

Referring to FIG. 23, a representation of vehicle 200 is provided. In embodiments, links 282a, 282b are adjustable shock absorbers 1000 which couple stabilizer bar 280 to front suspensions 262 and links 322a, 322b are replaced with adjustable shock absorbers 1000 which couple stabilizer bar 320 to rear suspensions 264. As shown in FIG. 23, each of links 282a, 282b and links 322a, 322b are replaced. In embodiments, only one of links 282a, 282b is replaced with an adjustable shock absorber 1000 and the other one of links 282a, 282b is a solid link such that stabilizer bar 280 is coupled to one of the front suspensions 262 through an adjustable shock absorber 1000 and to the other one of the front suspensions 262 through a solid link 282. In embodiments, only one of links 322a, 322b is replaced with an adjustable shock absorber 1000 and the other one of links 322a, 322b is a solid link such that stabilizer bar 320 is coupled to one of the rear suspensions 264 through an adjustable shock absorber 1000 and to the other one of the rear suspensions 264 through a solid link 322.

Adjustable shock absorbers 1000 are operatively coupled to electronic controller 50. By adjusting one or more characteristics of the respective adjustable shock absorber 1000, electronic controller 50 is able to adjust the amount of coupling between the respective front suspensions 262 and the respective rear suspensions 264. In embodiments, electronic controller 50 may control a characteristic of the adjustable shock absorber 1000 to cause adjustable shock absorber 1000 to act similar to a solid link in one scenario or to permit relative movement between the respective front suspension 262 or rear suspension 264 and the corresponding stabilizer bar 280 or 320 in another scenario.

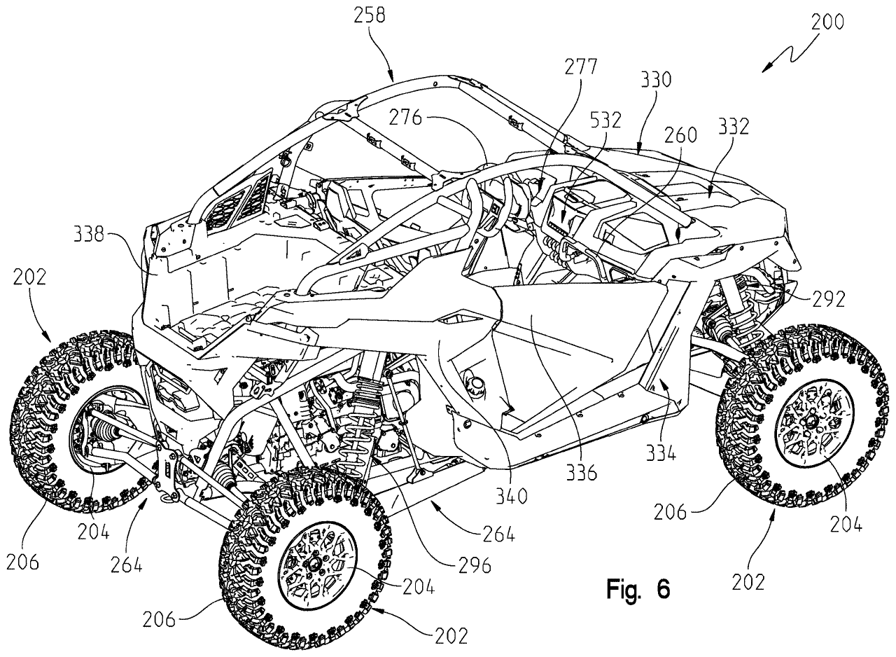

As shown vehicle 200 may also include an outer body 330 including a hood 332, side panels 334, doors 336, a utility cargo bed 338 (see FIG. 6) and rear panels 340. Vehicle 200, as described herein, may be further configured as shown in U.S. Pat. No. 8,827,028; U.S. patent application Ser. No. 16/458,797, published as US20200164742A1; U.S. patent application Ser. No. 16/244,462, published as US20190210668A1; and/or U.S. patent application Ser. No. 16/861,859, the entire disclosures of which are expressly incorporated by reference herein.

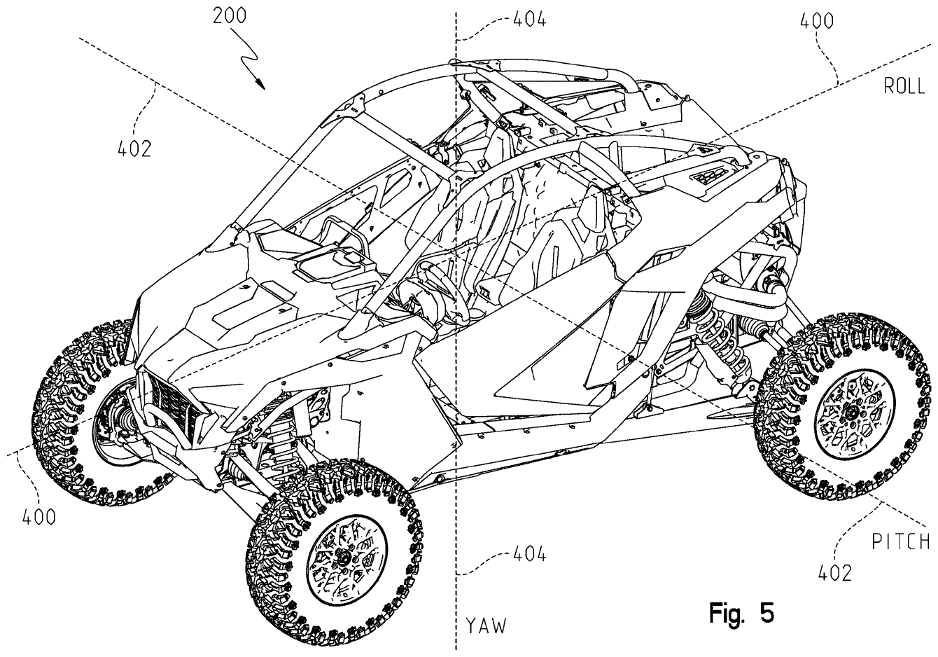

Referring to FIG. 5, a roll axis 400, a pitch axis 402, and a yaw axis 404 of vehicle 200 are shown. IMU 108 provides information to electronic controller 50 of the movement characteristics of vehicle 200 along and about roll axis 400 (longitudinal acceleration and roll angle rate), pitch axis 402 (lateral acceleration and pitch angle rate), and yaw axis 404 (vertical acceleration and yaw angle rate).

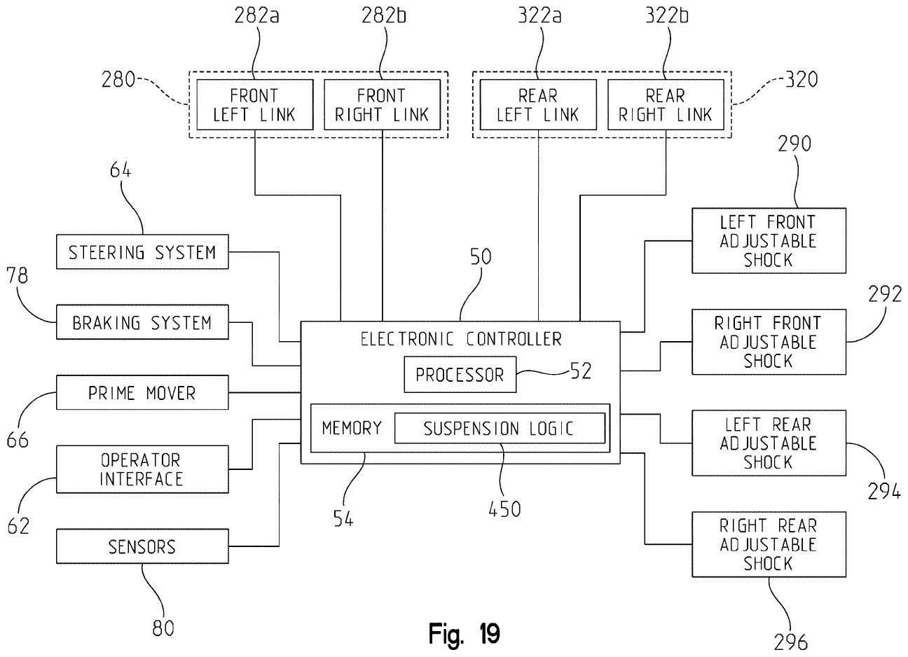

Referring to FIG. 19, electronic controller 50 includes suspension logic 450 which controls the damping characteristics of left front electronically adjustable shock 290, right front electronically adjustable shock 292, left rear electronically adjustable shock 294, right rear electronically adjustable shock 296, left front adjustable link 282a, right front adjustable link 282b, left rear adjustable link 322a, and rear right adjustable link 322b. The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium, such as memory 54, comprising logic 450 can additionally be considered to be embodied within any tangible form of a computer-readable carrier, such as solid-state memory, magnetic disk, and optical disk containing an appropriate set of computer instructions and data structures that would cause a processor 52 to carry out the processing sequences described herein. This disclosure contemplates other embodiments in which electronic controller 50 is not microprocessor-based, but rather is configured to control operation of left front electronically adjustable shock 290, right front electronically adjustable shock 292, left rear electronically adjustable shock 294, right rear electronically adjustable shock 296, left front adjustable link 282a, right front adjustable link 282b, left rear adjustable link 322a, and right rear adjustable link 322b based on one or more sets of hardwired instructions. In embodiments, suspension logic 450 is executed by suspension controller 90 of electronic controller 50.

Electronic controller 50 provides the electronic control of and/or monitors the various components of vehicle 200, illustratively steering system 64, braking system 78, prime mover 66, operator interface 62, and sensors 80. Exemplary sensors 80 are provided in FIG. 3 and throughout this disclosure.

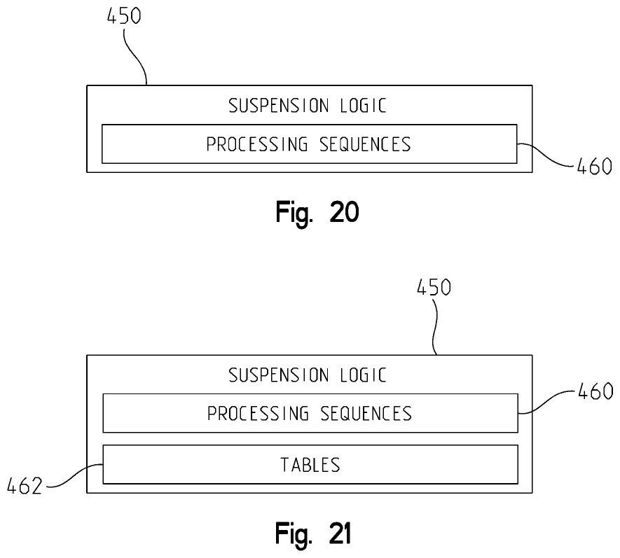

Referring to FIG. 20, suspension logic 450 includes one or more processing sequences 460 which control the damping characteristics of one or more of left front electronically adjustable shock 290, right front electronically adjustable shock 292, left rear electronically adjustable shock 294, and right rear electronically adjustable shock 296. In embodiments, suspension logic 450 includes one or more functions which based on one or more inputs output desired damping characteristics for each of left front electronically adjustable shock 290, right front electronically adjustable shock 292, left rear electronically adjustable shock 294, and right rear electronically adjustable shock 296. The desired damping characteristics may be the same for two or more or left front electronically adjustable shock 290, right front electronically adjustable shock 292, left rear electronically adjustable shock 294, and right rear electronically adjustable shock 296 or different for each of left front electronically adjustable shock 290, right front electronically adjustable shock 292, left rear electronically adjustable shock 294, and right rear electronically adjustable shock 296. In embodiments, the exemplary processing sequences, in embodiments, have varying arbitration priorities based on inputs received and the desired performance of vehicle 200.

Processing sequences 460 may also control the damping characteristics, or operational states, of one or more of front left adjustable link 282a, front right adjustable link 282b, rear left adjustable link 322a, and rear right adjustable link 322b. In embodiments, suspension logic 450 includes one or more functions which based on one or more inputs output desired damping characteristics for each of front left adjustable link 282a, front right adjustable link 282b, rear left adjustable link 322a, and rear right adjustable link 322b. The desired damping characteristic or operational state may be the same for two or more of any of front left adjustable link 282a, front right adjustable link 282b, rear left adjustable link 322a, and rear right adjustable link 322b or different for each of front left adjustable link 282a, front right adjustable link 282b, rear left adjustable link 322a, and rear right adjustable link 322b. In embodiments, the exemplary processing sequences, in embodiments, have varying arbitration priorities based on inputs received and the desired performance of vehicle 200.

In embodiments, suspension logic 450 includes one or more processing sequences 460 that simultaneously control the damping characteristics and/or operating states of any of left front electronically adjustable shock 290, right front electronically adjustable shock 292, left rear electronically adjustable shock 294, right rear electronically adjustable shock 296, left front adjustable link 282a, right front adjustable link 282b, left rear adjustable link 322a, and right rear adjustable link 322b.

Referring to FIG. 21, suspension logic 450 includes one or more processing sequences 460 which control the damping characteristics of one or more of left front electronically adjustable shock 290, right front electronically adjustable shock 292, left rear electronically adjustable shock 294, and right rear electronically adjustable shock 296 and one or more look-up tables 462 which based on one or more inputs provides damping characteristics for each of left front electronically adjustable shock 290, right front electronically adjustable shock 292, left rear electronically adjustable shock 294, and right rear electronically adjustable shock 296. The exemplary processing sequences, in embodiments, have varying arbitration priorities based on inputs received and the desired performance of vehicle 200.

In embodiments, electronic controller 50 updates the damping characteristics, or operational state, of left front electronically adjustable shock 290, right front electronically adjustable shock 292, left rear electronically adjustable shock 294, right rear electronically adjustable shock 296, left front adjustable link 282a, right front adjustable link 282b, left rear adjustable link 322a, and right rear adjustable link 322b during movement of vehicle 200. Electronic controller 50 continuously controls left front electronically adjustable shock 290, right front electronically adjustable shock 292, left rear electronically adjustable shock 294, and right rear electronically adjustable shock 296 by updating the desired damping characteristics of left front electronically adjustable shock 290, right front electronically adjustable shock 292, left rear electronically adjustable shock 294, and right rear electronically adjustable shock 296 based on monitored sensor values, received operator inputs, and/or other inputs at discrete instances of time. Additionally, electronic controller 50 continuously controls left front adjustable link 282a, right front adjustable link 282b, left rear adjustable link 322a, and right rear adjustable link 322b by updating the desired damping characteristics, or operational state, of left front adjustable link 282a, right front adjustable link 282b, left rear adjustable link 322a, and right rear adjustable link 322b based on monitored sensor values, received operator inputs, and/or other inputs at discrete instances of time. An exemplary time interval for controlling left front electronically adjustable shock 290, right front electronically adjustable shock 292, left rear electronically adjustable shock 294, right rear electronically adjustable shock 296, left front adjustable link 282a, right front adjustable link 282b, left rear adjustable link 322a, and right rear adjustable link 322b is about 1 milli-seconds to about 5 milliseconds. For example, electronic controller 50 updates targets for each of left front electronically adjustable shock 290, right front electronically adjustable shock 292, left rear electronically adjustable shock 294, and right rear electronically adjustable shock 296 about every 5 milliseconds and updates the current control loop about every milli-second. In embodiments, electronic controller 50 updates targets for each of left front adjustable link 282a, right front adjustable link 282b, left rear adjustable link 322a, and right rear adjustable link 322b about every 5 milliseconds and updates the current control loop about every millisecond.

In embodiments, the adjustable links 282a, 282b, 322a, 322b may be adjustable between an unlocked state, locked state, and semi-active state to adjust the stiffness of the links 282, 282b, 322a, 322b. In embodiments, a compression damping characteristic of adjustable links 282a, 282b, 322a, 322b may be adjustable to adjust a stiffness of the links 282a, 282b, 322a, 322b. In embodiments, a rebound damping characteristic of adjustable links 282a, 282b, 322a, 322b may be adjustable to adjust a stiffness of the links 282a, 282b, 322a, 322b. That is, adjustable links 282a, 282b, 322a, 322b may have varying levels of stiffness based upon the current operating state or damping characteristic.

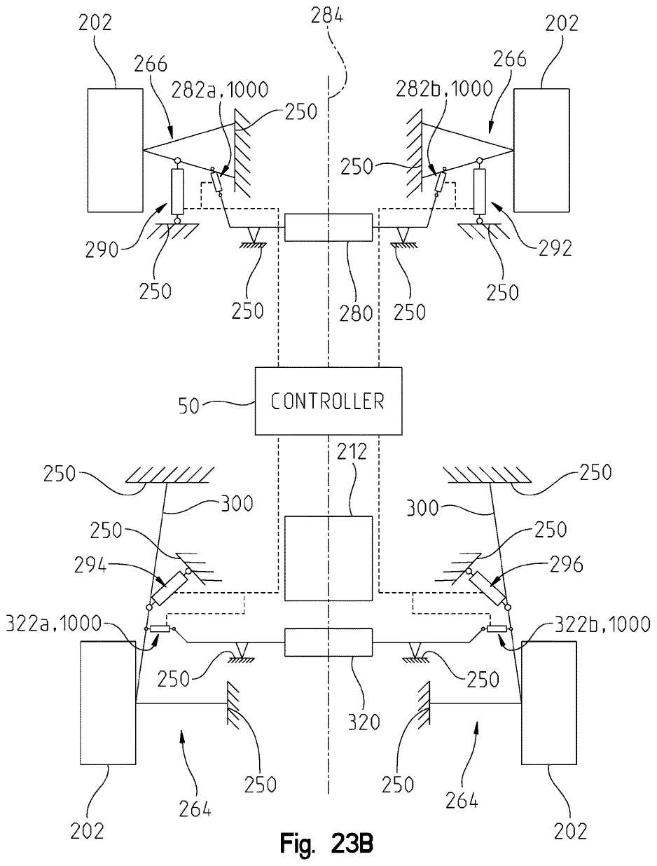

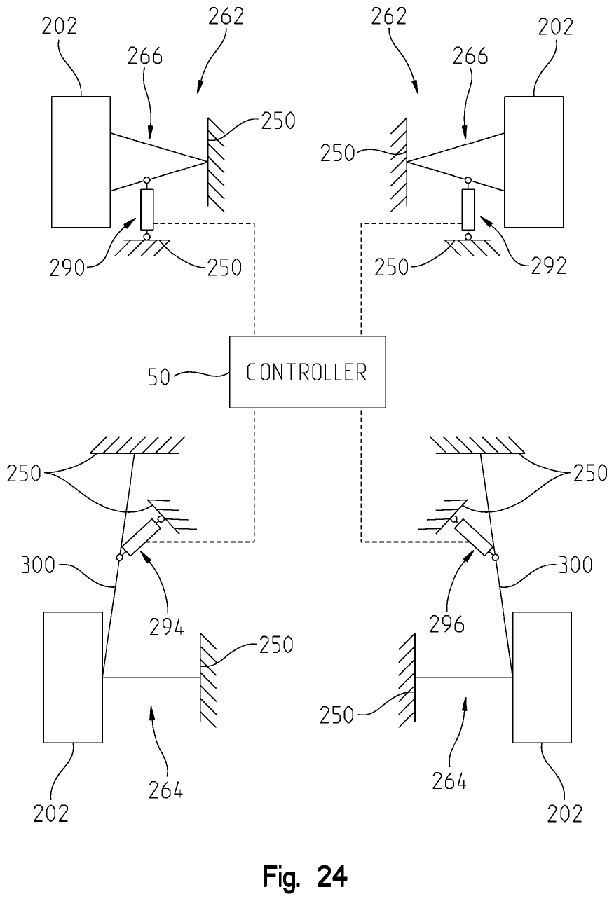

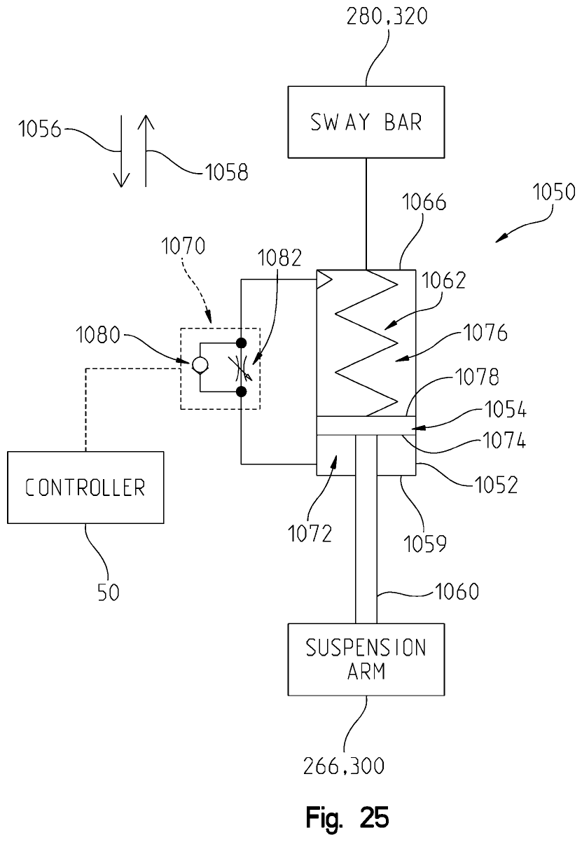

Referring to FIG. 25, an adjustable shock 1050 which may be implemented as adjustable shock absorber 1000 for any of links 282a, 282b, 322a, 322b is illustrated. Adjustable shock absorber 1050 includes a body 1052 having an interior in which a piston 1054 reciprocates in directions 1056, 1058. In the illustrated embodiment, a shaft 1060 moveable with piston 1054 extends from an end 1059 of body 1052 and is moveably coupled to a suspension arm 266 or 300. Another end 1066 of body 1052 is moveably coupled to stabilizer bar 280 or 320. A spring 1062 is included internal to body 1052 to bias piston 1054 in direction 1056 by being compressed between end 1066 of body 1052 and piston 1054. In other embodiments, spring 1062 is positioned external to body 1052 and compressed between spring stops (not shown); one spring stop carried by body 1052 and another spring stop carried by shaft 1060. In embodiments, adjustable shock absorber 1050 does not include an associated spring. An advantage, among others, of including an associated spring is the biasing of shock absorber 1050 towards an extended position. In embodiments, the effect of the spring may be accomplished through gas pressure.

An external fluid control circuit 1070 is provided. Fluid control circuit 1070 controls the movement of fluid from an interior chamber 1072 in the interior of body 1052 and bounded by a first side 1074 of piston 1054 and an interior chamber 1076 in the interior of body 1052 and bounded by a second side 1078 of piston.

The ability and the degree of the ease of movement of fluid between chambers 1072 and 1076 along with the stiffness of spring 1062 control the stiffness of adjustable shock absorber 1050. External fluid control circuit 1070 includes a rebound bypass bleed valve 1080 that permits fluid to move from chamber 1072 to chamber 1076; thereby allowing piston 1054 to move in direction 1056 resulting in a length of adjustable shock absorber 1050 extending. In embodiments, bleed valve 1080 is a one-way valve only allowing fluid movement from interior chamber 1072 to interior chamber 1076.

External fluid control circuit 1070 further includes an electronically controlled compression bypass valve 1082. Valve 1082 controls the movement of fluid from chamber 1076 to chamber 1072; thereby allowing piston 1054 to move in direction 1058 and shorten a length of adjustable shock absorber 1050. In embodiments, valve 1082 is an on/off valve and when in the on setting permits the movement of fluid from chamber 1076 to chamber 1072 and in the off setting prevents the movement of fluid from chamber 1076 to chamber 1072. Electronic controller 50 controls the operation of valve 1082 between the on setting and the off setting. In the off setting of valve 1082, adjustable shock absorber 1050 acts similar to a solid link, such as link 282 or link 322. In embodiments, valve 1082 has a variable opening having an off setting (closed) and a plurality of on settings (partial open to full open), each having a different rate of permitted fluid flow from chamber 1076 to chamber 1072. Electronic controller 50 controls the operation of valve 1082 including the permitted flow rate in the various on settings and between the various on settings and the off setting.

With the arrangement shown in FIG. 25, adjustable shock absorber 1050 when electronically controlled compression bypass valve 1082 is closed the position of piston 1054 is locked in compression (the adjustable shock absorber 1050 performs generally like a rigid link by limiting movement of piston 1054 in direction 1058) and the position of piston 1054 is free to move in rebound (movement of piston 1054 in direction 1056). When electronically controlled compression bypass valve 1082 is open the position of piston 1054 is free to move in compression (movement of piston 1054 in direction 1058) and the position of piston 1054 is free to move in rebound (movement of piston 1054 in direction 1056).

In embodiments, bypass valve 1082 is a two-way locking valve, and when the two-way locking valve 1082 is closed the position of piston 1054 is locked in compression (the adjustable shock absorber 1050 performs generally like a rigid link by limiting movement of piston 1054 in direction 1058) and the position of piston 1054 is also locked in rebound (the adjustable shock absorber 1050 performs generally like a rigid link by limiting movement of piston 1054 in direction 1056). In embodiments, when bypass valve 1082 is a two-way locking valve, fluid is only permitted to move from chamber 1072 to chamber 1076 through rebound bleed valve 1080; thereby allowing piston 1054 to move in direction 1056 resulting in a length of adjustable shock absorber 1050 extending.

In embodiments, electronic controller 50 is configured to control each of left front adjustable link 282a, right front adjustable link 282b, left rear adjustable link 322a, right rear adjustable link 322b between an unlocked state (i.e., open state), a locked state (i.e., a closed state), and a semi-active state.

In the unlocked state, the adjustable link (or shock absorber 1000) is able to move (i.e., shorten and/or lengthen) freely because electronic bypass valve 1082 is open, such that piston 1054 is free to move in either direction 1056 or 1058 and fluid is free to move back and forth between chambers 1072 and 1076.

In the locked state, the adjustable link (or shock absorber 1000) is limited from moving (e.g., shorten and/or lengthen). In embodiments, in the locked state, the shock absorber 1000 is restricted from moving. That is, I electronic bypass valve 1082 is closed, such that piston 1054 is locked in compression (e.g., restricted from moving in direction 1058). In the locked state, fluid may still move through bypass valve 1080, and piston 1054 is biased in direction 1056 by spring 1062. That is, in the locked state, shock absorber 1000 will generally lengthen because it is unable to move in compression (i.e., direction 1058), and it will move in rebound (i.e., direction 1056) under one or more of the weight of the suspension arm 266, 300 and the force of the spring 1062. In embodiments, the adjustable link (or shock absorber 1000) may be locked when piston 1054 is positioned at a vertical intermediate point of body 1052, and piston 1054 may subsequently move towards a fully extended position (i.e., in direction 1056).

In the semi-active state, controller 50 is configured to control the adjustable link (or shock absorber 1000) actively between the unlocked state and the locked state based upon one or more inputs.

In embodiments, shock absorber 1000 is configured as a variably adjustable shock absorber such that a damping characteristic may be altered to create a softer or firmer damping level. In embodiments, controller 50 is configured to control the compression damping characteristic (e.g., increase or decrease) and control the rebound damping characteristic (e.g., increase or decrease) of shock absorber 1000. Additional details regarding adjusting compression and rebound damping are found in U.S. patent application Ser. No. 16/198,280, filed Nov. 21, 2018, titled VEHICLE HAVING ADJUSTABLE COMPRESSION AND REBOUND DAMPING; and U.S. patent application Ser. No. 17/379,675, filed Jul. 19, 2021, titled ADJUSTABLE SUSPENSIONS AND VEHICLE OPERATION FOR OFF-ROAD RECREATIONAL VEHICLES, the entire disclosures of which are incorporated herein by reference.

Suspension logic 450, based on inputs from operator interface 62 and one or more sensors 80 adjusts the damping characteristics of left front electronically adjustable shock 290, right front electronically adjustable shock 292, left rear electronically adjustable shock 294, and right rear electronically adjustable shock 296 based on various conditions. In embodiments, suspension logic 450 adjusts the compression and/or rebound damping characteristics for one or more of left front electronically adjustable shock 290, right front electronically adjustable shock 292, left rear electronically adjustable shock 294, and right rear electronically adjustable shock 296 based on a determination that vehicle 200 is cornering, braking, accelerating, airborne, landing, sliding, traveling on flat ground, traveling uphill, traveling downhill, traveling over whoops, rock crawling, counter steering, selected vehicle modes, based on monitored sensor values, and other monitored conditions. Exemplary processing sequences for the above and other conditions are provided in U.S. patent application Ser. No. 16/013,210, filed Jun. 20, 2018, titled VEHICLE HAVING SUSPENSION WITH CONTINUOUS DAMPING CONTROL; U.S. patent application Ser. No. 16/529,001, filed Aug. 1, 2019, titled ADJUSTABLE VEHICLE SUSPENSION SYSTEM; U.S. patent application Ser. No. 15/816,368, filed Nov. 17, 2017, titled ADJUSTABLE VEHICLE SUSPENSION SYSTEM; U.S. patent application Ser. No. 16/198,280, filed Nov. 21, 2018, titled VEHICLE HAVING ADJUSTABLE COMPRESSION AND REBOUND DAMPING; U.S. Provisional Application Ser. No. 63/027,833, filed May 20, 2020, titled SYSTEMS AND METHODS OF ADJUSTABLE SUSPENSIONS FOR OFF-ROAD RECREATIONAL VEHICLES, docket PLR-01-29147.01P-US; and U.S. Provisional Application Ser. No. 63/053,278, filed Jul. 17, 2020, titled VEHICLE HAVING ADJUSTABLE COMPRESSION AND REBOUND DAMPING, docket PLR-15-29249.01P-US, the entire disclosures of which are expressly incorporated by reference herein.

In embodiments, suspension logic 450, based on inputs from operator interface 62 and one or more sensors 80 adjusts the operational state (e.g., unlocked, locked) and/or damping characteristics of left front adjustable link 282a, right front adjustable link 282b, left rear adjustable link 322a, and right rear adjustable link 322b based on various conditions. In embodiments, suspension logic 450 adjusts the compression and/or rebound damping characteristics and/or the operating states for one or more of left front adjustable link 282a, right front adjustable link 282b, left rear adjustable link 322a, and right rear adjustable link 322b based on a determination that vehicle 200 is cornering, braking, accelerating, airborne, landing, sliding, traveling on flat ground, traveling uphill, traveling downhill, traveling over whoops, rock crawling, counter steering, selected vehicle modes, based on monitored sensor values, and other monitored conditions.

In embodiments, suspension logic 450 predicts acceleration of vehicle 200 along one or more of roll axis 400 (longitudinal acceleration), pitch axis 402 (lateral acceleration), and yaw axis 404 (vertical acceleration) and/or predicts an angular motion of vehicle 200 about one or more of roll axis 400, pitch axis 402, and yaw axis 404 and updates the damping characteristics, or operational states, of one or more of left front electronically adjustable shock 290, right front electronically adjustable shock 292, left rear electronically adjustable shock 294, right rear electronically adjustable shock 296, left front adjustable link 282a, right front adjustable link 282b, left rear adjustable link 322a, and right rear adjustable link 322b based thereon or in combination with other inputs and sensed values. Additional details regarding predicted longitudinal acceleration can be found below and in U.S. patent application Ser. No. 17/325,062, the entire disclosure of which is expressly incorporated by reference herein.

In embodiments, a longitudinal acceleration of vehicle 200 is measured based on one or more inputs, such as IMU 132, estimated based on one or more inputs, such as a monitored throttle position and/or a monitored engine rpm, or predicted based on one or more inputs as described herein.

In embodiments, for the predicted longitudinal acceleration of vehicle 200, electronic controller 50 actively reviews the engine torque and/or throttle position and adjusts the compression and rebound damping characteristics of at least one of the left front electronically adjustable shock 290, right front electronically adjustable shock 292, left rear electronically adjustable shock 294, and right rear electronically adjustable shock 296 to counter predicted motion of vehicle 200, such as diving (pitching forward about pitch axis 402) or squatting (pitching rearward about pitch axis 402). In an example, vehicle 200 is traveling at a higher speed (open throttle) and the operator drops the throttle to 0%. In response, electronic controller 50 increases the compression damping in left front electronically adjustable shock 290 and right front electronically adjustable shock 292 to counter a front end dive of vehicle 200 and increases the rebound damping in left rear electronically adjustable shock 294 and right rear electronically adjustable shock 296 to counter the lifting of the rear end of vehicle 200.

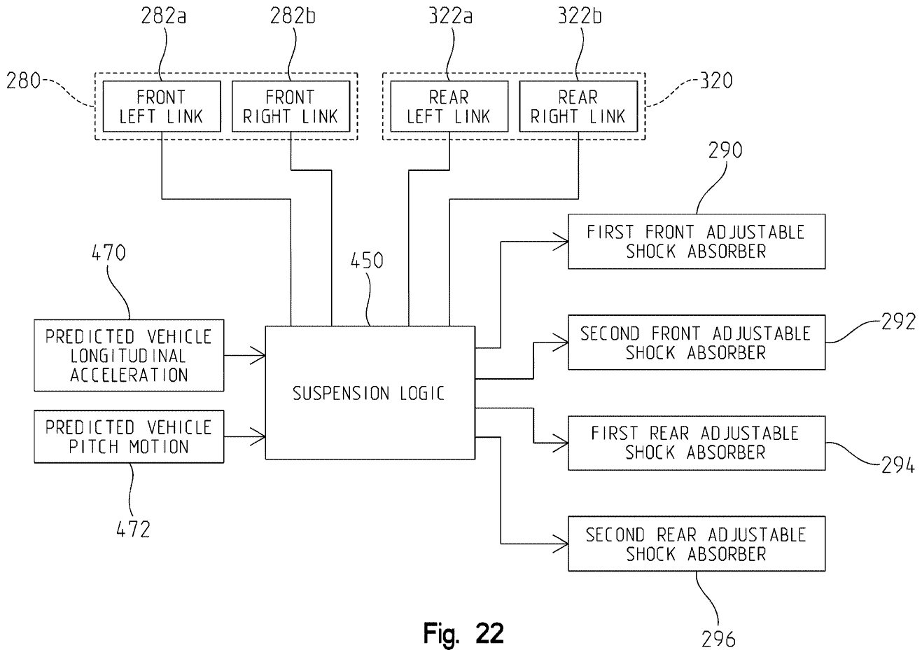

Referring to FIG. 22, in embodiments, suspension logic 450 receives a predictive longitudinal acceleration 470 of vehicle 200 and a predictive pitch motion 472 of vehicle 200 and assigns damping characteristics, or operational states, for one or more of left front electronically adjustable shock 290, right front electronically adjustable shock 292, left rear electronically adjustable shock 294, right rear electronically adjustable shock 296, left front adjustable link 282a, right front adjustable link 282b, left rear adjustable link 322a, and right rear adjustable link 322b based on one or both of the predicted longitudinal acceleration 470 of vehicle 200 and the predictive pitch motion 472 of vehicle 200. Suspension logic 450, in embodiments, includes a damping characteristic table (compression damping only, rebound damping only, or both compression and rebound damping) for each of left front electronically adjustable shock 290, right front electronically adjustable shock 292, left rear electronically adjustable shock 294, and right rear electronically adjustable shock 296 based on predicted vehicle longitudinal acceleration 470 of vehicle 200 and/or predicted vehicle pitch 472 of vehicle 200.

As explained in US Published Patent Application No. US2020/0156430, the entire disclosure of which is expressly incorporated by reference herein, the damping characteristics of left front electronically adjustable shock 290, right front electronically adjustable shock 292, left rear electronically adjustable shock 294, and right rear electronically adjustable shock 296 are adjusted during cornering. In embodiments, the characteristics of stabilizer bar 280 and stabilizer bar 320 may also be adjusted during cornering. That is, the operational state, or damping characteristic of links 282a, 282b, 322a, 322b may also be adjusted during cornering. The characteristics of left front electronically adjustable shock 290, right front electronically adjustable shock 292, left rear electronically adjustable shock 294, and right rear electronically adjustable shock 296, front-left adjustable link 282a, front-right adjustable link 282b, rear-left adjustable link 322a, and rear-right adjustable link 322b may be adjusted based on a detection of a cornering of vehicle 200 and on the location in a corner (corner entry, mid-corner, corner exit). As discussed in US Published Patent Application No. US2020/0156430, the entire disclosure of which is expressly incorporated by reference herein, the detection of a cornering of vehicle 200 and the location in a corner may be detected based on one or more sensor values. In embodiments, the sharpness of the corner and/or the speed of the vehicle are further considered in the characteristics of left front electronically adjustable shock 290, right front electronically adjustable shock 292, left rear electronically adjustable shock 294, and right rear electronically adjustable shock 296 and front-left adjustable link 282a, front-right adjustable link 282b, rear-left adjustable link 322a, and rear-right adjustable link 322b.

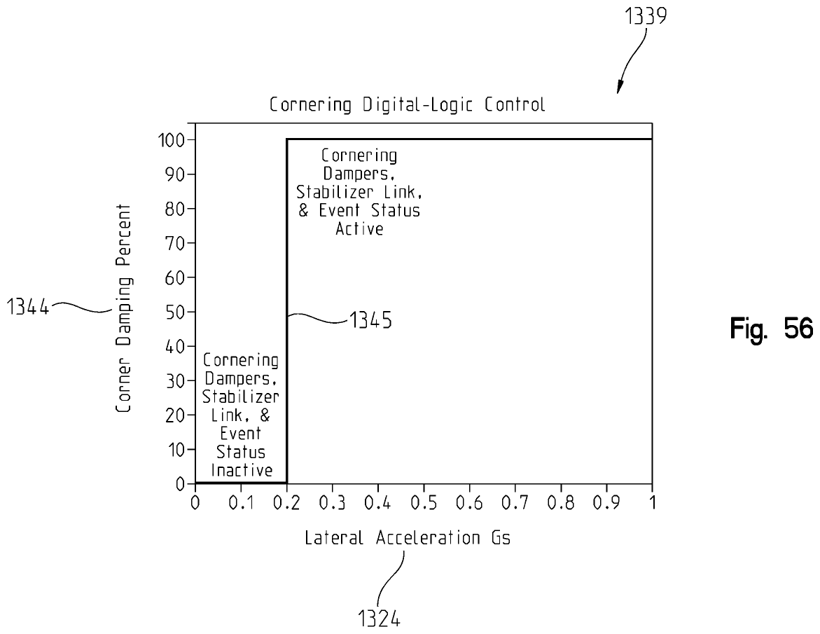

In embodiments, electronic controller 50 determines whether vehicle 200 is cornering (e.g., a turn). Further, electronic controller 50 determines a direction of the turn (e.g., a left turn or a right turn). For example, electronic controller 50 may determine vehicle 200 is cornering and/or direction of the turn based on the steering information indicating a steering rate, angle, and/or position, yaw rate information indicating a yaw rate, and/or the acceleration information indicating a lateral acceleration. Electronic controller 50 may compare the steering rate, steering angle, steering position, yaw rate, and/or lateral acceleration with one or more corresponding thresholds (e.g., pre-determined, pre-programmed, and/or user-defined) to determine if vehicle 200 is cornering. Referring to FIG. 56, controller 50 is operable to determine a cornering event based upon a determined lateral acceleration 1324 experienced by vehicle 200. As shown in FIG. 56, a graph 1339 illustrates a curve 1345 displaying a damping percent 1344 as a function of lateral acceleration 1324. In embodiments, curve 1345 is one two-dimensional component of a three-dimensional graph, wherein the curve 1345 further varies with vehicle speed. In embodiments, controller 50 may determine that vehicle 200 is in a cornering event when the measured lateral acceleration 1324 reaches 0.2 Gs (e.g., 1 G equals approximately 9.8 m/s\hat{ }2; 0.2 Gs equals approximately 1.96 m/s\hat{ }2). In embodiments, the damping value of one or more of shock absorbers 290, 292, 294, 296 and one or more of links 282a, 282b, 322a, 322b may be altered in response to controller 50 determining vehicle 200 has entered a cornering event. Electronic controller 50 may use the positive and/or negative values of the steering rate, angle, position, yaw rate, and/or lateral acceleration to determine the direction of the turn. Further, electronic controller 50 determines whether vehicle 200 is entering, in the middle of, and/or exiting a corner. Additional details regarding determining when vehicle 200 is cornering, a direction of the turn, and whether vehicle 200 is in the entry of the turn, middle of the turn, or exiting the turn are provided in US Published Patent Application No. US2020/0156430, the entire disclosure of which is expressly incorporated by reference herein.

In embodiments, a vertical acceleration along axis 404 (FIG. 5) is monitored by IMU 108. By monitoring vertical acceleration, electronic controller 50 may determine when vehicle 200 is airborne and when vehicle 200 lands. Additional methods of detecting when vehicle 200 is airborne and when vehicle 200 lands are provided in U.S. patent application Ser. No. 16/013,210, filed Jun. 20, 2018, titled VEHICLE HAVING SUSPENSION WITH CONTINUOUS DAMPING CONTROL; U.S. patent application Ser. No. 16/529,001, filed Aug. 1, 2019, titled ADJUSTABLE VEHICLE SUSPENSION SYSTEM; U.S. patent application Ser. No. 15/816,368, filed Nov. 17, 2017, titled ADJUSTABLE VEHICLE SUSPENSION SYSTEM; U.S. patent application Ser. No. 16/198,280, filed Nov. 21, 2018, titled VEHICLE HAVING ADJUSTABLE COMPRESSION AND REBOUND DAMPING; U.S. Provisional Application Ser. No. 63/027,833, filed May 20, 2020, titled SYSTEMS AND METHODS OF ADJUSTABLE SUSPENSIONS FOR OFF-ROAD RECREATIONAL VEHICLES, docket PLR-01-29147.01P-US; and U.S. Provisional Application Ser. No. 63/053,278, filed Jul. 17, 2020, titled VEHICLE HAVING ADJUSTABLE COMPRESSION AND REBOUND DAMPING, docket PLR-15-29249.01P-US, and U.S. patent application Ser. No. 17/379,675, filed Jul. 19, 2021, titled ADJUSTABLE SUSPENSIONS AND VEHICLE OPERATION FOR OFF-ROAD RECREATIONAL VEHICLES, docket no. PLR-15-29249.04P-US, the entire disclosures of which are expressly incorporated by reference herein.

In embodiments, controller 50 may determine whether a sliding event is occurring based on steering information indicating a steering rate, angle, and/or position, yaw rate information indicating a yaw rate, the acceleration information indicating a lateral and/or longitudinal acceleration, and/or other information (e.g., a pitch angle or rate). Controller 50 may compare the steering rate, steering angle, steering position, yaw rate, lateral acceleration, and/or longitudinal acceleration with one or more thresholds (e.g., pre-determined, pre-programmed, and/or user-defined) to determine the sliding event. In some instances, the detection of the sliding event may be similar to the detection of the cornering event. Further, the commands to adjust the damping of the shock absorbers 290, 292, 294, 296 based on the detection of the sliding event may be similar to the cornering event. For example, the controller 50 may prioritize the steering information, the yaw rate information, and/or the acceleration information to determine the sliding event. In other words, the steering position and/or angle, steering rate, yaw rate, and/or lateral acceleration may conflict, and the controller 50 may prioritize the lateral acceleration over the steering position, angle, rate and/or the yaw rate. For example, the controller 50 may determine the sliding event is occurring based on the lateral acceleration value exceeding (e.g., above or below) a lateral acceleration threshold even if the yaw rate, steering rate, angle, and/or position do not exceed their corresponding thresholds.

In embodiments, controller 50 may determine whether a spinning event is occurring based on steering information indicating a steering rate, angle, and/or position, an angular characteristic such as yaw rate information indicating a yaw rate, the acceleration information indicating a lateral and/or longitudinal acceleration, engine speed, ground speed, brake information indicating a brake input, and/or other information (e.g., a pitch angle or rate). Controller 50 may compare the steering rate, steering angle, steering position, yaw rate, lateral acceleration, and/or longitudinal acceleration with one or more thresholds (e.g., pre-determined, pre-programmed, and/or user-defined) to determine the spinning event. In embodiments, controller 50 determines vehicle 200 is spinning by comparing an angular characteristic of the vehicle, such as the yaw rotation rate, to a spinning threshold, which may be different than the cornering threshold. If the magnitude of the yaw rotation rate exceeds the spinning threshold, controller 50 determines that vehicle 200 is spinning. In one example, the angular characteristic is the yaw rotation rate and the spinning threshold is about 100 degrees per second. In another example, the angular characteristic is a change in the direction of travel of the vehicle of at least 90 degrees over a period of time. In some instances, the detection of the spinning event may be similar to the detection of the cornering event. Further, the commands to adjust the damping of the shock absorbers 290, 292, 294, 296 based on the detection of the spinning event may be similar to the cornering event. In embodiments, controller 50 may determine whether a spinning event is occurring based upon a total rotation of vehicle 200. Controller 50 may determine that vehicle 200 has spun around when vehicle 200 has made a complete rotation (e.g., 360 degrees) within a predetermined amount of time. In embodiments, controller 50 may lock one or more of links 282a, 282b, 322a, 322b upon a determination that vehicle 200 is experiencing a spinning event. In embodiments, controller 50 may lock each of links 282a, 282b, 322a, 322b upon a determination that vehicle 200 is experiencing a spinning event. In embodiments, controller 50 may lock one of links 282a, 282b and one of links 322a, 322b upon a determination that vehicle 200 is experiencing a spinning event. Additional details regarding detection of a spinning event and corresponding adjustments to shock absorbers 290, 292, 294, 296 are discussed in U.S. patent application Ser. No. 17/355,650, filed Jun. 23, 2021, titled VEHICLE HAVING ADJUSTABLE SUSPENSION, attorney docket no. PLR-15-25091.08P-02-US, the entire disclosure of which is expressly incorporated herein by reference.

In embodiments, input devices 42 includes at least one user actuatable input on the steering wheel 276. Input devices 42 on steering wheel 276 may include a first user actuatable input 570, a second user actuatable input 572, and a third user actuatable input 574 (FIG. 11A). Each of first user actuatable input 570, second user actuatable input 572, third user actuatable input 574 are operably coupled to controller 50. In embodiments, first user actuatable input 570 is configured to cycle through, or alter, an operating mode, or drive mode (e.g., baja, track, race, comfort, etc.). In embodiments, an input to second user actuatable input 572 is configured to temporarily alter the suspension damping characteristic (“TASD Request”) of one or more of shock absorbers 290, 292, 294, 296. In embodiments, an input to second user actuatable input 572 is configured to increase a compression damping of each of shock absorbers 290, 292, 294, 296 to a full-firm setting. In embodiments, an input to third user actuatable input 574 is configured to provide an instantaneous request to alter a damping characteristic of one or more of shock absorbers 290, 292, 294, 296. In embodiments, an input to third user actuatable input 574 is configured to decrease a compression damping of each of shock absorbers 290, 292, 294, 296. Additional details regarding temporarily altering the suspension damping characteristic may be found in U.S. patent application Ser. No. 17/176,110, filed Feb. 15, 2021, titled ADJUSTABLE VEHICLE SUSPENSION SYSTEM, the entire disclosure of which is expressly incorporated by reference herein.

In embodiments, an input to one or more of first user actuatable input 570, second user actuatable input 572, third user actuatable input 574 may alter an operating state, or damping characteristic of one or more of front left link 282a, front right link 282b, rear left link 322a, and rear right link 322b. In embodiments, an input to one or more of first user actuatable input 570, second user actuatable input 572, third user actuatable input 574 is configured to alter a damping characteristic of one or more of shock absorbers 290, 292, 294, 296 and one or more of links 282a, 282b, 322a, and 322b. In embodiments, an input to third user actuatable input 574 is configured to increase a compression damping characteristic of each of shock absorbers 290, 292, 294, 296 to a full-firm and alter an operating characteristic of each of links 282a, 282b, 322a, 322b to a locked state. In embodiments, an input to third user actuatable input 574 is configured to decrease a compression damping characteristic of each of shock absorbers 290, 292, 294, 296 and alter an operating characteristic of each of links 282a, 282b, 322a, 322b to an unlocked state.

### Ride Height Adjustment

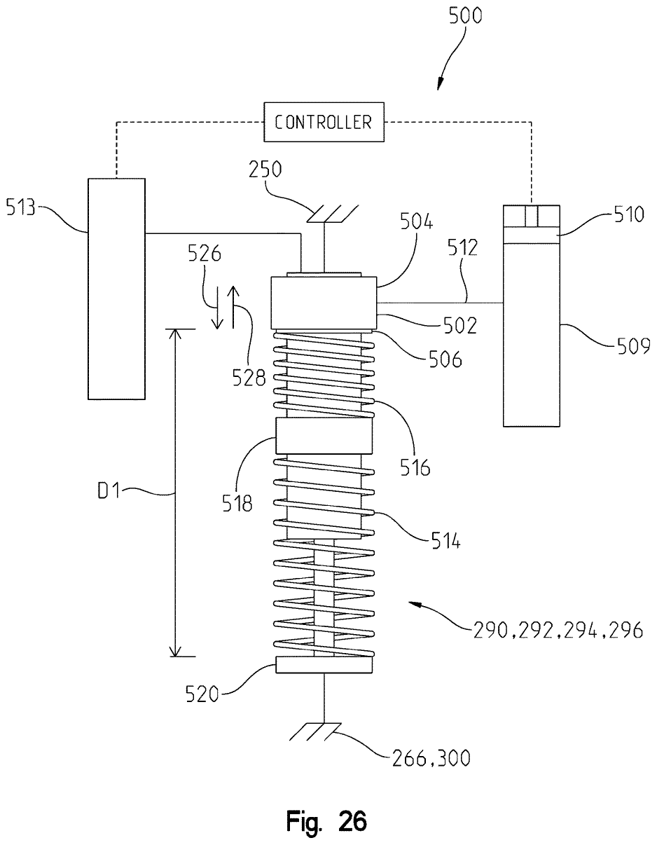

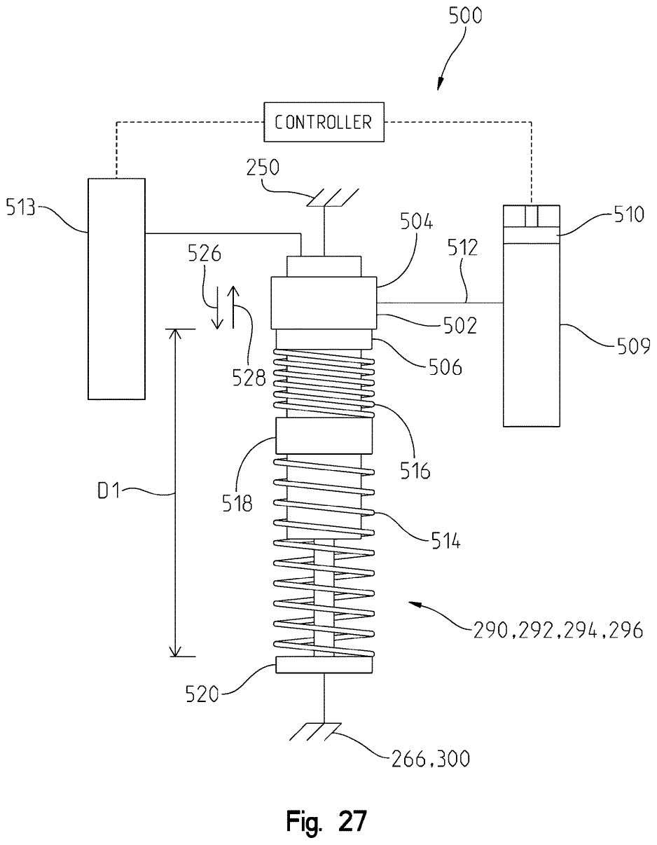

Now referring to FIGS. 26-27, a preload system 500 is configured to be operably coupled to one or more of adjustable shocks 290, 292, 294, 296. Preload system 500 comprises a collar 502 configured to sit generally at an upper extent of the adjustable shock 290, 292, 294, 296. In embodiments, collar 502 is configured to sit generally at a lower extent of the adjustable shock 290, 292, 294, 296. Collar 502 comprises an outer collar 504 and an inner collar 506 slidably engaged with outer collar 504. A conduit 512 is fluidly coupled between the collar 502 and an external reservoir 508. External reservoir comprises a working volume 509, and an actuator 510 is operably coupled to external reservoir 508 to control the movement of fluid into and out of conduit 512 and collar 502 by controlling the size of working volume 509. In embodiments, controller 50, or ride height controller 96, is configured to control actuator 510. In embodiments, actuator 510 is a motor, a screw, a piston, a motorized lead screw or another type of actuator that may displace fluid within reservoir 508.

Adjustable shocks 290, 292, 294, 296 each comprise a primary spring 514 and a secondary spring 516 and a slider 518 coupled between the primary spring 514 and second spring 516. Secondary spring 516 is bounded on a first end by collar 502 and on a second end by slider 518, and primary spring 514 is bounded on a first end by slider 518 and on a second end by spring stop 520 positioned at a generally bottom portion of the adjustable shock. The compressed, neutral distance when the vehicle is on flat ground and not moving between collar 502 and spring stop 520 is a first distance D1. Distance D1 changes as the shock absorber travels, absorbs loads, extends, and otherwise functions during operation of the vehicle. In embodiments, adjustable shocks 290, 292, 294, 296 only comprise a single, primary spring 514. A reservoir 513 is configured to house fluid for operating shock absorbers 290, 292, 294, 296. Example fluid is oil, water, or other viscous fluids.

Still referring to FIGS. 26-27, inner collar 506 is coupled to secondary spring 516. That is, an upper extent of spring 516 is approximately the same diameter as inner collar 506, and spring 516 is seated along and operably coupled to inner collar 506.

Controller 50 is configured to control actuator 510 to control flow of a fluid into and out of collar 502. In embodiments, controller 50 is configured to control actuator 510 to decrease the size of working volume 509 (i.e., moving actuator 510 in direction 526) and push fluid through conduit 512 and into collar 502. As fluid pressure within collar 502 is increased, inner collar 506 is configured to move downwardly (i.e., in direction 526) relative to outer collar 504 and decrease distance D1 by compressing springs 514, 516. That is, the force exerted by preload system 500 (i.e., through actuator 510 acting on the working fluid within working volume 509, conduit 512, and collar 502) on springs 514, 516 is greater than the spring force.

In embodiments, controller 50 is configured to control actuator 510 to increase the size of working volume 509 (i.e., moving actuator 510 in direction 528) and allow fluid to come back into working volume 509 of external reservoir 508. As the size of working volume 509 is increased, springs 514, 516 are able to overcome any forces (e.g., frictional forces) imposed by collar 502 and push inner collar 506 upwardly (i.e., in direction 528) relative to outer collar 504 and increase the distance D1 of springs 514, 516. As springs 514, 516 push upwardly, compressing inner collar 506, fluid flows from collar 502, through conduit 512, and into working volume 509.

Still referring to FIGS. 26-27, as distance D1 is altered, the initial preload force applied to springs 514, 516 is altered, and the initial biasing force of springs 514, 516 on the adjustable shock absorbers 290, 292, 294, 296 is altered.

In embodiments, controller 50 (or ride height controller 96) controls preload assembly 500 in response to one or more input devices 42 (e.g., from operator interface 62), sensors 80, or vehicle systems 60. Referring now to FIG. 28, controller 50, 96 may complete process 530 to determine a preload adjustment of one or more of shock absorbers 290, 292, 294, 296. In embodiments, controller 50, 96 is configured to complete process 530 for each individual shock absorber 290, 292, 294, 296 separately. Process 530 includes step 532 which determines the added load at a wheel (e.g., front right wheel). Step 532 determines an added load based upon at least one of an input from a user input 42, a weight sensor 542, a fuel level 543, or suspension sensor 544. In embodiments, process 530 determines an added load at each wheel 202 (i.e., at each of front-right wheel, front-left wheel, rear-right wheel, and rear-left wheel).

In embodiments, referring to FIGS. 26-27, preload system 500 is capable of being placed in multiple orientations. That is, in embodiments, a first end of shock absorber 290, 292, 294, 296 (i.e., first end adjacent collars 502, 504) is coupled to vehicle frame 250 and a second end of shock absorber 290, 292, 294, 296 (i.e., second end adjacent spring stop 520) is coupled to either of A-arm 266 or trailing arm 300. In embodiments, a first end of shock absorber 290, 292, 294, 296 (i.e., first end adjacent collars 502, 504) is coupled to either of A-arm 266 or trailing arm 300 and a second end of shock absorber 290, 292, 294, 296 (i.e., second end adjacent spring stop 520) is coupled to vehicle frame 250. In embodiments, collar 502 is positioned adjacent the bottom extent of shock absorber 290, 292, 294, 296 and inner collar 506 is configured to move upwardly relative to outer collar 504. In embodiments, any of shock absorbers 290, 292, 294, 296 may include a single spring (e.g., primary spring 514), three springs (which may include a second slider 518), four springs, or more springs.

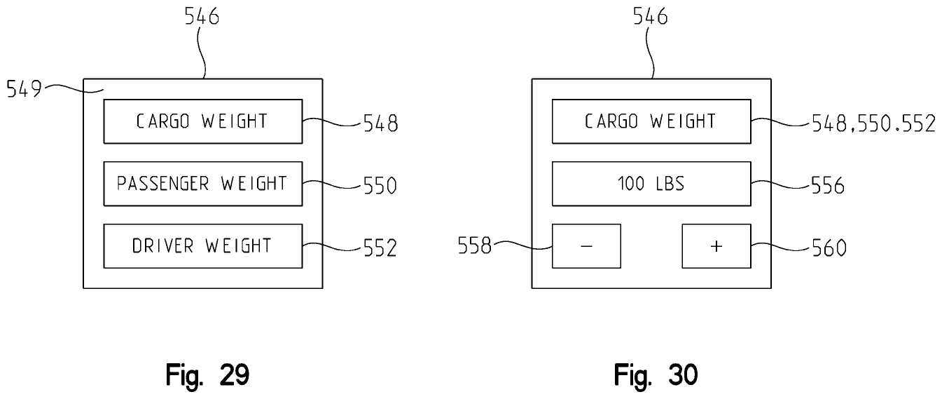

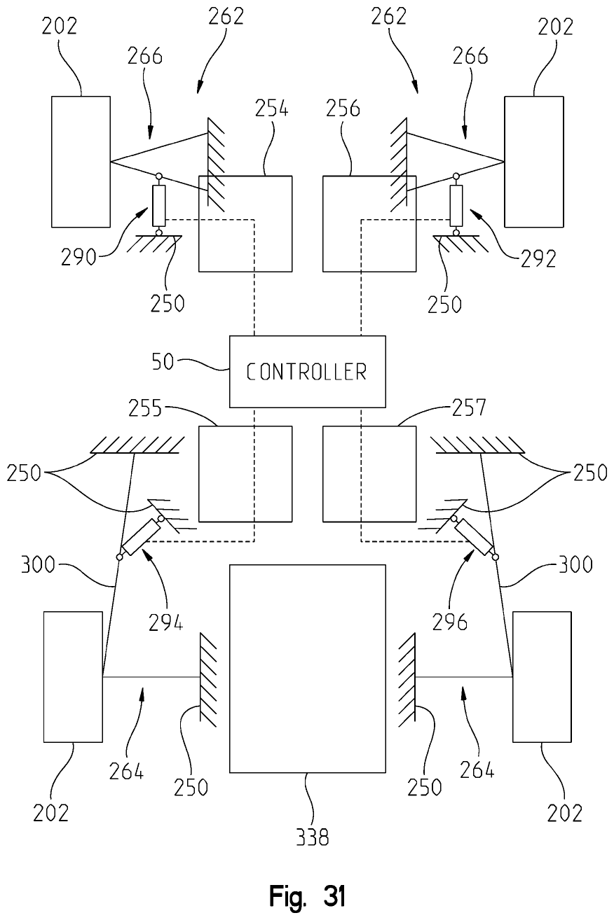

Referring to FIGS. 29-31, an exemplary output device 44 is a display 546. Display 546 is configured to display a plurality of screen layouts. A first screen layout 549 (FIG. 29) includes a plurality of selectable options including a first button 548 labeled “Cargo Weight”, a second button 550 labeled “Passenger Weight”, and a third button 552 labeled “Driver Weight”. A user may select any of first button 548, second button 550, or third button 552 and display may cycle to a second screen layout 554 (FIG. 30). Second screen layout 554 includes an indication of which input is being adjusted (e.g., cargo weight, passenger weight, driver weight), as well as a weight value 556 of the input being adjusted and a pair of adjustment buttons 558, 560 which allow a user to adjust weight value 556. In embodiments, first screen layout 549 includes a button to enter the weight for a first passenger corresponding to a front passenger (e.g., passenger seat 256), first screen layout 549 includes a button to enter the weight for a second passenger corresponding to a rear driver's-side passenger (e.g., passenger seat 255 (FIG. 31)), and first screen layout 549 includes a button to enter the weight for a third passenger corresponding to a rear passenger's-side passenger (e.g., passenger seat 257 (FIG. 31)). Illustratively, first button 548 may be configured to receive an indication of cargo weight of, for example, any cargo within cargo area 338. Further, third button 552 may be configured to receive an indication of a driver weight of, for example, a driver in driver's seat 254.

In embodiments, any of seats 254, 255, 256, and 257 and cargo box 338 may comprise a weight sensor 542 configured to measure the weight of any of the driver of seat 254, passenger of passenger seat 255, passenger of passenger seat 256, passenger of passenger seat 257, and cargo of cargo box 338. Weight sensors 542 are operably coupled to controller 50 (or ride height controller 96) and controller 50 is configured to read the weight values of weight sensors 542.

In embodiments, controller 50 is configured to determine a weight of fuel the vehicle is carrying by determining a fuel level 543. Controller 50 may compare the fuel level to a table (not shown) to determine a total weight of fuel and/or a distribution of the weight of the fuel among the shock absorbers 290, 292, 294, 296.

In embodiments, controller 50 is configured to determine a weight at each wheel (i.e., at each of front-right wheel, front-left wheel, rear-right wheel, and rear-left wheel) by determining the distribution of the combined weight of all passengers, cargo, and fuel. For example, in embodiments, when a driver is in seat 254 and no passengers are in the vehicle and no cargo is in cargo box 338, the added weight at the front-left wheel will be greater than the added weight at the front-right wheel.

Still referring to FIG. 28, controller 50 may be configured to receive a height of any of shock absorbers 290, 292, 294, 296 and determine an added load, or added weight, at each of wheels 202 (i.e., at each of front-right wheel, front-left wheel, rear-right wheel, and rear-left wheel) based upon a change in shock absorber height.

Referring still to FIG. 28, after the added load, or added weight, is determined in step 532, process 530 moves on to step 534 to determine a spring force adjustment required for each shock absorber 290, 292, 294, 296 at each wheel. The spring force adjustment may be calculated by Equation 1, which determines that the spring force adjustment for each wheel equals Added Weight (determined in step 532) divided by the Motion Ratio 562.

Spring Force Adjustment=Added Weight/Motion Ratio. Equation 1

The motion ratio 562 is a predetermined set characteristic of the respective shock absorber 290, 292, 294, 296. In embodiments, shock absorbers 290, 292 have the same motion ratio 562 and in embodiments, shock absorbers 294, 296 have the same motion ratio 562 different from the motion ratio of shock absorbers 290, 292. In embodiments, each of shock absorbers 290, 292, 294, 296 have different motion ratios 562. In embodiments, each of shock absorbers 290, 292 (e.g., front shock absorbers) have a different motion ratio than each of shock absorbers 294, 296 (e.g., rear shock absorbers).

Referring still to FIG. 28, after the Spring Force Adjustment is calculated in step 534, process 530 proceeds to step 536 to determine the amount of pre-load adjustment required at the shock absorber 290, 292, 294, 296. The pre-load adjustment determined in FIG. 28 is a distance value and may be calculated by Equation 2.

Pre-Load Adjustment=Spring Force Adjustment/Total Spring Rate. Equation 2

Total Spring Rate 564 is a known value based upon the combined spring rate of the primary spring 514 and secondary spring 516. Springs 514, 516 are in series and have a combined spring rate which may be determined by Equation 3. Spring 514 has a spring rate K_{Primary} and spring 516 has a spring rate K_{Secondary}.

Total Spring Rate=(1/((1/K_{Primary})+(1/K_{Secondary}))) Equation 3

Referring still to FIG. 28, process 530 includes step 538 to determine if any additional ride height adjustments are requested. In step 538, controller 50 may receive additional requests for ride height adjustments from user input 42. Example additional requests may include a user input for 0.5″ of ride height adjustment, 1″, 1.5″, 2″, 3″, 4″, 5″ or 6″, or any other amount of change. Additional requests may be −0.5″, −1″, −1.5″, −2″, −3″, −4″, −5″ or −6″. User requests may be provided through display 546, through one or more screen layouts similar to first screen layout 549 and second screen layout 554. In embodiments, in step 538, controller 50 may determine that the vehicle is in a driving mode 566. Example driving modes 566 include race mode, track mode, baja mode, comfort mode, or other driving modes. In embodiments, one or more driving modes 566 may be set with a predetermined ride height adjustment such that, when the vehicle is operating in different driving modes, shock absorbers 290, 292, 294, 296 have varying neutral positions. In embodiments, in baja mode, it may be advantageous to operate all of shock absorbers 290, 292, 294, 296 with 1″ of ride height added to increase ground clearance through whoops, bumps, or varied terrain. In embodiments, in track mode, it may be advantageous to operate all of shock absorbers 290, 292, 294, 296 with −0.5″ of ride height to lower the center of gravity and increase stability.

In step 538, controller 50 receives the requested ride height adjustment and determines an amount of spring adjustment required to effectuate the ride height adjustment at any of shocks 290, 292, 294, 296. The spring adjustment determined in step 538 may be determined by Equation 4.

Spring Adjustment=Requested Ride Height Adjustment*Motion Ratio. Equation 4

Process 530 proceeds to step 540, and controller 50 determines a total amount of spring adjustment required by combining the determined amount in step 536 and the determined amount in step 538. Process 530 moves on to step 541, and controller 50 adjusts preload system 500 accordingly for each wheel (i.e., at each of front-right wheel, front-left wheel, rear-right wheel, and rear-left wheel). For example, in step 540, it is determined that shock absorber 290 requires 1″ of ride height adjustment and shock absorber 292 requires 0.5″ of ride height adjustment, and controller 50 operates preload system 500 of the front-left wheel to extend inner collar 506 1″ and decrease distance D1 by 1″ and operates preload system 500 of the front-right wheel to extend inner collar 506 0.5″ and decrease distance D1 by 0.5″. In embodiments, in step 541, the preload for each wheel (i.e., front-right wheel, front-left wheel, rear-right wheel, and rear-left wheel) is adjusted at the same time. In embodiments, in step 541, the preload for each wheel (i.e., front-right wheel, front-left wheel, rear-right wheel, and rear-left wheel) is adjusted at substantially the same time (e.g., within 10 seconds of each other).

In embodiments, when process 530 determines an added load in step 532, controller 50 is configured to control, or alter, a rebound damping characteristic of any of shock absorbers 290, 292, 294, 296 to balance the shock out with the adjusted spring. In embodiments, when ride height is increased, or when a positive spring adjustment is completed, controller 50 will increase the base percent of rebound damping to help balance the shock absorber and prevent a top-out condition, an underdamped condition, or similar conditions. Controller 50 is configured to determine the total spring adjustment in step 540, and in response, alter the rebound damping characteristic of any of shock absorbers 290, 292, 294, 296 based on a map (e.g., tables 462).

In embodiments, and still referring to FIG. 28, process 530 is comprised of two separate sequences, sequence A and sequence B. Sequence A is configured to provide an amount of spring adjustment required to level-out vehicle 2. That is, Sequence A is configured to determine the weight at each wheel, and adjust the suspension at each wheel, so that each corner of the vehicle is at the same, or approximately the same, height from a ground surface. In embodiments, Sequence B is configured to provide additional adjustment based upon one or more of the drive mode 564 and user input 42. In embodiments, Sequence A is configured to precede Sequence B. That is, process 530 may first complete Sequence A so that vehicle 200 is first at a substantially level state before completing the adjustments of Sequence B. In embodiments, Sequence B is configured to precede Sequence A.

In embodiments, controller 50 is configured to monitor an engine state, or engine condition (e.g., ON-state or OFF-state) and controller 50 is configured to only adjust preload system 500 when the vehicle is in an ON-state or when a user has just turned the vehicle off, or the vehicle is changed to an OFF-state. Preload system 500 is configured to run while the prime mover 212 is operating to reduce the drain rate of a battery (not shown), to reduce the perceived noise level of preload system by covering some or all of the noise with the noise of prime mover 212, and decrease the opportunities for the user to operate preload system 500 which increases the life cycle of the preload system 500. In embodiments, controller 50 is configured to automatically operate preload system 500 to decrease the height of the vehicle after the vehicle is changed to an OFF-state. That is, controller 50 is configured to lower the vehicle after a user turns the vehicle off to assist in the ingress/egress of the vehicle.

### Stabilizer Bar

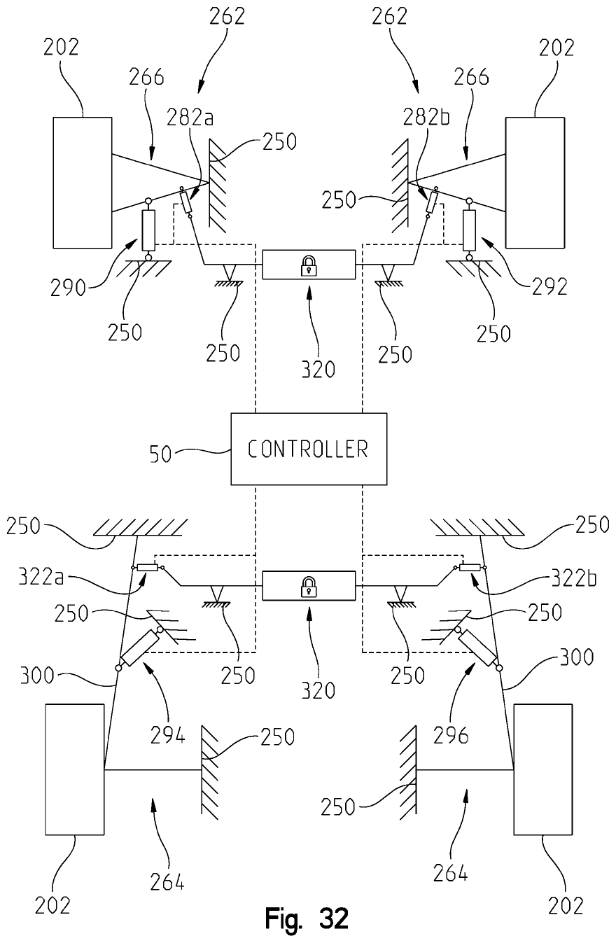

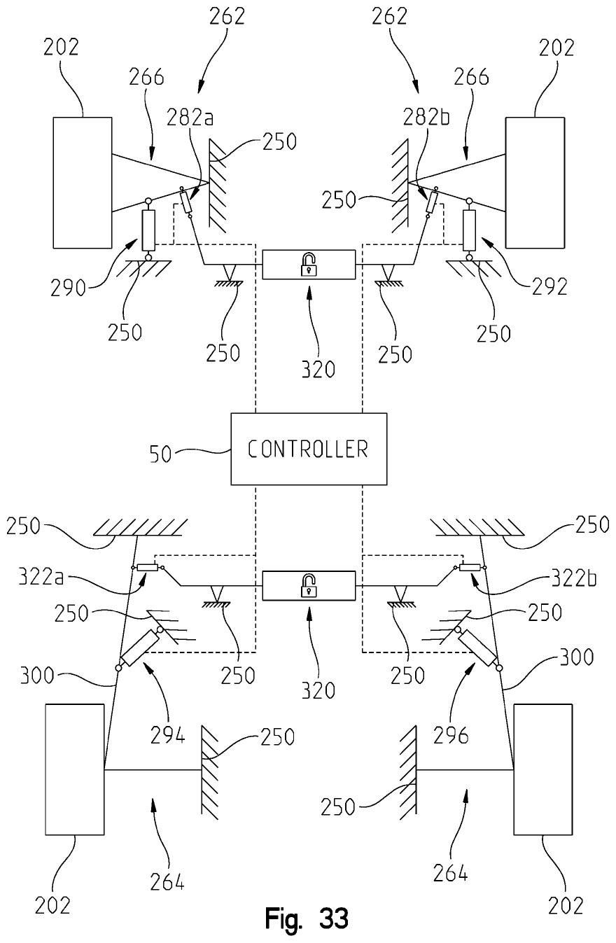

Referring now to FIGS. 32-35, controller 50 may operate one or more of stabilizer bars 280, 320 of vehicle 200 to operate in a locked state, an unlocked state, or may further be operated in semi-active state. Referring to FIG. 32, controller 50 may operate each of stabilizer bars 280, 320 in a locked configuration where each of links 282a, 282b, 322a, 322b are locked (e.g., piston 1054 (FIG. 25) is restricted or inhibited from to moving upwardly and downwardly within body 1052), which increases the rigidity between front suspensions 262 and rear suspensions 264, respectively. Referring to FIG. 33, controller 50 may operate each of stabilizer bars 280, 320 in an unlocked configuration where each of links 282a, 282b, 322a, 322b are capable of altering their lengths (e.g., piston 1054 is able to move upwardly and downwardly within body 1052), which allows front suspensions 262 to move more easily relative to one another and allows rear suspensions 264 to move more easily relative to one another.

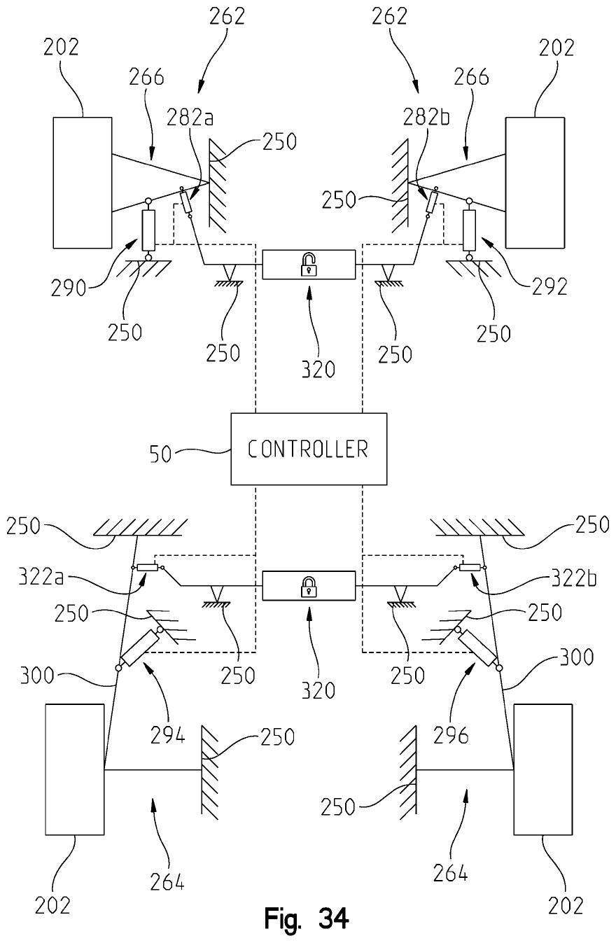

Referring to FIG. 34, controller 50 may operate front stabilizer bar 280 in an unlocked configuration and rear stabilizer bar 320 in a locked configuration. That is, controller 50 may operate links 282a, 282b in an unlocked state and operate one or more of links 322a, 322b in a locked state.

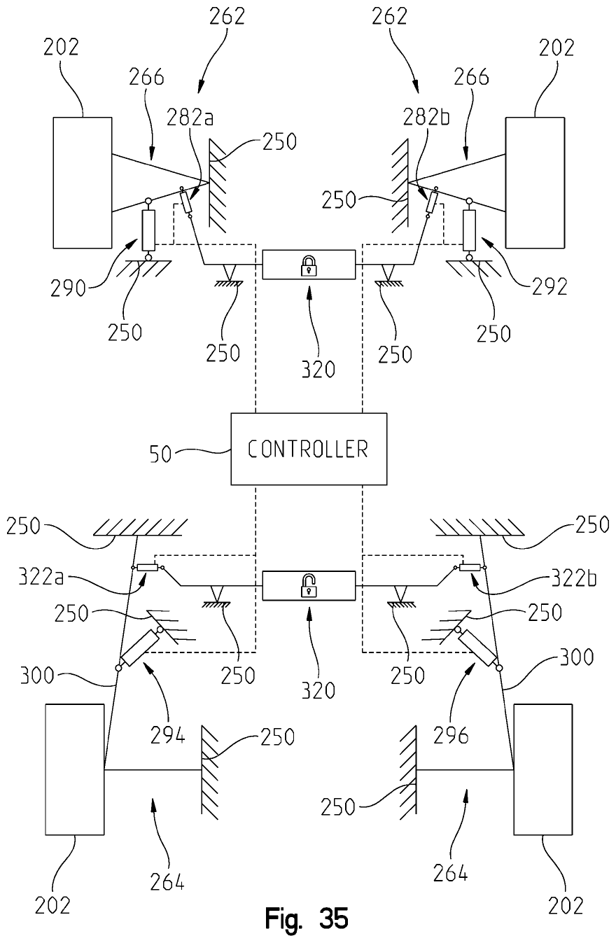

Referring to FIG. 35, controller 50 may operate front stabilizer bar 280 in a locked configuration and rear stabilizer bar 320 in an unlocked configuration. That is, controller 50 may operate one or more of links 282a, 282b in a locked state and operate links 322a, 322b in an unlocked state.

In various embodiments, controller 50 may operate any or all of links 282a, 282b, 322a, 322b between the locked state and the unlocked state. That is, in embodiments, controller 50 may be configured to operate one link of links 282a, 282b, 322a, 322b in a locked state and the remaining links in an unlocked state. In embodiments, controller 50 may be configured to operate one link of links 282a, 282b, 322a, 322b in an unlocked state and the remaining links in a locked state. In embodiments, controller 50 may be configured to operate two links of links 282a, 282b, 322a, 322b in a locked state and the remaining links in an unlocked state. In embodiments, controller 50 may be configured to operate two links of links 282a, 282b, 322a, 322b in an unlocked state and the remaining links in a locked state.

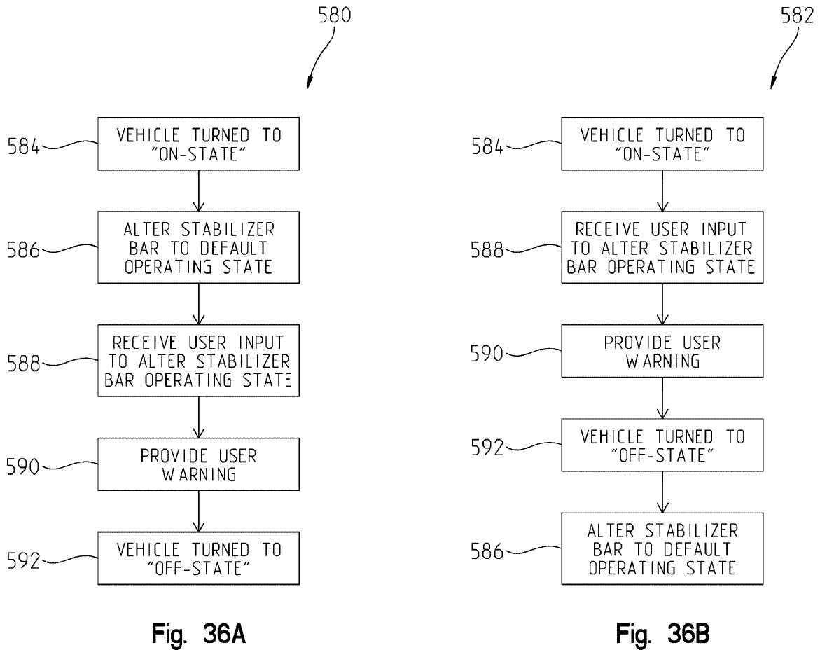

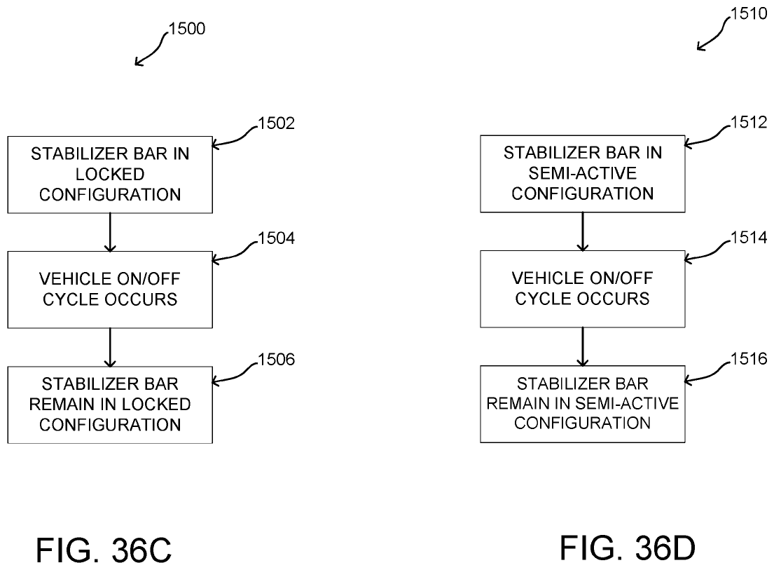

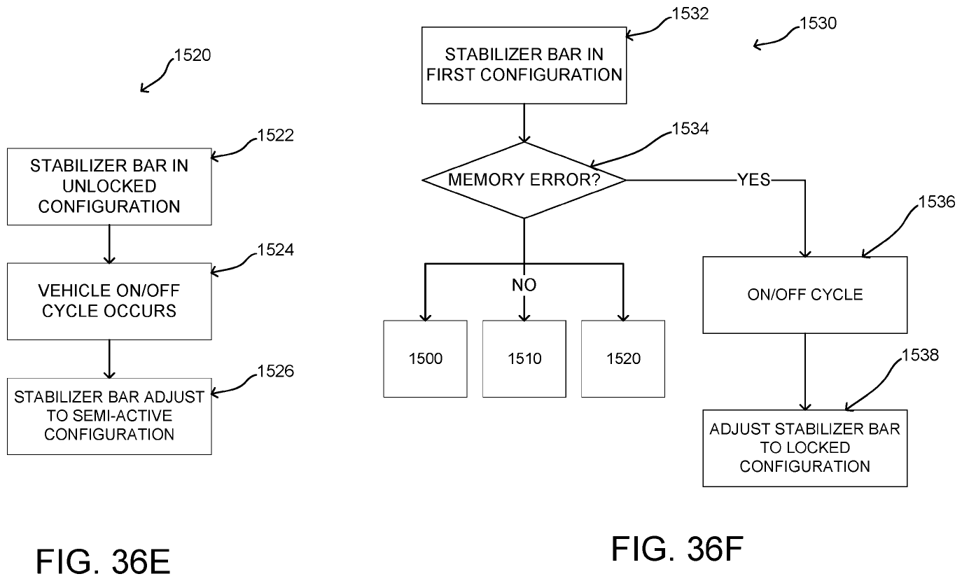

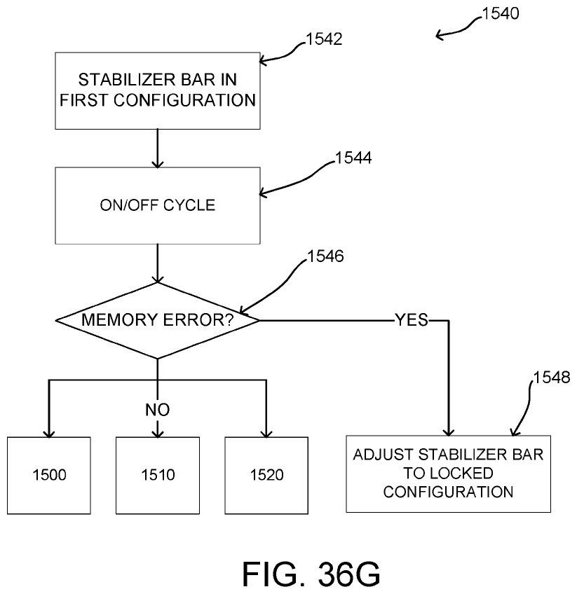

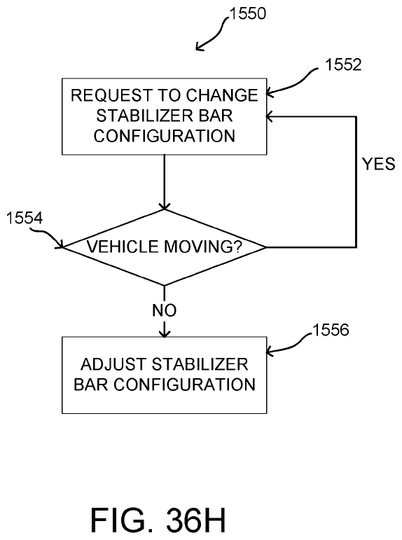

Referring now to FIGS. 36A-B, controller 50 is configured to operate one or more of processes 580, 582 in response to the prime mover 212 and vehicle 200 switching between a first operating condition (e.g., ON-condition or OFF-condition) and a second operating condition (e.g., the other of the ON-condition or OFF-condition). Process 580 starts with step 584 wherein the vehicle is turned to an “on-condition”. The “on-condition” may be when the prime mover 212 (e.g., engine, electric motor) is operating, or the “on-condition” may be when vehicle 200 is an accessory mode (e.g., electrical is on, prime mover 212 not operating). In embodiments, the “on-condition” is any operational state other than a keyed-off state. After an “on-condition” is determined in step 584, process 580 moves to step 586, and controller 50 is configured to change the current operating state of stabilizer bars 280, 320 to a default operating state, or first state (e.g., unlocked, locked, semi-active). In embodiments, the default operating state is the semi-active mode. That is, controller 50 is configured to change the current operating state of stabilizer bars 280, 320 to operate in semi-active mode upon determining that the vehicle has changed to an “on-condition”. For example, controller 50 determines, upon the vehicle changing to the “on-condition”, that one or more of the stabilizer bars 280, 320 is in an unlocked state or a locked state (e.g., a second state), and in step 586, is configured to change the current operating state of stabilizer bars 280, 320 to the semi-active mode (e.g., the default, or first state). Process 580 proceeds to operate stabilizer bars 280, 320, and in step 588, receives a user input (e.g., inputs 42) to alter the stabilizer bar operating state to a non-default state, or second state (e.g., unlocked, locked). In embodiments, step 588 is completed if controller 50 receives a user input to alter either of, or both of, stabilizer bars 280, 320 from either semi-active moved or the locked state to the unlocked state. In embodiments, after receiving, in step 588, a user input to alter stabilizer bars 280, 320 to an unlocked state, process 580 proceeds to step 590, and controller 50 is configured to provide a warning to a user of the vehicle. The warning may be a prompt on a display (e.g., output devices 44, such as display 546), may be an audio clip, a tactile feedback output to the operator (e.g., through steering wheel 276), or another type of warning to the operator or passengers. Additional details regarding warnings or notifications provided to vehicle operators may be found in U.S. patent application Ser. No. 17/410,781, filed Aug. 24, 2021, titled VEHICLE STEERING SYSTEMS AND METHODS, attorney docket no. PLR-15-29282.02P-US; U.S. Provisional Patent Application Ser. No. 63/343,564, filed May 19, 2022, titled SYSTEMS AND METHODS OF A SMART HELMET, attorney docket no. PLR-04-29495.01P-US, the complete disclosures of which are expressly incorporated herein by reference.

Still referring to FIGS. 36A-36B, process 580 concludes with vehicle 200 being turned to an “off-condition”, which may also be a keyed-off state. Process 580 ensures that vehicle 200 always has stabilizer bars 280, 320 operating in the default mode, or first state (e.g., semi-active mode) upon vehicle start up. When stabilizer bars 280, 320 are operating in semi-active mode, vehicle 200 is most capable of adapting to any terrain, and it is therefore advantageous for vehicle 200 to default to the semi-active mode, or first state. In embodiments, the default operating mode for stabilizer bars 280, 320 is the locked state, and upon start-up, controller 50 will change the current operating mode of stabilizer bars 280, 320 to be the default locked state.

Referring now to FIG. 36B, process 582 starts with step 584 when vehicle 200 is turned to the “on-condition”. Process 582 proceeds through step 588 to determine if a user is desiring to alter an operating state (e.g., to second state) of stabilizer bars 280, 320, and provide a warning in step 590. Process 582 determines that the vehicle is in an “off-condition” in step 592 and, subsequent to step 592, alters the current operating condition of stabilizer bars 280, 320 to be the default operating state, or first state (e.g., semi-active mode). Controller 50 may have a delayed powered-off timer so that it may remain operational long enough to alter the current operating condition of stabilizer bars 280, 320 to the default operating state. That is, in process 582, upon vehicle 200 turning-on (i.e., step 584), stabilizer bars 280, 320 will be in the default operating state, or first state.

Still referring to FIGS. 36A-36B, processes 580, 582 may operate without a user input in step 588 and processes 580, 582 automatically adjust the stabilizer bars 280, 320 from the default state, or first state to another state, or second state based upon a predetermined condition, such as time, a sensor value, drive mode, or another characteristic.

Referring now to FIG. 36C, a process 1500 includes a first step of determining that stabilizer bars 280, 320 of vehicle 200 are in a locked configuration, as indicated by block 1502. Further, a vehicle Off/On cycle occurs (e.g., the vehicle turns off and back on again), as indicated by block 1504, and controller 50 is operable to maintain stabilizer bars 280, 320 in the locked configuration, as indicated by block 1506.

Referring now to FIG. 36D, a process 1510 includes a first step of determining that stabilizer bars 280, 320 of vehicle 200 are in a semi-active configuration, as indicated by block 1512. Further, a vehicle Off/On cycle occurs (e.g., the vehicle turns off and back on again), as indicated by block 1514, and controller 50 is operable to maintain stabilizer bars 280, 320 in the semi-active configuration, as indicated by block 1516.

Referring now to FIG. 36E, a process 1520 includes a first step of determining that stabilizer bars 280, 320 of vehicle 200 are in an unlocked configuration, as indicated by block 1522. Further, a vehicle Off/On cycle occurs (e.g., the vehicle turns off and back on again), as indicated by block 1524, and controller 50 is operable to adjust stabilizer bars 280, 320 into the semi-active configuration, as indicated by block 1526.

Referring now to FIG. 36F, a process 1530 includes a first step of determining that stabilizer bars 280, 320 of vehicle 200 are in a first configuration (e.g., any configuration including a locked configuration, unlocked configuration, or semi-active configuration), as indicated by block 1532. Controller 50 may then determine if a memory error has occurred, such as a write-error before shutting off vehicle 200 (e.g., writing the first configuration to the memory), as indicated by block 1534. Controller 50 may determine that a memory error has not occurred, and proceed to execute any of processes 1500, 1510, 1520 to ensure that stabilizer bars 280, 320 are operating correctly upon vehicle start-up. Controller 50 may determine that a memory error has occurred, and upon a vehicle Off/On cycle occurring, as indicated by block 1536, controller 50 is operable to adjust stabilizer bars 280, 320 into the locked configuration, as indicated by block 1538.

Referring now to FIG. 36G, a process 1540 includes a first step of determining that stabilizer bars 280, 320 of vehicle 200 are in a first configuration (e.g., any configuration including a locked configuration, unlocked configuration, or semi-active configuration), as indicated by block 1542. Controller 50 may then determine that an Off/On cycle has occurred, as indicated by block 1544, and upon vehicle start up, controller 50 may determine if a memory error has occurred, such as a read-error upon turning on vehicle 200 (e.g., reading the stabilizer bar configuration memory), as indicated by block 1546. Controller 50 may determine that a memory error has not occurred, and proceed to execute any of processes 1500, 1510, 1520 to ensure that stabilizer bars 280, 320 are operating correctly upon vehicle start-up. Controller 50 may determine that a memory error has occurred and controller 50 is operable to adjust stabilizer bars 280, 320 into the locked configuration, as indicated by block 1548.

Referring now to FIG. 36E, controller 50 is operable to control one or more of stabilizer bars 280, 320 according to process 1550. Controller 50 may determine that a request has been made to change the stabilizer bar configuration (e.g., between unlocked, locked, and semi-active), as indicated by block 1552. The request may be a user input, event logic, or other instructions received by controller 50. Controller 50 may then determine if vehicle 200 is moving, as indicated by block 1554. Controller 50 may determine if vehicle 200 is moving by one or more of a wheel speed sensor (not shown), an acceleration sensor (e.g., IMU or gyroscope), a GPS, or another sensor on vehicle 200. If vehicle 200 is not moving, controller 50 may permit the adjustment of the stabilizer bar configuration, as indicated by block 1556. If vehicle 200 is moving, controller 50 may not permit the adjustment of the stabilizer bar configuration (e.g., stabilizer bars 280, 320) and return to block 1552. In embodiments, if controller 50 does not permit the adjustment of the stabilizer bar configuration, controller 50 may display a message, create sound, or otherwise alert the driver that they may not adjust the stabilizer bar configuration while vehicle 200 is moving.

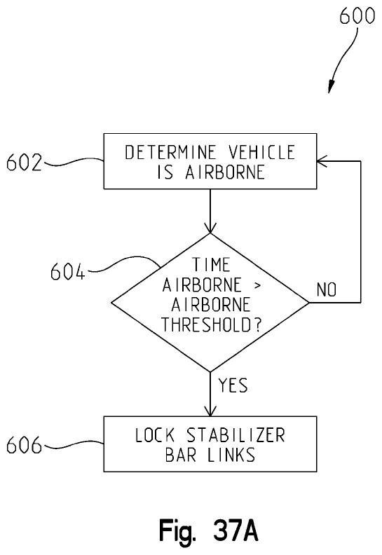

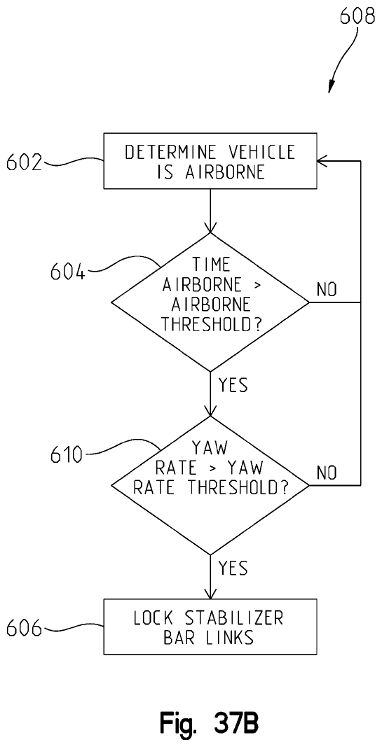

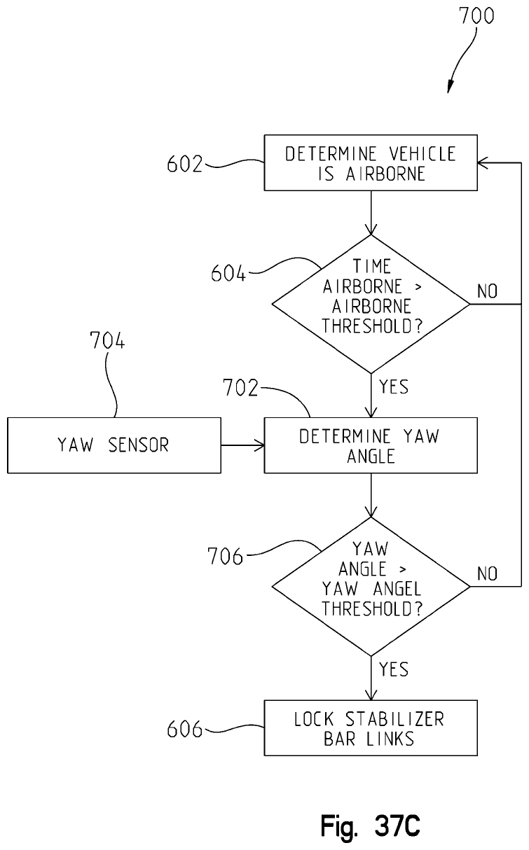

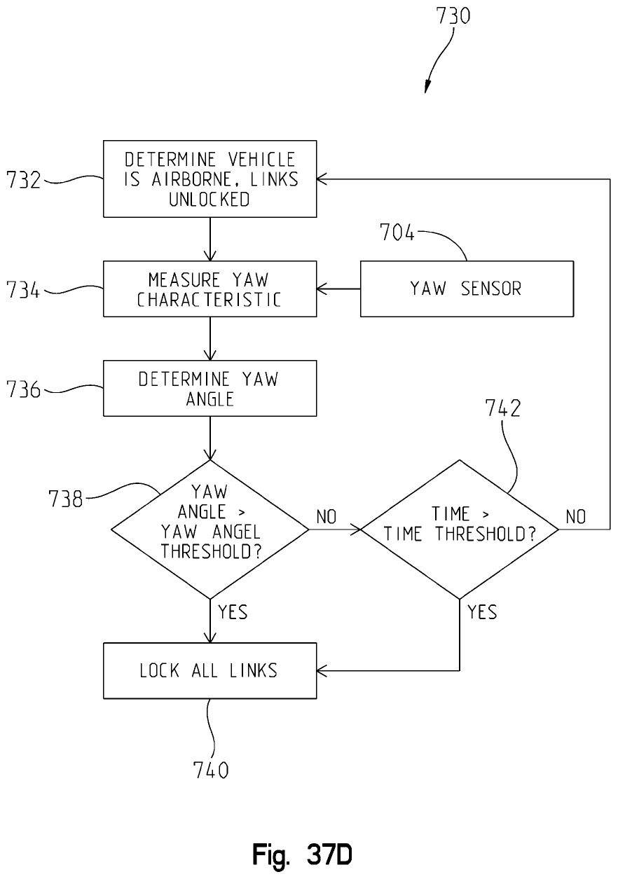

Referring now to FIG. 37A, controller 50 is configured to complete process 600, and in step 602, controller 50 is configured to determine if vehicle 200 is airborne in an airborne event. Vehicle 200 may be determined to be airborne if the vertical acceleration experienced by vehicle 200 passes a predetermined threshold. Other methods of airborne detection may be utilized. When it is determined that vehicle 200 is airborne, process 600 moves to step 604 and determines if the amount of time vehicle 200 has been airborne has exceeded an airborne threshold. The airborne threshold is a predetermined time-period. If vehicle 200 is airborne for a time period less than the airborne threshold, process 600 starts-over, and may indicate that vehicle 200 is undergoing a ‘short’ airborne event, and if vehicle 200 is airborne for a time period greater than the airborne threshold, process 600 proceeds to step 606, and may indicate that vehicle 200 is undergoing a ‘long’ airborne event. When vehicle 200 is airborne for a time greater than the airborne threshold, process 600 moves to step 606, and controller 50 is configured to alter the configuration of all four links 282a, 282b, 322a, 322b. In embodiments, in step 606, controller 50 alters the operating state of all of links 282a, 282b, 322a, 322b to be in the locked operating state (i.e., FIG. 32) when vehicle 200 enters a landing condition (i.e., completes the airborne event), and front suspension 262 and rear suspension 264 have increased rigidity. In embodiments, in step 606, controller 50 alters the operating state of at least one of links 282a, 282b and at least one of links 322a, 322b to be in the locked operating state when vehicle 200 enters a landing condition (i.e., completes the airborne event).

Referring to FIG. 37B, controller 50 is configured to complete a process 608 which is similar to process 600. Process 608 starts with step 602 by determining that vehicle 200 is airborne. After determining that vehicle 200 is airborne, process 608 proceeds to step 604 to determine if vehicle 200 has been airborne for a time greater than the airborne threshold. If step 604 is satisfied, process 608 proceeds to step 610 and controller 50 determines if a yaw rate of vehicle 200 exceeds a yaw rate threshold indicating that vehicle 200 is moving about yaw axis 404. If the yaw rate of vehicle 200 exceeds a yaw rate threshold, process 608 moves to step 606 and controller 50 alters the operating state of all of links 282a, 282b, 322a, 322b to be in the locked operating state (i.e., FIG. 32) when vehicle 200 enters a landing condition (i.e., completes the airborne event), and front suspension 262 and rear suspension 264 have increased rigidity. In embodiments, in step 606, controller 50 alters the operating state of at least one of links 282a, 282b and at least one of links 322a, 322b to be in the locked operating state when vehicle 200 enters a landing condition (i.e., completes the airborne event).

Referring to FIG. 37C, controller 50 is configured to complete a process 700 which is similar to processes 600 and 608. Process 700 starts with step 602 by determining that vehicle 200 is airborne. After determining that vehicle 200 is airborne, process 608 proceeds to step 604 to determine if vehicle 200 has been airborne for a time greater than the airborne threshold. If step 604 is satisfied, process 608 proceeds to step 702 and controller 50 determines a yaw angle of vehicle 200, which is indicative of an angle that vehicle 200 is angled relative to, for example, a set directional heading (e.g., north) or the initial heading of the vehicle prior to the airborne condition. In embodiments, yaw angle is determined in step 702 by integrating the yaw rate provided by a yaw sensor in step 704. In embodiments, the yaw rate is provided by an IMU or a gyroscope. Process 700 proceeds to step 706 and determines if the yaw angle has exceeded a predetermined yaw angle threshold. If the yaw angle of vehicle 200 exceeds a yaw angle threshold, process 700 moves to step 606 and controller 50 alters the operating state of all of links 282a, 282b, 322a, 322b to be in the locked operating state (i.e., FIG. 32) when vehicle 200 enters a landing condition (i.e., completes the airborne event), and front suspension 262 and rear suspension 264 have increased rigidity. In embodiments, in step 606, controller 50 alters the operating state of at least one of links 282a, 282b and at least one of links 322a, 322b to be in the locked operating state when vehicle 200 enters a landing condition (i.e., completes the airborne event).

Referring to FIG. 37D, controller 50 is operable to complete a process 730 which may increase stability and handling of vehicle 200 during an airborne event. Process 730 includes an initial determination that vehicle 200 is airborne, as previously described, as shown in block 732. Additionally, each of links 282a, 282b, 322a, 322b may start in an unlocked operating state when it is determined that vehicle 200 is in an airborne state. An operator of vehicle 200 may have a more comfortable ride and handling experience during an airborne event when links 282a, 282b, 322a, 322b are unlocked unless certain criteria are met, as provided by process 730. After determining that vehicle 200 is in an airborne state, a yaw characteristic is measured, as indicated in block 734, by yaw sensor 704. The yaw characteristic measured in block 734 may be a yaw velocity, a yaw acceleration, or another yaw characteristic. The yaw angle may then be measured based upon the yaw characteristic, as indicated in block 736. In embodiments, the yaw angle may be measured by integrating the yaw velocity as a function over the period of time of the airborne event. The yaw angle may then be compared to a yaw angle threshold, as indicated in block 738. The yaw angle may be indicative of the yaw angle at which the vehicle 200 will land (i.e., a yaw rotational landing angle) after the airborne event is completed, and it may be desirable to alter one or more links 282a, 282b, 322a, 322b based upon the yaw angle to increase the ride and handling of vehicle 200 upon the landing of vehicle 200. If the determined yaw angle is greater than the yaw angle threshold, controller 50 may lock all of links 282a, 282b, 322a, 322b, as indicated in block 740. In embodiments, controller 50 may lock at least one of links 282a, 282b, 322a, 322b in block 740. In embodiments, controller may lock at least one of links 282a, 282b and at least one of links 322a, 322b in block 740.

Referring still to FIG. 37D, if the yaw angle is not greater than the yaw angle threshold, as determined in block 738, controller 50 may measure a time value of the airborne event (i.e., airborne time) and compare the airborne time to an airborne time value threshold. If the airborne time is greater than the airborne time value threshold, controller 50 may lock all of links 282a, 282b, 322a, 322b, as indicated in block 740. In embodiments, controller 50 may lock at least one of links 282a, 282b, 322a, 322b in block 740. In embodiments, controller may lock at least one of links 282a, 282b and at least one of links 322a, 322b in block 740. If the airborne time is less than the airborne time value threshold, process 730 may return to block 732. Process 730 may be operable to lock one or more of links 282a, 282b, 322a, 322b in response to the airborne duration being greater than a time threshold because a larger airborne duration may represent a harder, or harsher, landing for which it may be beneficial to have one or more of links 282a, 282b, 322a, 322b locked. That is, by locking one or more of links 282a, 282b, 322a, 322b, front suspension 262 and/or rear suspension 264 are inhibited from moving and/or rotating relative to each other, thereby rigidizing the front suspension 262 and/or rear suspension 264, respectively. During a harder, or harsher landing it may be beneficial to have a more rigid suspension to stabilize the vehicle upon landing and inhibit or prevent the suspensions 262, 264 and/or the shock absorbers 290, 292, 294, 296 and/or the links 282a, 282b, 322a, 322b from bottoming-out. Further, it may be increase the ride and handling and/or maneuverability of the vehicle 200 to keep each of links 282a, 282b, 322a, 322b unlocked in response to the airborne duration being less than a time threshold because a shorter airborne duration may indicate a softer landing, for which it may be beneficial to keep links 282a, 282b, 322a, 322b unlocked. That is, by unlocking one or more of links 282a, 282b, 322a, 322b, front suspension 262 and/or rear suspension 264 are allowed to move and/or rotate relative to each other with a greater range of motion, thereby decreasing the rigidity of the front suspension 262 and/or rear suspension 264, respectively, and creating a softer ride for the operator.

In embodiments, processes 600, 608, 700, 730 in response to determining an airborne condition, alter a damping characteristic of each of shock absorbers 290, 292, 294, 296. In embodiments, in step 606, controller 50 is configured to alter an operating state of all of links 282a, 282b, 322a, 322b to be in the locked operating state (i.e., FIG. 32) and alter a compression damping characteristic of each of shock absorbers 290, 292, 294, 296 to a full-firm damping characteristic. In embodiments, in step 606, controller 50 is configured to alter an operating state of all of links 282a, 282b, 322a, 322b to be in the locked operating state (i.e., FIG. 32) and alter a compression and rebound damping characteristic of each of shock absorbers 290, 292, 294, 296. Additional details regarding controlling compression and rebound damping characteristics during an airborne and landing condition may be found in U.S. patent application Ser. No. 16/198,280, filed May 21, 2020, titled VEHICLE HAVING ADJUSTABLE COMPRESSION AND REBOUND DAMPING, attorney docket no. PLR-15-28021.01P-US, the entire disclosure of which is expressly incorporated herein by reference.

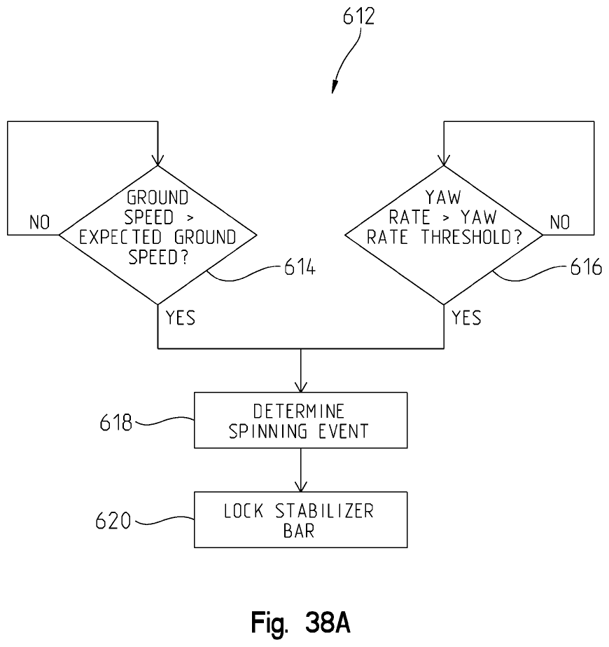

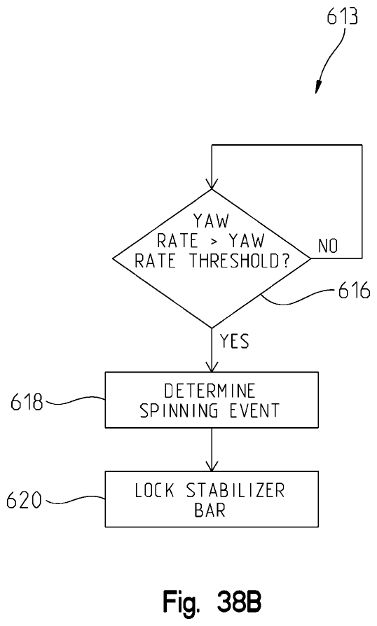

In embodiments, controller 50 is configured to determine when vehicle 200 is in a spinning condition and, in response to the spinning condition, control each of links 282a, 282b, 322a, 322b. Referring to FIG. 38A, controller 50 is configured to operate links 282a, 282b, 322a, 322b according to a process 612. Process 612 comprises a pair of steps 614, 616, and step 614 includes controller 50 determining if a current ground speed of vehicle 200 is less than an expected ground speed of vehicle 200, and step 616 includes controller 50 determining if a yaw rate of vehicle 200 is greater than a yaw rate threshold. In embodiments, a current ground speed of vehicle 200 may be determined by location determiner 70 (e.g., GPS), and an expected ground speed of vehicle 200 may be determined by one or more of an engine speed, a wheel speed, or a combination thereof. Additional details regarding determining a current or expected ground speed may be found in U.S. application Ser. No. 13/153,037, filed Jun. 3, 2011, titled ELECTRONIC THROTTLE CONTROL, attorney docket no. PLR-00EN-23995.04P-US, the entire disclosure of which is expressly incorporated herein by reference.

Still referring to FIG. 38A, controller 50 determines that a spinning event is occurring in step 618 when both steps 614 and steps 616 have been completed, and in response to determining a spinning event, controller 50 is configured to alter, in step 620, the operating state of links 282a, 282b, 322a, 322b. In embodiments, in step 620, altering the links 282a, 282b, 322a, 322b includes locking each of links 282a, 282b, 322a, 322b to increase the rigidity of front suspension 262 and rear suspension 264. Increasing the rigidity of front suspension 262 and rear suspension 264 during a spinning event will decrease the likelihood of an increased roll rate along roll axis 400.

Referring to FIG. 38B, similar to process 612, a process 613 may comprise only steps 616, 618 and 620, and in response to a yaw rate exceeding a yaw rate threshold, controller 50 is configured to alter, in step 620, the operating state of links 282a, 282b, 322a, 322b.

In embodiments, the operating state of links 282a, 282b, 322a, 322b may be altered in response to a user input to one or more of input devices 42. In embodiments, controller 50 receives a user input at, for example, second user actuatable input 572, and in response to the input to second user actuatable input 572, alter an operating state of links 282a, 282b, 322a, 322b. In embodiments, at a first-time controller 50 is operating links 282a, 282b, 322a, 322b in a first state (e.g., unlocked state, locked state, semi-active mode). In embodiments, at the first time, controller 50 may be operating links 282a, 282b, 322a, 322b in varying states. At a second time subsequent to the first-time, controller 50 receives an input (a TASD request) at a user input (e.g., second user actuatable input 572), and at a third time subsequent to the second-time, controller 50 is configured to operate links in a pre-determined state. That is, in embodiments in response to a user input at second user actuatable input 572, controller 50 is configured to alter the operating state of each of links 282a, 282b, 322a, 322b to a locked state. In embodiments, a user input to third user actuatable input 574 may be configured to alter the operating state of each of links 282a, 282b, 322a, 322b to an unlocked state.

In embodiments, in response to an input to a user input (e.g., second user actuatable input 572), controller 50 is configured to alter the operating state of each of links 282a, 282b, 322a, 322b and adjust a damping characteristic of each of shock absorbers 290, 292, 294, 296. In embodiments, controller 50 receives an input to second user actuatable input 572, and in response to receiving the input, controller 50 is configured to alter the operating state of each of links 282a, 282b, 322a, 322b to a locked state and adjust a compression damping characteristic of each of shock absorbers 290, 292, 294, 296 to a full-firm compression damping level. In embodiments, at a fourth-time subsequent to the third time, each of links 282a, 282b, 322a, 322b are configured to return to their previous operating state at the first-time. The fourth-time is a calibratable amount of time after the third-time. Exemplary time periods between third-time and fourth-time are one second, two seconds, three seconds, four seconds, five seconds, or another amount of time.

In one example, at a first time, each of links 282a, 282b, 322a, 322b are operating in the semi-active mode (e.g., links 282a, 282b are unlocked and links 322a, 322b are locked) and shock absorbers 290, 292, 294, 296 are operating at a thirty (30) percent compression damping level. At a second-time subsequent to the first-time, controller 50 receives an input to second user actuatable input 572 and at a third-time subsequent to the second-time, controller 50 alters the operating characteristic of each of links 282a, 282b, 322a, 322b to be in a locked state and controller 50 alters the compression damping characteristic of each of shock absorbers 290, 292, 294, 296 to be a full-firm compression damping level. Further, at a fourth-time subsequent to the fourth-time, controller 50 alters the operating state of each of links 282a, 282b, 322a, 322b to return to the operating state at the first-time (i.e., links 282a, 282b are unlocked and one or more of links 322a, 322b are locked) and controller 50 alters the compression damping characteristic of each of shock absorbers 290, 292, 294, 296 to return to the operating level at the first-time (i.e., shock absorbers 290, 292, 294, 296 operating at a thirty (30) percent compression damping level).

In embodiments, during a cornering event, controller 50 may be configured to alter the operating state of one or more of links 282a, 282b, 322a, 322b. In embodiments, controller 50 is configured to determine that vehicle 200 is in a cornering event, and in response to the cornering event, alter the operating state of stabilizer bar 280 and stabilizer bar 320. In embodiments, it may be advantageous for controller 50 to induce an understeer condition on vehicle 200, or in embodiments, it may be advantageous for controller 50 to induce an oversteer condition on vehicle 200. In embodiments, controller 50 may be configured to both induce either an understeer and an oversteer condition and lock stabilizer bars 280, 320 during a cornering event by delaying the locking of either stabilizer bars 280, 320 relative to the other of stabilizer bars 280, 320. In embodiments, controller 50 may be configured to both induce either an understeer and an oversteer condition and lock stabilizer bars 280, 320 during a cornering event by modifying a damping characteristic of either stabilizer bars 280, 320 relative to the other of stabilizer bars 280, 320.

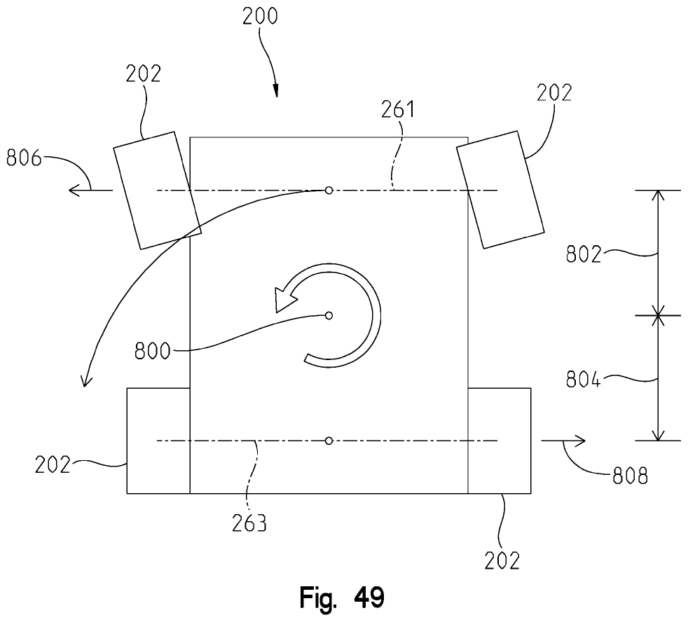

In embodiments, electronic controller 50 may determine the lateral acceleration at one or more of front axle 261 or rear axle 263. Controller 50 may be configured to receive a yaw rate of vehicle 200 and determine, based upon the center of gravity of vehicle 200, the lateral acceleration at one or more of front axle 261 or rear axle 263. Referring to FIG. 49, electronic controller 50 may be configured to determine the center of gravity 800, or alternatively, the center of gravity 800 may be a set constant. Controller 50 may also know the distance 802 between the center of gravity 800 and the front axle 261 and the distance 804 between the center of gravity 800 and the rear axle 263. Controller 50 may determine the lateral velocity of the front axle 261 and the lateral velocity of the rear axle 263 by multiplying the yaw rate by the distance 802, or distance 804, respectively. That is, the lateral velocity along axis 806 of the front axle 261 equals yaw rate multiplied by distance 802, and the lateral velocity along 808 of the rear axle 263 equals yaw rate multiplied by distance 804. The lateral acceleration at front axle 261 may be determined by the instantaneous rate of change (i.e., derivative) of the lateral velocity of the front axle 261 and the lateral acceleration at rear axle 263 may be determined by the instantaneous rate of change (i.e., derivative) of the lateral velocity of the rear axle 263.

In embodiments, electronic controller 50 may determine vehicle 200 is cornering and/or direction of the turn, as previously described, based on the steering information indicating a steering rate, angle, and/or position, yaw rate information indicating a yaw rate, and/or the acceleration information indicating a lateral acceleration, and/or the lateral acceleration at the front axle 261 and/or rear axle 263. In embodiments, it may be advantageous to promote an oversteer condition of vehicle 200, and in embodiments, it may be advantageous to promote an understeer condition of vehicle 200. In embodiments, an understeer or oversteer condition may be promoted based upon one or more of a drive mode, a steering characteristic, a throttle characteristic, a braking characteristic, a lateral acceleration, a longitudinal acceleration, a vertical acceleration, a yaw rate, a roll rate, a pitch rate, a vehicle speed, or another characteristic.

In embodiments, controller 50 may determine than an oversteer condition is required, and in response, controller 50 is configured to lock, at a first time, lock each of rear left link 322a and rear right link 322b to lock rear stabilizer bar 320, and at a second time, subsequent to the first time, lock each of front left link 282a and front right link 282b to lock front stabilizer bar 280. That is, front stabilizer bar 280 will be locked after a predetermined time delay after rear stabilizer bar 320 is locked. When rear stabilizer bar 320 is locked, the traction at the rear wheels is reduced (e.g., during a right turn, vehicle 200 will experience a left lateral acceleration and the rear-right wheel is prone to lifting off the ground), and during the predetermined time delay, the front wheels will have greater traction (e.g., with front stabilizer bar 280 unlocked while rear stabilizer bar 320 is locked, both front wheels will be more prone to maintain traction with the ground) than the rear wheels and allow vehicle 200 to enter into an oversteer condition.

In embodiments, controller 50 may determine than an understeer condition is required, and in response, controller 50 is configured to lock, at a first time, at least one of front left link 282a and front right link 282b to lock front stabilizer bar 280, and at a second time, subsequent to the first time, lock at least one of rear left link 322a and rear right link 322b to lock rear stabilizer bar 320. That is, rear stabilizer bar 320 will be locked after a predetermined time delay after front stabilizer bar 280 is locked. When front stabilizer bar 280 is locked, the traction at the front wheels is reduced (e.g., during a right turn, vehicle 200 will experience a left lateral acceleration and the front-right wheel is prone to lifting off the ground), and during the predetermined time delay, the rear wheels will have greater traction (e.g., with rear stabilizer bar 320 unlocked while front stabilizer bar 280 is locked, both rear wheels will be more prone to maintain traction with the ground) than the front wheels and allow vehicle 200 to enter into an understeer condition.

In embodiments, the predetermined time delay is approximately 200 milliseconds (ms). In embodiments, the predetermined time delay is approximately 100 ms, 300 ms, 400 ms, 500 ms, 1 second, or another predetermined time period.

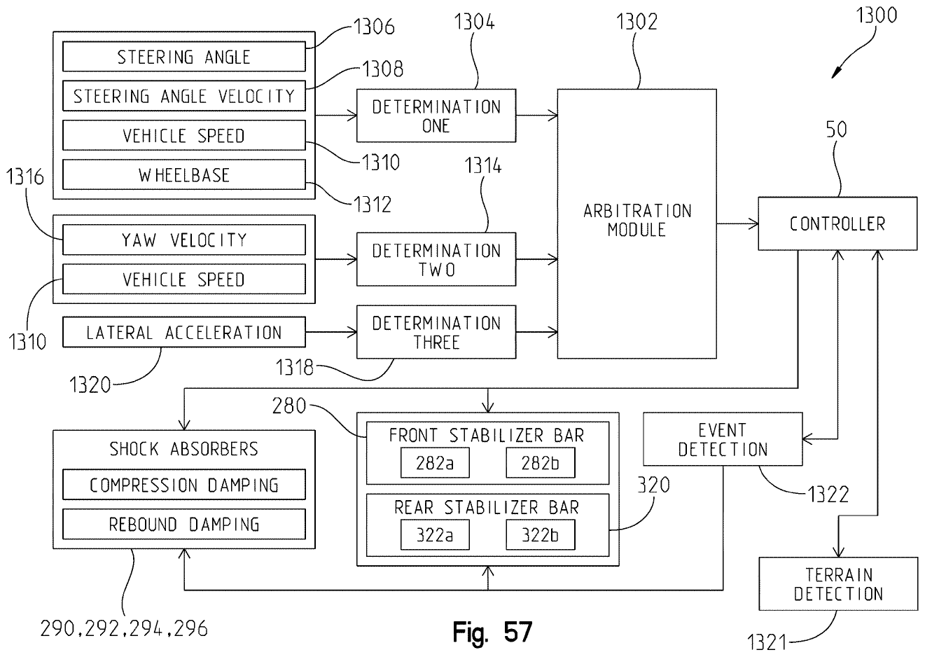

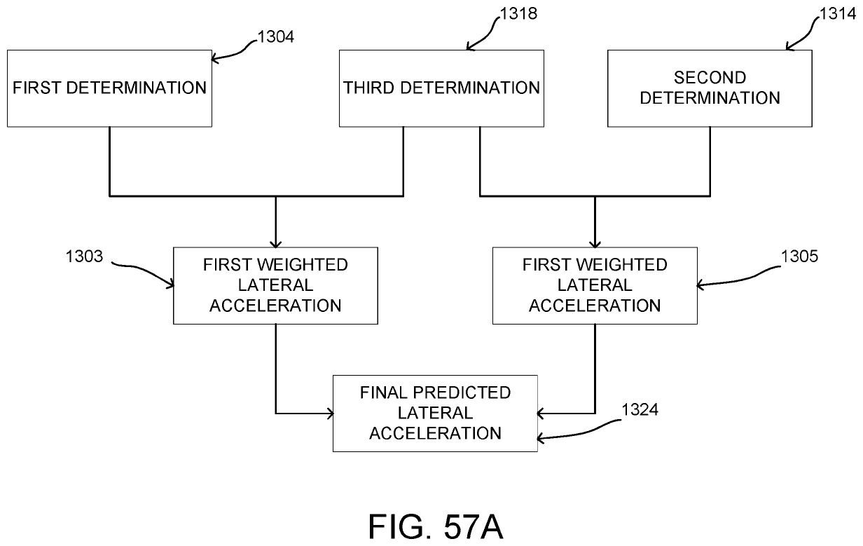

Referring now to FIG. 57, a control diagram 1300 includes a lateral acceleration model 1300 including an arbitration module 1302 operable to discriminate and compare between a first determination 1304, a second determination 1314, and a third determination 1318. In embodiments, the arbitration module 1302 is operable to discriminate and compare between one determination, two determinations, three determinations, four determinations, or more determinations. Each determination (e.g., first determination 1304, second determination 1314, and third determination 1318) represents a predicted value of a lateral acceleration or a measurement of a lateral acceleration. In embodiments, arbitration module 1302 is a separate controller from controller 50. In embodiments, arbitration module 1302 is a part of controller 50.

Referring still to FIG. 57, the first determination 1304 receives a plurality of inputs including a steering angle value 1306 (e.g., by steering angle sensor 106), a steering angle velocity 1308 (e.g., by steering angle sensor 106), a vehicle speed 1310 (e.g., from vehicle speed sensor 104) and the wheelbase of vehicle 200. In embodiments, the first determination 1304 is a steering angle based pre-prediction of lateral acceleration. The pre-predicted lateral acceleration may be determined by Lateral Acceleration Equation 1.

Lateral Acceleration Equation 1=((V\hat{ }2)*sin(α))/W.

V=Vehicle Velocity; α=Wheel Cut Angle; W=Wheelbase.

The first determination 1304 provides an initial determination based on steering angle that a cornering event is occurring. That is, as shown in Lateral Acceleration Equation 1, as the wheel cut angle increases, which may be a scaled factor directly correlated to steering angle, the output (i.e., pre-prediction lateral acceleration) of Lateral Acceleration Equation 1 will increase. As the output of Lateral Acceleration Equation 1 increases this indicates that vehicle 200 is more likely encountering a cornering event. In embodiments, a positive wheel cut angle (e.g., +2 radians or within 0-1 pi radians) and a positive vehicle velocity 1310 (e.g., moving forward), indicates a left-hand turn or cornering event. In embodiments, a negative wheel cut angle (e.g., −2 radians or within −1 pi−0 radians) and a positive vehicle velocity 1310 (e.g., moving forward), indicates a right-hand turn or cornering event. In embodiments, a positive wheel cut angle (e.g., +2 radians or within 0-1 pi radians) and a negative vehicle velocity 1310 (e.g., moving backwards), indicates a reverse left-hand turn or cornering event. In embodiments, a negative wheel cut angle (e.g., −2 radians or within −1 pi−0 radians) and a negative vehicle velocity 1310 (e.g., moving backwards), indicates a reverse right-hand turn or cornering event. In embodiments, a left hand turn may be measured as a positive wheel cut angle and a right hand turn may be measured as a negative wheel cut angle. In embodiments, a left hand turn may be measured as a negative wheel cut angle and a right hand turn may be measured as a positive wheel cut angle.

Referring still to FIG. 57, the second determination 1314 receives a plurality of inputs including a yaw velocity (e.g., form IMU 108) and a vehicle speed 1310 (e.g., from vehicle speed sensor 104). In embodiments, the second determination 1314 is a yaw velocity pre-prediction of lateral acceleration. The pre-predicted lateral acceleration may be determined by Lateral Acceleration Equation 2.

Lateral Acceleration Equation 2=V*β_1.

V=Vehicle Velocity; β_1=Yaw Velocity.

The second determination 1314 provides a secondary determination based on yaw angle that a cornering event is occurring. That is, as shown in Lateral Acceleration Equation 2, a yaw velocity 1316 value greater or less than zero and a vehicle speed 1310 greater or less than zero will yield a lateral acceleration, and as either or both of yaw velocity 1316 and vehicle speed 1310 grow, the lateral acceleration will grow. In embodiments, a positive value yaw velocity 1316 (e.g., +2 radians/second) with a positive vehicle speed 1310 (e.g., moving forward) indicates a left-hand turn or cornering event. In embodiments, a negative value yaw velocity 1316 (e.g., −2 radians/second) with a positive vehicle speed 1310 (e.g., moving forward) indicates a right-hand turn or cornering event. In embodiments, a positive value yaw velocity 1316 (e.g., +2 radians/second) with a negative vehicle speed 1310 (e.g., moving backwards) indicates a reverse right-hand turn or cornering event. In embodiments, a negative value yaw velocity 1316 (e.g., +2 radians/second) with a negative vehicle speed 1310 (e.g., moving backwards) indicates a reverse left-hand turn or cornering event.

Referring still to FIG. 57, the third determination 1318 receives an input from a lateral acceleration sensor 1320 (e.g., IMU 108 or Accelerometer 110). In embodiments, the third determination is an actual contemporaneous value of lateral acceleration directly from the acceleration sensor 1320 (e.g., IMU 108 or Accelerometer 110).

Referring still to FIG. 57, arbitration module 1302 is configured to receive inputs from one or more of the first determination 1304, second determination 1314, and third determination 1318. Arbitration module 1302 is operable to provide a ranking, or a weight, to each of the determinations 1304, 1314, 1318 based on their strength and accuracy. The first determination 1304 may be used as an initial predictor while the second determination 1314 may be used as a secondary predictor because steering based lateral acceleration prediction (i.e., the first determination 1304) may often lead in predicting a lateral acceleration while a yaw based lateral acceleration prediction (i.e., the second determination 1314) will follow the steering based lateral acceleration prediction. This is because the yaw that is created to determine the yaw based lateral acceleration prediction is generated as a result of a steering input used to generate the steering based lateral acceleration prediction. The third determination 1318 is the actual measured lateral acceleration and therefore may be used as a baseline model of values to measure the predicted values of the first determination 1304 and the second determination 1314 against.

Arbitration module 1302 is operable to determine a confidence of each of the first determination 1304 and the second determination 1314. The confidence of the third determination 1318 is high because this is an actual measured value (e.g., the actual measured lateral acceleration). The confidence of the first determination 1304 and second determination 1314 may be determined by comparing their predicted lateral acceleration to the actual measured lateral acceleration of the third determination 1318.

The confidence of the first determination 1304, or the steering based lateral acceleration pre-prediction, will vary based on the accuracy of the first determination 1304 relative to the actual measured lateral acceleration measured in the third determination 1318. The confidence of the first determination 1304 will go up when the value of the first determination 1304 is accurately predicting and leading the actual measured lateral acceleration measured in the third determination 1318. That is, if the first determination 1304 (i.e., the steering based lateral acceleration prediction) has a positive sign and is increasing in value, and subsequently the third determination 1318 (i.e., the actually measured lateral acceleration) has a positive sign and is increasing in value, the first determination can be determined to have a greater confidence. In embodiments, the confidence in the first determination 1304 will be increased when the first determination 1304 and the third determination 1318 have the same sign (e.g., positive sign or negative sign) and the magnitude of the first determination 1304 is greater than the third determination 1318. In embodiments, the confidence may vary as the differential margin between the value of the first determination 1304 and the third determination 1318 increases or decreases. In embodiments, if the first determination 1304 (i.e., the steering based lateral acceleration prediction) has a positive sign and is increasing in value, and subsequently the third determination 1318 (i.e., the actually measured lateral acceleration) has either a negative sign or is decreasing in value, the first determination 1304 can be determined to have a lesser confidence. In embodiments, the confidence of the first determination 1304 is at least partially determined based upon vehicle speed 1310.

The confidence of the first determination 1304 may be decreased if the sign (e.g., positive sign or negative sign) of the first determination 1304 and the sign (e.g., positive sign or negative sign) of the third determination 1318 do not match. In embodiments, if the first determination 1304 has a positive sign or value and the third determination 1318 has a negative sign or value, the confidence in the first determination 1304 will be decreased. In embodiments, if the third determination 1318 is determined to have a value near-zero (e.g., between −0.1 Gs and 0.1Gs), the confidence of the first determination 1304 will not be affected if the sign (e.g., positive sign or negative sign) of the first determination 1304 does not match the sign (e.g., positive sign or negative sign) of the third determination 1318. The confidence of the first determination 1304 may be decreased if the value of the first determination 1304 is increasing in the same direction as the third determination 1318 and the first determination 1304 is less than the third determination 1318. That is if the first determination 1304 is increasing and at a first positive value, and the third determination 1318 is increasing and at a second positive value greater than the first positive value, the confidence in the first determination 1304 will be decreased.

The confidence of the second determination 1314, or the yaw based lateral acceleration pre-prediction, will vary based on the accuracy of the second determination 1314 relative to the actual measured lateral acceleration measured in the third determination 1318. The confidence of the second determination 1314 will go up when the value of the second determination 1314 is accurately predicting and leading the actual measured lateral acceleration measured in the third determination 1318. That is, if the second determination 1314 (i.e., the yaw based lateral acceleration prediction) has a positive sign and is increasing in value, and subsequently the third determination 1318 (i.e., the actually measured lateral acceleration) has a positive sign and is increasing in value, the second determination can be determined to have a greater confidence. In embodiments, the confidence in the second determination 1314 will be increased when the second determination 1314 and the third determination 1318 have the same sign (e.g., positive sign or negative sign) and the magnitude of the second determination 1314 is greater than the third determination 1318. In embodiments, the confidence may also increase as the differential margin between the value of the second determination 1314 and the third determination 1318 decreases and the confidence may also decrease as the differential margin between the value of the second determination 1314 and the third determination 1318 increases. In embodiments, if the second determination 1314 (i.e., the yaw based lateral acceleration prediction) has a positive sign and is increasing in value, and subsequently the third determination 1318 (i.e., the actually measured lateral acceleration) has either a negative sign or is decreasing in value, the second determination 1314 can be determined to have a lesser confidence. In embodiments, the confidence of the second determination 1314 is at least partially determined based upon vehicle speed 1310.

The confidence of the second determination 1314 may be decreased if the sign (e.g., positive sign or negative sign) of the second determination 1314 and the sign (e.g., positive sign or negative sign) of the third determination 1318 do not match. In embodiments, if the second determination 1314 has a positive sign or value and the third determination 1318 has a negative sign or value, the confidence in the second determination 1314 will be decreased. In embodiments, if the third determination 1318 is determined to have a value near-zero (e.g., between −0.1Gs and 0.1Gs), the confidence of the second determination 1314 will not be affected if the sign (e.g., positive sign or negative sign) of the second determination 1314 does not match the sign (e.g., positive sign or negative sign) of the third determination 1318. The confidence of the second determination 1314 may be decreased if the value of the second determination 1314 is increasing in the same direction as the third determination 1318 and the second determination 1314 is less than the third determination 1318. That is if the second determination 1314 is increasing and at a first positive value, and the third determination 1318 is increasing and at a second positive value greater than the first positive value, the confidence in the second determination 1314 will be decreased.

In embodiments, controller 50 is operable to detect a vehicle event, as indicated by block 1322, which may include a cornering event, a side-hilling event, a sliding event, a spinning event, or another type of vehicle event.

Referring to FIGS. 57-57A, the controller 50 is operable to determine a final predicted lateral acceleration 1324 based upon the first determination 1304, second determination 1314 and third determination 1318. Controller 50 may combine the first determination 1304 and the third determination 1318 based upon a calibratable percentage to arrive at the first weighted predicted lateral acceleration 1303 and the controller 50 may combine the second determination 1314 and the third determination 1318 based upon a calibratable percentage to arrive at the second weighted predicted lateral acceleration 1305. That is, the first weighted predicted lateral acceleration 1303 may be the average of the first determination 1304 and the third determination 1318 and the second weighted predicted lateral acceleration 1305 may be the average of the second determination 1314 and the third determination 1318. In embodiments, the first weighted predicted lateral acceleration 1303 and the second weighted predicted lateral acceleration value 1305 are determined by the arbitration module 1302.

In embodiments, the first weighted predicted lateral acceleration 1303 and the second weighted predicted lateral acceleration 1305 are combined according to a calibratable percentage to arrive at the final predicted lateral acceleration 1324. That is, in embodiments, if the calibratable percentage is 20%, the controller 50 is operable to use 20% of the first weighted predicted lateral acceleration 1303 (i.e., capturing the value of the steering-based pre-prediction value) and 80% of the second weighted predicted lateral acceleration 1305 (i.e., capturing the value of the yaw-based pre-prediction value). The calibratable percentage may be any percentage between 0% 100%. In embodiments, the calibratable percentage may be 0%, 10%, 20%, 30%, 40%, 50%, 60%, 70%, 80%, 90%, or 100%. In embodiments, the calibratable percentage may be set as a factory setting. In embodiments, the calibratable percentage is different based upon the present operating mode. In embodiments, if the calibratable percentage is 40%, the controller 50 is operable to use 40% of a first one of the first weighted predicted lateral acceleration 1303 based on the first determination 1304 (i.e., the value of the steering-based pre-prediction value) and the second weighted predicted lateral acceleration 1305 based on the second determination 1314 (i.e., the value of the yaw-based pre-prediction value) and 60% of a second one of the first weighted predicted lateral acceleration 1303 based on the first determination 1304 (i.e., the value of the steering-based pre-prediction value) and the second weighted predicted lateral acceleration 1305 based on the second determination 1314 (i.e., the value of the yaw-based pre-prediction value).

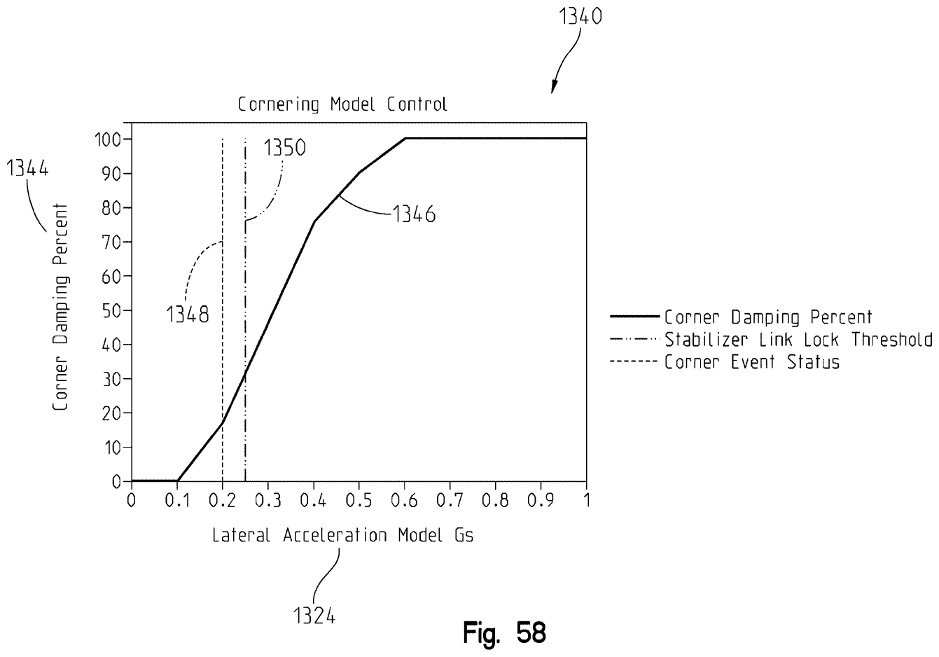

Referring now to FIG. 58, a graph or damping model 1340 provides a curve 1346 which is representative of a damping percent 1344 based on the predicted lateral acceleration 1324. That is, the damping percent (i.e., compression damping or rebound damping) may range between 0%-100%, wherein 0% is representative of a base damping of each of shock absorbers 290, 292, 294, 296, and 100% is representative of a maximum damping of each of shock absorbers 290, 292, 294, 296. In embodiments, the damping percent of any of shock absorbers 290, 292, 294, 296 may be any value between 0%-100% based upon the determined lateral acceleration 1324. Still referring to FIG. 58, curve 1346 (i.e., the damping percent of one or more of shock absorbers 290, 292, 294, 296) is approximately 0% between 0-0.1 Gs. That is, at low lateral acceleration events (e.g., 0-0.1 Gs) the damping percent will remain at a base damping value. The damping percent 1344 trends upwardly from 0% to 100% as the predicted lateral acceleration 1324 increases from 0.1 Gs to 0.6 Gs. That is, as lateral acceleration increases, the damping percent will increase from the base damping value (i.e., 0%) to the maximum damping value (i.e., 100%). Further, curve 1346 maintains a damping percent 1344 of 100% above 0.6 Gs. That is, during high lateral acceleration events, one or more of shocks 290, 292, 294, 296 may operate at a 100% damping percent value or the maximum damping value. In embodiments, curve 1346 may be adjustable or calibratable for each of a compression damping characteristic, rebound damping characteristic for each shock absorber 290, 292, 294, 296 based upon a vehicle mode (e.g., baja, track, race, comfort, etc.). That is, curve 1346 may be more steep or less steep or may have different shapes for each of the compression damping characteristic, and rebound damping characteristic for each of shock absorbers 290, 292, 294, 296 in each vehicle mode (e.g., baja, track, race, comfort, etc.).

In embodiments, during a cornering event, the inner shock absorbers (i.e., the left shock absorbers 290, 294 during a left turn or the right shock absorbers 292, 296 during a right turn) may have their compression damping characteristic adjusted based upon the damping percent 1344 and the outer shock absorbers (i.e., the left shock absorbers 290, 294 during a right turn or the right shock absorbers 292, 296 during a left turn) may have their rebound damping characteristic adjusted based upon the damping percent 1344.

Referring still to FIG. 58, vehicle 200 may experience a first lateral acceleration value (e.g., 0.1 Gs) and controller 50 is operable to adjust the damping percent of one or more of shock absorbers 290, 292, 294, 296 to a first damping percent (e.g., 0% or a base damping percent). Vehicle 200 may experience a second lateral acceleration value greater than the first lateral acceleration value (e.g., 0.6 Gs) and controller 50 is operable to adjust the damping percent of one or more of shock absorbers 290, 292, 294, 296 to a second damping percent greater than the first damping percent (e.g., 100% or a maximum damping percent). Vehicle 200 may experience a third lateral acceleration value greater than the first lateral acceleration value and less than the second lateral acceleration value (e.g., 0.3 Gs) and controller 50 is operable to adjust the damping percent of one or more of shock absorbers 290, 292, 294, 296 to a third damping percent greater than the first damping percent and less than the second damping percent (e.g., approximately 50% damping).

In embodiments, graph 1340 includes a first threshold 1348 representative of a first lateral acceleration threshold. The first threshold 1348 represents a predicted lateral acceleration threshold at which a cornering event is detected. That is, the first threshold is approximately 0.2 Gs (e.g., 1 G equals approximately 9.8 m/s\hat{ }2; 0.2 Gs equals approximately 1.96 m/s\hat{ }2) and when vehicle 200 experiences a lateral acceleration greater than 0.2 Gs, controller 50 will operate according to a cornering event. That is, controller 50 is operable to adjust a damping characteristic of one or more of shock absorbers 290, 292, 294, 296 based upon the determined lateral acceleration 1324. In embodiments, graph 1340 includes a second threshold 1350 representative of a lateral acceleration threshold. The second threshold 1350 represents a predicted lateral acceleration threshold at which stabilizer bars 280, 320 will be locked. That is, the second threshold is approximately 0.25 Gs (e.g., 1 G equals approximately 9.8 m/s\hat{ }2; 0.25 Gs equals approximately 2.43 m/s\hat{ }2) and when vehicle 200 experiences a lateral acceleration greater than 0.25 Gs, controller 50 is operable to adjust at least one of stabilizer bars 280, 320. That is, in response to the lateral acceleration 1324 exceeding the second threshold 1350, the controller 50 is operable to adjust at least one of links 282a, 282b, 322a, 322b. In embodiments, in response to the lateral acceleration 1324 exceeding the second threshold 1350, the controller 50 is operable to adjust each of links 282a, 282b, 322a, 322b. In embodiments, in response to the lateral acceleration 1324 exceeding the second threshold 1350, the controller 50 is operable to lock at least one of links 282a, 282b, 322a, 322b. In embodiments, in response to the lateral acceleration 1324 exceeding the second threshold 1350, the controller 50 is operable to lock each of links 282a, 282b, 322a, 322b.

Still referring to FIG. 58, graph 1340 illustrates the determination of a cornering event and a delay between the lock of one or more of stabilizer bars 280, 320 and an increase in the damping percent of one or more of shock absorbers 290, 292, 294, 296. In embodiments, curve 1346 and thresholds 1348, 1350 may be altered based upon a vehicle speed. In embodiments, the thresholds 1348, 1350 may be closer together as vehicle speed increases. That is, as vehicle speed increases, the time between determining a cornering event is occurring and one or more of the stabilizer bars 280, 320 is locked is reduced. In embodiments, the thresholds 1348, 1350 may be further apart as vehicle speed decreases. That is, as vehicle speed decreases, the time between determining a cornering event is occurring and one or more of the stabilizer bars 280, 320 is locked is reduced. In embodiments, threshold 1350 may be variably spaced from the initial increase of damping percent 1344. That is, as vehicle speed increases, the threshold 1350 may occur at a lower predicted lateral acceleration 1324 and as vehicle speed decreases, the threshold 1350 may occur at a higher predicted acceleration 1324. That is, as vehicle speed increases, controller 50 is operable to control a delay between an onset or increase of the damping percent 1344 of one or more of shock absorbers 290, 292, 294, 296 and the locking of one or more of stabilizer bars 280, 320.

In embodiments, in response to controller 50 determining a first lateral acceleration 1324 (e.g., 0.2 Gs) of the vehicle 200, the controller 50 is operable to adjust the at least one adjustable damping characteristic (e.g., compression damping characteristic or the rebound damping characteristic) of at least one of adjustable shock absorber 290, 292, 294, 296 to a first damping value (e.g., damping percent 1344 equal to 20%) and at least one of the stabilizer bar 280, 320 to a first configuration (e.g., unlocked, locked, semi-active), and in response to the controller 50 determining a second lateral acceleration 1324 (e.g., 0.3 Gs) greater than the first lateral acceleration, the controller 50 is operable to adjust at least one of adjustable stabilizer bars 280, 320 to the second configuration (e.g., unlocked, locked, semi-active).

In embodiments, in response to controller 50 determining a first lateral acceleration 1324 (e.g., 0.2 Gs) of the vehicle 200, the controller 50 is operable to adjust the at least one adjustable damping characteristic (e.g., compression damping characteristic or the rebound damping characteristic) of at least one of adjustable shock absorber 290, 292, 294, 296 to a first damping value (e.g., damping percent 1344 equal to 20%) and at least one of the stabilizer bar 280, 320 to a first configuration (e.g., unlocked, locked, semi-active), and in response to the controller 50 determining a second lateral acceleration 1324 (e.g., 0.3 Gs) greater than the first lateral acceleration, the controller 50 is operable to adjust the at least one adjustable damping characteristic (e.g., compression damping characteristic or the rebound damping characteristic) of at least one of adjustable shock absorber 290, 292, 294, 296 to a first damping value (e.g., damping percent 1344 equal to 40%) and at least one of adjustable stabilizer bars 280, 320 to a second configuration (e.g., unlocked, locked, semi-active).

In embodiments, during a cornering event, controller 50 may be operable to lock each of stabilizer bars 280, 320 at the same time. In embodiments, during a cornering event, controller 50 may insert a time delay between locking one of the stabilizer bars 280, 320 and the other of the stabilizer bars 280, 320. In embodiments, during a cornering event, controller 50 may lock only one of stabilizer bars 280, 320. In embodiments, during a cornering event, controller 50 is operable to lock only one of links 282a, 282b to lock stabilizer bar 280. In embodiments, controller 50 is operable to lock only one of links 322a, 322b to lock stabilizer bar 320. In embodiments, during a cornering event, controller 50 is operable to lock one of links 282a, 282b and lock one of links 322a, 322b to lock each of stabilizer bars 280, 320. In embodiments, during a cornering event, controller 50 is operable to lock each of links 282a, 282b and lock one of links 322a, 322b to lock each of stabilizer bars 280, 320. In embodiments, during a cornering event, controller 50 is operable to lock one of links 282a, 282b and lock each of links 322a, 322b to lock each of stabilizer bars 280, 320.

In embodiments, during a cornering event, controller 50 may be operable to lock only the inside links. That is, during a left-hand turn, controller 50 may be operable to lock each of links 282a, 322a on the inside, or left-side, of vehicle 200. During a right-hand turn, controller 50 may be operable to lock each of links 282b, 322b on the inside, or right-side of vehicle 200. In embodiments, during a cornering event, controller 50 may be operable to lock only the outside links. That is, during a right-hand turn, controller 50 may be operable to lock each of links 282a, 322a on the outside, or left-side, of vehicle 200. During a left-hand turn, controller 50 may be operable to lock each of links 282b, 322b on the outside, or right-side of vehicle 200. In embodiments, during a cornering event, controller 50 may be operable to lock each of links 282a, 282b, 322a, 322b.

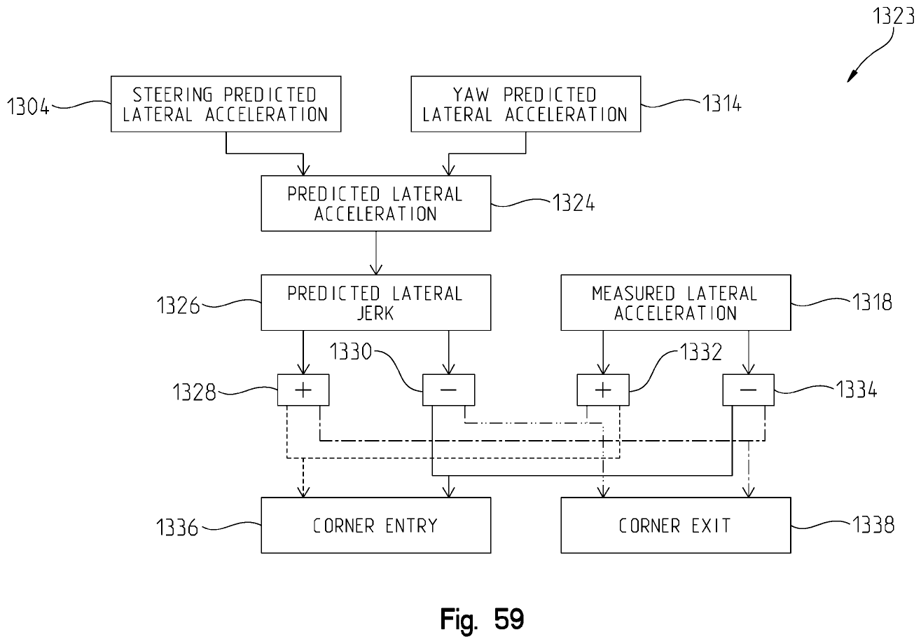

Referring again to FIG. 59, controller 50 is operable to determine a predicted lateral jerk 1326 by taking the derivative of the predicted lateral acceleration 1324. The predicted lateral jerk 1326 will yield either a positive value 1328, a negative value 1330, or may also return a zero-value (not shown) when the predicted lateral acceleration is constant. The measured lateral acceleration 1318 may also yield either a positive value 1332, a negative value 1334, or may also return a zero-value (not shown) when the lateral velocity is constant. In embodiments, when vehicle is in a cornering event, controller 50 may be operable to determine vehicle 200 is in one of a corner-entry condition 1336 or a corner-exit condition 1338. In embodiments, if the sign (positive/negative) of the predicted lateral jerk 1326 and measured lateral acceleration 1318 matches, controller 50 may determine that vehicle 200 is in the corner entry condition 1336. In embodiments, if the sign (positive/negative) of the predicted lateral jerk 1326 and measured lateral acceleration 1318 do not match, controller 50 may determine that vehicle 200 is in the corner exit condition 1338. In embodiments, if the predicted lateral jerk 1326 is a positive value and the measured lateral acceleration 1318 is a positive value, controller 50 may determine that vehicle 200 is in the corner entry condition 1336. In embodiments, if the predicted lateral jerk 1326 is a negative value and the measured lateral acceleration 1318 is a negative value, controller 50 may determine that vehicle 200 is in the corner entry condition 1336. In embodiments, if the predicted lateral jerk 1326 is a positive value and the measured lateral acceleration 1318 is a negative value, controller 50 may determine that vehicle 200 is in the corner exit condition 1338. In embodiments, if the predicted lateral jerk 1326 is a negative value and the measured lateral acceleration 1318 is a positive value, controller 50 may determine that vehicle 200 is in the corner exit condition 1338.

Still referring to FIG. 59, controller 50 may determine that vehicle 200 is in a corner entry condition 1336 and may adjust the damping characteristic of one or more of adjustable shock absorbers 290, 292, 294, 296. Further, controller 50 may determine that vehicle 200 is in a corner exit condition 1338 and may adjust the damping characteristic of one or more of adjustable shock absorbers 290, 292, 294, 296. In embodiments, during a corner entry condition 1336, controller 50 may be operable to increase the compression damping characteristic of the outside shock absorbers (e.g., shock absorbers 290, 294 during a right turn and shock absorbers 292, 296 during a left turn) and controller 50 may be operable to increase the rebound damping characteristic of the inside shock absorbers (e.g., shock absorbers 290, 294 during a left turn and shock absorbers 292, 296 during a right turn). In embodiments, during a corner exit condition, the lateral acceleration 1324 may have a first sign (e.g., a positive sign indicating a left turn, and the predicted lateral jerk 1326 may have a second sign (e.g., a negative sign) indicating vehicle 200 is coming out of a turn. During the corner exit condition, based upon the predicted lateral jerk 1326, controller 50 may increase the rebound damping of the outside shock absorbers (e.g., shock absorbers 290, 294 during a right turn and shock absorbers 292, 296 during a left turn) and increase the compression damping of the inside shock absorbers (e.g., shock absorbers 290, 294 during a left turn and shock absorbers 292, 296 during a right turn).

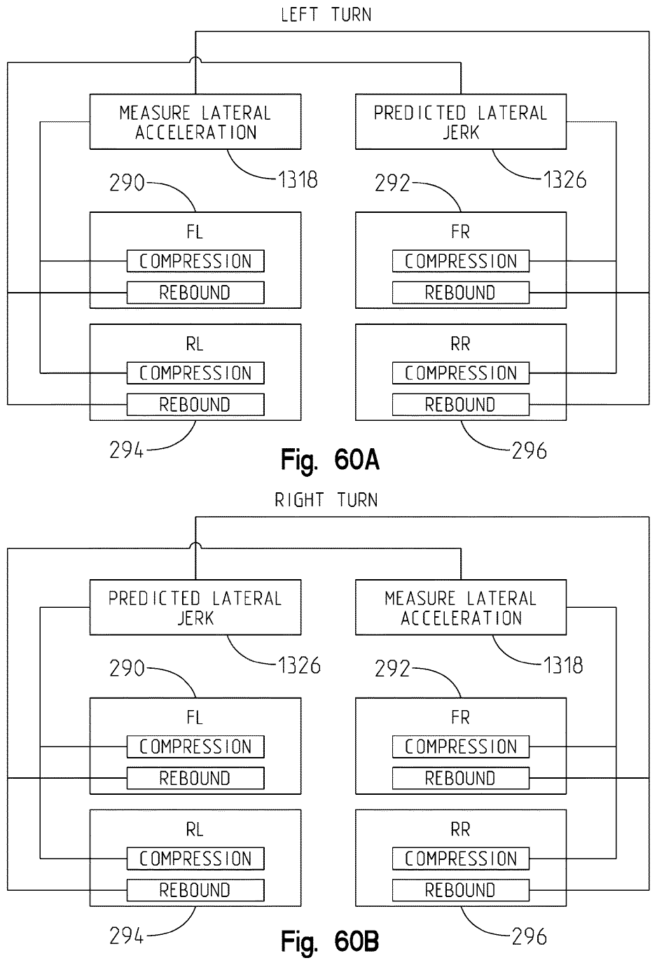

Referring now to FIG. 60A, controller 50 may be operable to control shock absorbers 290, 292, 294, 296 according to a compression damping characteristic and a rebound damping characteristic. Referring to FIG. 60A, during a left turn, controller 50 may utilize the measured lateral acceleration 1318 (i.e., the third determination) to control the compression damping characteristic of the front left shock absorber 290 and the compression damping characteristic of the rear left shock absorber 294. That is, the compression damping characteristic of each of the inner shock absorbers (i.e., shock absorbers 290, 294 during a left turn) may be adjusted based upon the measured lateral acceleration 1318 of vehicle 200. Referring still to FIG. 60A, during a left turn, controller 50 may utilize the measured lateral acceleration 1318 (i.e., the third determination) to control the rebound damping characteristic of the front right shock absorber 292 and the rebound damping characteristic of the rear right shock absorber 296. That is, the rebound damping characteristic of each of the outer shock absorbers (i.e., shock absorbers 292, 296 during a left turn) may be adjusted based upon the measured lateral acceleration 1318 of vehicle 200. Referring still to FIG. 60A, during a left turn, controller 50 may utilize the predicted lateral jerk 1326 to control the rebound damping characteristic of the front left shock absorber 290 and the rebound damping characteristic of the rear left shock absorber 294. That is, the rebound damping characteristic of each of the inner shock absorbers (i.e., shock absorbers 290, 294 during a left turn) may be adjusted based upon the predicted lateral jerk 1326 of vehicle 200. Referring still to FIG. 60A, during a left turn, controller 50 may utilize the predicted lateral jerk 1326 to control the compression damping characteristic of the front right shock absorber 292 and the compression damping characteristic of the rear right shock absorber 296. That is, the compression damping characteristic of each of the outer shock absorbers (i.e., shock absorbers 292, 296 during a left turn) may be adjusted based upon the predicted lateral jerk 1326 of vehicle 200.

Referring now to FIG. 60B, controller 50 may be operable to control shock absorbers 290, 292, 294, 296 according to a compression damping characteristic and a rebound damping characteristic. Referring to FIG. 60B, during a right turn, controller 50 may utilize the measured lateral acceleration 1318 (i.e., the third determination) to control the compression damping characteristic of the front right shock absorber 292 and the compression damping characteristic of the rear right shock absorber 296. That is, the compression damping characteristic of each of the inner shock absorbers (i.e., shock absorbers 292, 296 during a right turn) may be adjusted based upon the measured lateral acceleration 1318 of vehicle 200. Referring still to FIG. 60B, during a right turn, controller 50 may utilize the measured lateral acceleration 1318 (i.e., the third determination) to control the rebound damping characteristic of the front left shock absorber 290 and the rebound damping characteristic of the rear left shock absorber 294. That is, the rebound damping characteristic of each of the outer shock absorbers (i.e., shock absorbers 290, 294 during a right turn) may be adjusted based upon the measured lateral acceleration 1318 of vehicle 200. Referring still to FIG. 60B, during a right turn, controller 50 may utilize the predicted lateral jerk 1326 to control the rebound damping characteristic of the front right shock absorber 292 and the rebound damping characteristic of the rear right shock absorber 296. That is, the rebound damping characteristic of each of the inner shock absorbers (i.e., shock absorbers 292, 296 during a right turn) may be adjusted based upon the predicted lateral jerk 1326 of vehicle 200. Referring still to FIG. 60B, during a right turn, controller 50 may utilize the predicted lateral jerk 1326 to control the compression damping characteristic of the front left shock absorber 290 and the compression damping characteristic of the rear left shock absorber 294. That is, the compression damping characteristic of each of the outer shock absorbers (i.e., shock absorbers 290, 294 during a right turn) may be adjusted based upon the predicted lateral jerk 1326 of vehicle 200.

Controller 50 may determine whether a compression damping characteristic or a rebound damping characteristic of each shock absorber (i.e., shock absorber 290, 292, 294, 296) is adjusted based upon the vehicle 200 encountering a left turn or a right turn. Controller 50 may reference a cornering model based upon predicted lateral acceleration (e.g., graph 1340) to determine a damping percent (i.e., 0%-100%) of each compression damping characteristic and rebound damping characteristic for each shock absorber 290, 292, 294, 296 during a left turn or a right turn.

In embodiments, controller 50 may use the predicted lateral acceleration 1324 to adjust the compression damping characteristic and/or rebound damping characteristic of each of the shock absorbers 290, 292, 294, 296 during a left turn or a right turn. Controller 50 may also use the predicted lateral jerk 1326 to increase the rebound damping of the inside shock absorbers (e.g., shock absorbers 290, 294 during a left turn and shock absorbers 292, 296 during a right turn) past the adjusted rebound damping characteristic determined by the predicted lateral acceleration. Further, the controller may also use the predicted lateral jerk 1326 to increase the compression damping of the outside shock absorbers (e.g., shock absorbers 290, 294 during a right turn and shock absorbers 292, 296 during a left turn) past the adjusted compression damping characteristic determined by the predicted lateral acceleration.

Referring again to FIG. 57, controller 50 may be operable to detect a terrain vehicle 200 is traversing, as indicated by block 1321. Controller 50 may be operable to determine that vehicle 200 is traversing over two or more types of terrains and properly identify the terrain. That is, controller 50 may be able to detect, in embodiments, a smooth terrain (e.g., an on-road terrain) and a rough terrain (e.g., an off-road terrain). In embodiments, controller 50 may receive inputs from one or more of a steering system 64, braking system 78, prime mover 66, operator interface 62, or sensors 80. In embodiments, controller 50 may make a single determination of a terrain type (e.g., smooth terrain or rough terrain) based upon one subsystem (e.g., steering system 64, braking system 78, prime mover 66, operator interface 62, or sensors 80) and adjust one or more of shock absorbers 290, 292, 294, 296 and one or more of links 282a, 282b, 322a, 322b according to the terrain type. In embodiments, controller 50 may make two determinations of a terrain type (e.g., smooth terrain or rough terrain) based upon a plurality of subsystems (e.g., steering system 64, braking system 78, prime mover 66, operator interface 62, or sensors 80) and adjust one or more of shock absorbers 290, 292, 294, 296 and one or more of links 282a, 282b, 322a, 322b according to the terrain type. In embodiments, controller 50 may make three determinations of a terrain type (e.g., smooth terrain or rough terrain) based upon a plurality of subsystems (e.g., steering system 64, braking system 78, prime mover 66, operator interface 62, or sensors 80) and adjust one or more of shock absorbers 290, 292, 294, 296 and one or more of links 282a, 282b, 322a, 322b according to the terrain type. In embodiments, controller 50 may make four or more determinations of a terrain type (e.g., smooth terrain or rough terrain) based upon a plurality of subsystems (e.g., steering system 64, braking system 78, prime mover 66, operator interface 62, or sensors 80) and adjust one or more of shock absorbers 290, 292, 294, 296 and one or more of links 282a, 282b, 322a, 322b according to the terrain type.

In embodiments, controller 50 may monitor sensors 80 for a frequency characteristic and controller 50 may compare the frequency characteristic against known data tables to determine a type of terrain being traversed by vehicle 200. In embodiments, controller 50 may monitor one or more steering sensors of a steering assembly 64 to determine torque spikes within the steering system and upon a predetermined number of torque spikes occurring within a predetermined time period, controller 50 may determine a type of terrain being traversed by vehicle 200. In embodiments, a greater number of torque spikes may indicate a rough terrain. In embodiments, controller 50 may monitor a wheel speed sensor for measuring wheel acceleration events and counting the numbering of wheel acceleration events. The controller 50 may then determine a type of terrain being traversed by vehicle 200 based upon the number of wheel acceleration events. In embodiments, a greater number of wheel acceleration events may indicate a rough terrain. Additional details regarding terrain detection may be found in PCT Application No. PCT/US2024/012271, filed Jan. 19, 2024, titled TERRAIN DETECTION AND METHODS OF USE THEREOF, the entire disclosure of which is expressly incorporated by reference herein.

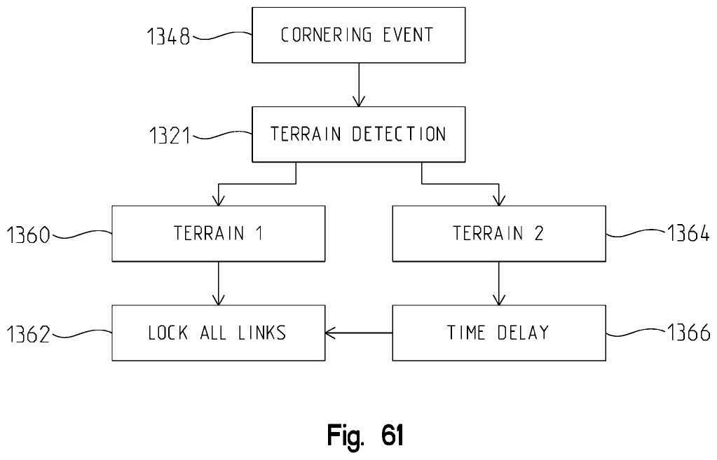

Referring now to FIG. 61, controller 50 may determine a terrain type, as indicated in block 1321, and in response to the terrain type, alter one or more of links 282a, 282b, 322a, 322b based upon the terrain type. In embodiments, controller 50 is operable to determine that vehicle 200 is traversing a first terrain (e.g., a smooth terrain) as indicated by block 1360. In embodiments, controller 50 is operable to lock each of links 282a, 282b, 322a, 322b, as indicated by block 1362 in response to the controller 50 determining that vehicle 200 is traversing the first terrain (e.g., a smooth terrain) during a cornering event. In embodiments, controller 50 is operable to determine that vehicle 200 is traversing a second terrain (e.g., a rough terrain) as indicated by block 1364. In embodiments, controller 50 is operable to lock each of links 282a, 282b, 322a, 322b, as indicated by block 1362, after a time delay 1366 in response to the controller 50 determining that vehicle 200 is traversing the second terrain (e.g., a rough terrain) during a cornering event. In embodiments, the time delay 1366 is 0.5 seconds, 1 second, 2 seconds, or a different amount of time.

In embodiments, controller 50 may adjust thresholds 1348, 1350 of graph 1340 in response to a determined terrain type. In embodiments, in a first terrain type (e.g., a smooth terrain), threshold 1350 may be lowered such that at least one of stabilizer bars 282a, 282b, 322a, 322b is adjusted in response to a lower predicted lateral acceleration when vehicle 200 is traversing a smooth terrain. In embodiments, in a second terrain type (e.g., a rough terrain), threshold 1350 may be increased such that at least one of stabilizer bars 282a, 282b, 322a, 322b is adjusted in response to a higher predicted lateral acceleration when vehicle 200 is traversing a rough terrain.

In embodiments, curve 1346 of cornering model or graph 1340 may be adjusted based upon the determined terrain type. In embodiments, in a first terrain type (e.g., a smooth terrain), curve 1346 may be steeper such that in response to a lower predicted lateral acceleration value on a smooth surface, controller 50 may adjust damping (e.g., increase damping relative to the second terrain type) to one or more of shock absorbers 290, 292, 294, 296. In embodiments, in a second terrain type (e.g., a rough terrain), curve 1346 may be shallower such that in response to a higher predicted lateral acceleration value on a rough surface, controller 50 may adjust damping (e.g., decrease damping relative to the first terrain type) to one or more of shock absorbers 290, 292, 294, 296.

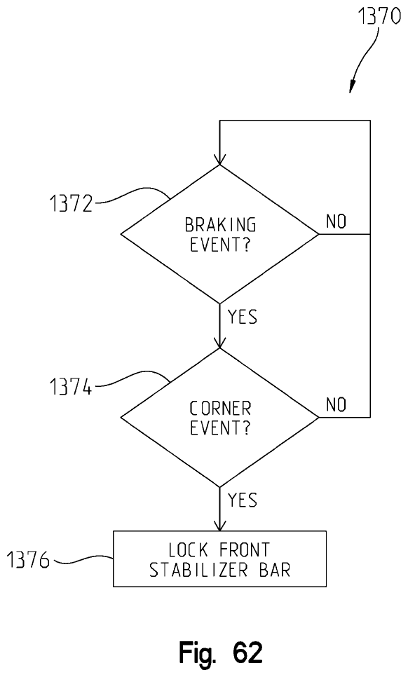

Referring now to FIG. 62, in embodiments, controller 50 may be operable to control one or more of shock absorbers 290, 292, 294, 296 and one or more of links 282a, 282b, 322a, 322b in response to a braking event. A braking event may be determined by longitudinal acceleration, predicted longitudinal acceleration, a brake sensor, an accelerometer, an IMU, or another sensor. In embodiments, controller 50 may operate vehicle according to a process 1370, and controller 50 may be operable to determine a braking event is occurring, as indicated by block 1372. If vehicle 200 is experiencing a braking event, controller 50 is operable to determine if vehicle 200 is in a cornering event (e.g., threshold 1348 (FIG. 58)) as indicated by block 1374. If vehicle 200 is not in a cornering event, controller 50 may not alter links 282a, 282b, 322a, 322b. If vehicle 200 is in a cornering event, controller may lock at least one of links 282a, 282b (i.e., the front stabilizer bar links) to lock the front stabilizer bar. That is, if vehicle 200 is in a cornering event and also in a braking event, controller 50 may automatically lock the front stabilizer bar 280. During a braking event and cornering event, it may be helpful to rigidify the front suspensions 266 to reduce or inhibit the front of vehicle 200 from diving into the corner.

Throughout the disclosure, the term “adjust” may be used to discuss controlling one or more damping characteristics or operating states of shock absorbers 290, 292, 294, 296 and links 282a, 282b, 322a, 322b. The term “adjust” may be used to mean changing between damping characteristics or operating states, or alternatively, maintaining the current damping characteristic or operating state as appropriate. That is, adjusting the shock absorbers 290, 292, 294, 296 and links 282a, 282b, 322a, 322b between operating states may include adjusting between a first operating state and a second operating state or may further include maintaining a current operating state, as appropriate. For example, during an airborne event it may be helpful to adjust one or more of links 282a, 282b, 322a, 322b to increase the ride and handling characteristics of the vehicle, and under certain conditions (e.g., FIGS. 37A-37D) controller 50 may be operable to “adjust” the one or more links 282a, 282b, 322a, 322b which may include altering the operating state of one or more links 282a, 282b, 322a, 322b from a first state (e.g., unlocked or semi-active) to a second state (e.g., locked) if the state should change to the second state and may also include maintaining the operating state of one or more links 282a, 282b, 322a, 322b in the current state (e.g., locked) if the state should remain the same. Current Control Strategy

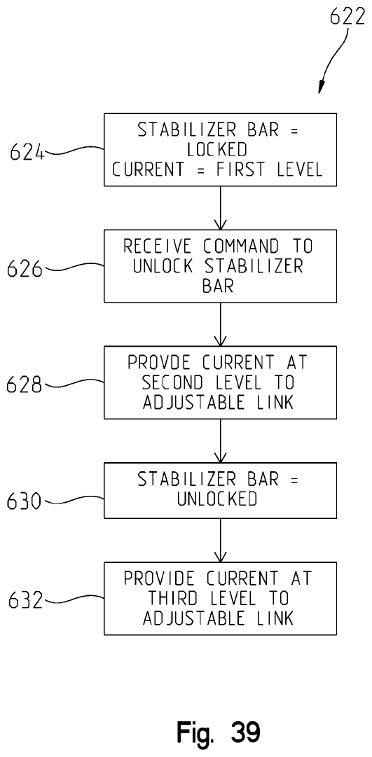

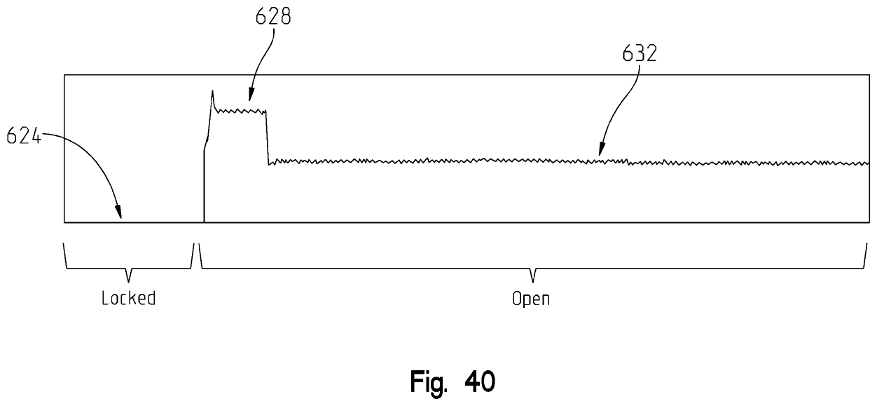

Referring now to FIGS. 39-40, power is provided to each of adjustable links 282a, 282b, 322a, 322b (i.e., in embodiments, adjustable shock absorber 1050). by a power source which may be a battery, an alternator, or a combination thereof. A current is supplied to the electronic bypass valve 1082 of adjustable shock 1050 to open and close the valve to control the adjustable shock absorber 1050 between an unlocked and locked state, respectively. In embodiments, when shock absorber 1050 is a locked condition, piston 1054 may be lodged, or otherwise ‘stuck’, or partially stuck, within body 1052. That is, while adjustable shock absorber 1050 is in a locked condition, piston 1054 is repeatedly being pushed outwardly toward full extension and may become ‘stuck’ in the full extension position. The more ‘stuck’ that piston 1054 is within body 1052, the greater amount of force required to alter the operating state (i.e., transition the valve 1082) of adjustable shock absorber 1050 from the locked state to the unlocked state and move piston 1054 in the unlocked condition (i.e., break the locked state and transition the valve 1082 from a locked state to an unlocked state and move piston 1054 in compression).

Referring to FIG. 39, controller 50 is configured to execute process 622 to alter the operating state of any of links 282a, 282b, 322a, 322b from a locked state to an unlocked state. Controller 50 is configured to provide a first current to links 282a, 282b, 322a, 322b when operating in a locked state in step 624. In a locked state, the first current is approximately zero (0) Amps due to the links operating in a steady-state configuration. Process 622 proceeds to step 626 and receives an indication from controller 50 to unlock one or more of links 282a, 282b, 322a, 322b. In response to the indication from the controller 50 in step 626, a second current is configured to be supplied in step 628 to one or more of the links 282a, 282b, 322a, 322b (i.e., whichever link is intended to be unlocked). The second current is a non-zero current and is configured to be sufficient to ‘break’ the locked state of piston 1054 and move piston 1054 in compression. Process 622 proceeds to step 630 and determines that adjustable shock absorber 1050 is unlocked, and in response to the adjustable shock absorber 1050 being unlocked in step 630, a third current is configured to be supplied in step 632 to one or more of the links 282a, 282b, 322a, 322b (i.e., whichever link is intended to be unlocked). In embodiments, the third current is less than the second current, and the third current is greater than the first current. In embodiments, the third current is the required amount of current to maintain electronically controlled bypass valve 1082 in the open, or unlocked condition.

In embodiments, the first current is approximately 0 Amps (A) is provided to electronically controlled bypass valve 1082 of adjustable shock absorber 1050. In embodiments, the second current is approximately 900 milliAmps (mA) and approximately 7 Watts (W) of power are provided to adjustable shock absorber 1050. In embodiments the third current is approximately 500 mA and approximately 2.15 W of power are provided to adjustable shock absorber 1050. The second current may be provided to adjustable shock absorber 1050 for a calibratable amount of time, for example, 200 milliseconds (ms), 100 ms, 300 ms, 400 ms, 500 ms, 1 second(s), or varying time intervals.

### User Interface

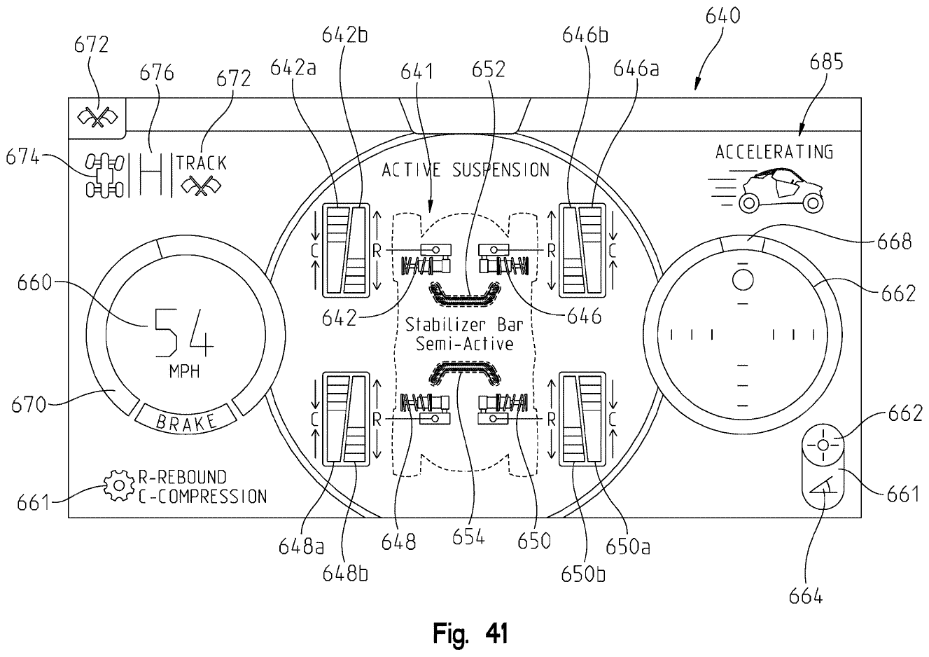

In embodiments, vehicle 200 includes a display 640 (may be similar or same as output device 44, display 546) configured to display one or more characteristics of any of left front electronically adjustable shock 290, right front electronically adjustable shock 292, left rear electronically adjustable shock 294, right rear electronically adjustable shock 296, front-left adjustable link 282a, front-right adjustable link 282b, rear-left adjustable link 322a, and rear-left adjustable link 322b. Referring to FIG. 41, display 640 is configured to display a vehicle 641 representative of vehicle 200. A first shock absorber 642 (representative of left front electronically adjustable shock 290) is shown with a first fillable bar 642a representative of a compression damping level of first shock absorber 642 and a second fillable bar 642b representative of a rebound damping level of first shock absorber 642. A second shock absorber 644 (representative of right front electronically adjustable shock 292) is shown with a first fillable bar 644a representative of a compression damping level of second shock absorber 644 and a second fillable bar 644b representative of a rebound damping level of second shock absorber 644. A third shock absorber 646 (representative of left rear electronically adjustable shock 294) is shown with a first fillable bar 646a representative of a compression damping level of third shock absorber 646 and a second fillable bar 646b representative of a rebound damping level of third shock absorber 646. A fourth shock absorber 648 (representative of right rear electronically adjustable shock 296) is shown with a first fillable bar 648a representative of a compression damping level of fourth shock absorber 648 and a second fillable bar 648b representative of a rebound damping level of fourth shock absorber 648.

In embodiments, display 640 is configured to show a first representative stabilizer bar 652 (representative of front stabilizer bar 280) and a second representative stabilizer bar 654 (representative of rear stabilizer bar 320) on vehicle 641.

In embodiments, display 640 is further configured to display a G-force indicator 662, a steering angle indicator 668, and a toggle 661 to switch between the G-force indicator 662 and an inclinometer 664. Display 640 is further configured to display a speed 660 (e.g., a speedometer), a brake input level 670, an operating mode 672, a driveline mode 674, a gear position 676, a fuel level (not shown), a heading indicator (not shown), an ambient temperature (not shown), and a time (or clock, not shown). In embodiments, an indicator 685 (FIG. 41) shows if vehicle 200 is entering a vehicle condition (e.g., accelerating, cornering, sliding, spinning, airborne, etc.) In embodiments, display 640 is configured to display a settings button 661 which will transition display 640 to one or more additional display screens where a user may adjust vehicle settings (e.g., stabilizer bars 280, 320).

Referring to FIGS. 41-45, display 640 is configured to dynamically display the compression damping and rebound damping level of each of shock absorbers 290, 292, 294, 296 (i.e., indicators 642, 644, 646, 648) and an operating state of front stabilizer bar 280 (i.e., indicator 652) and rear stabilizer bar 320 (i.e., indicator 654). Additional details regarding the display of compression and rebound damping levels of each of shock absorbers 290, 292, 294, 296 may be found in U.S. patent application Ser. No. 17/379,675, filed Jul. 19, 2021, titled ADJUSTABLE SUSPENSIONS AND VEHICLE OPERATION FOR OFF-ROAD RECREATIONAL VEHICLES, attorney docket no. PLR-15-29249.04P-US, the entire disclosure of which is expressly incorporated herein by reference.

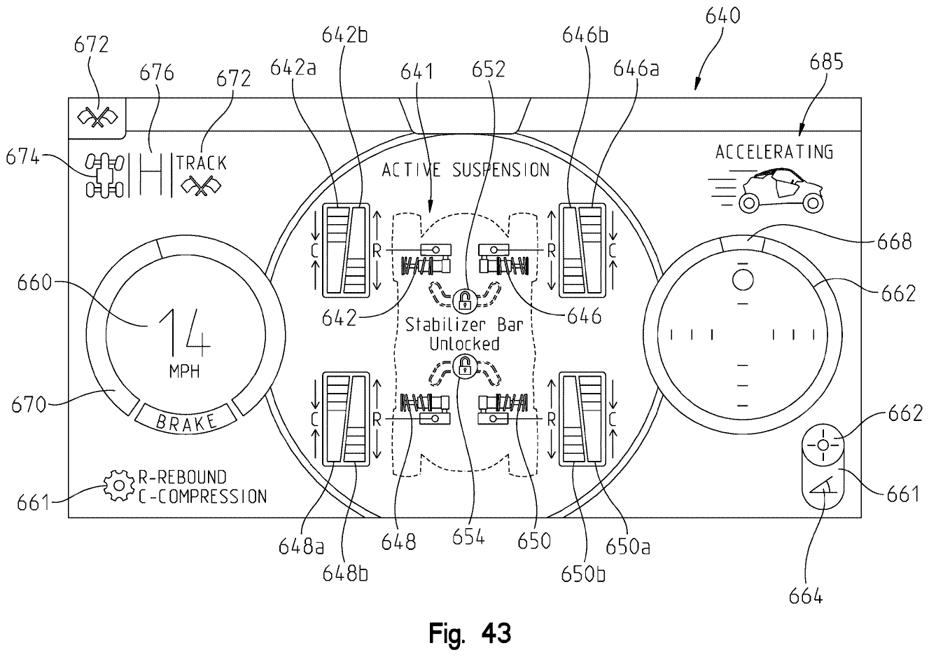

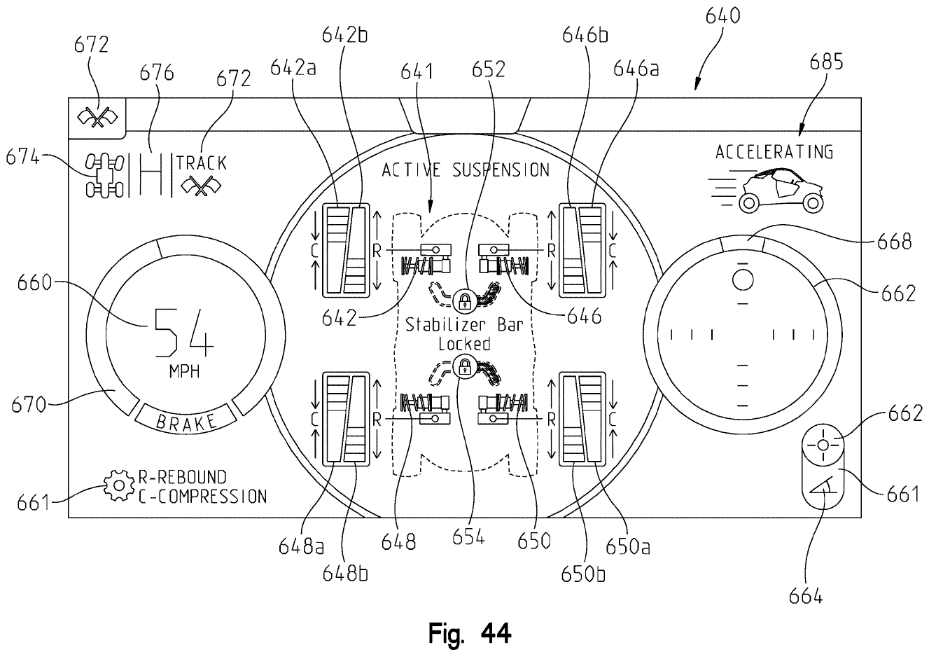

The operating state of front stabilizer bar 280 (i.e., indicator 652) and rear stabilizer bar 320 (i.e., indicator 654) may provide an unlocked indicator 656 (FIG. 43) and a locked indicator 658 (FIG. 44) to display when either stabilizer bar 280 (i.e., indicator 652) or stabilizer bar 320 (i.e., indicator 654) is in an unlocked or a locked state. In embodiments, when indicators 652, 654 do not have either of unlocked indicator 656 or locked indicator 658, stabilizer bars 280, 320 may be in the semi-active mode.

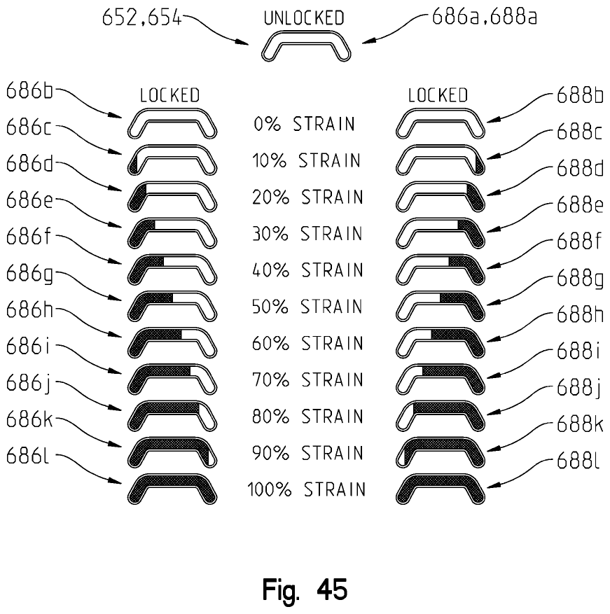

Referring to FIG. 45, each of front stabilizer bar 280 (i.e., indicator 652) and rear stabilizer bar 320 (i.e., indicator 654) may be colored with different shades to indicate an unlocked state or a locked state, and in the locked state, each of front stabilizer bar 280 (i.e., indicator 652) and rear stabilizer bar 320 (i.e., indicator 654) may be colored according to a gradient to provide a representative indication of a force (i.e., a strain placed on stabilizer bar 280, 320) on each of front stabilizer bar 280 (i.e., indicator 652) and rear stabilizer bar 320 (i.e., indicator 654). That is, as shown in FIG. 45, first profile 686a, 688a illustrates a stabilizer bar (e.g., stabilizer bar 280, 320) that is blank, or a first shade or color, and in an unlocked condition. In embodiments, the first profile 686a, 688a illustrates a stabilizer bar (e.g., stabilizer bar 280, 320) that is a transparent color. Further, each of profiles 686b-6861 and profiles 688b-688l illustrate a stabilizer bar that is a second shade or color (or gradient of colors) and in a locked condition. Each of profiles 686b-686l and 688b-688l illustrate a different shade/color gradient to illustrate a varied representative level of force placed on stabilizer bar 280, 320. In embodiments, profiles 686b-686l illustrate a gradient showing a first color moving from left-to-right as the amount of representative force increases. In embodiments, as the first color moves from left-to-right, the stabilizer bar has an increasing amount of strain which may be a result of the stabilizer bar twisting due to trailing arms vertically moving further apart relative to one another in a first direction of a first direction and a second direction (e.g., left trailing arm 300 moving upwardly relative to right trailing arm 300). In embodiments, profiles 688b-688l illustrate a gradient showing the first color moving from right-to-left as the amount of representative force increases. In embodiments, as the first color moves from right-to-left, the stabilizer bar has an increasing amount of strain which may be a result of the stabilizer bar twisting due to trailing arms vertically moving further apart relative to one another in a second direction of the first direction and the second direction (e.g., right trailing arm 300 moving upwardly relative to left trailing arm 300).

In embodiments, profile 686b, 688b is a stabilizer bar that is entirely a first color (different than the color of first profile 686a) indicating that stabilizer bar 280, 320 is in a locked state with minimum strain, or no strain, on stabilizer bar 280, 320. In embodiments, the first color is yellow. In another example, profile 686g is a stabilizer bar that is 50% a first color and 50% a second color, indicating a first representative force placed on stabilizer bar 280, 320. In embodiments, the second color is red. In another example, profile 686l is a stabilizer bar that is 100% the second color, indicating that stabilizer bar 280, 320 are experiencing a second representative force (i.e., stabilizer bars 280, 320 are vertically separated as far as possible).

In embodiments, controller 50 is configured to measure one or more of a longitudinal acceleration and a lateral acceleration and fill the profile of indicators 652, 654 to create a profile (e.g., profiles 686a-686l, 686a-688l) according to a strain map.

Referring to FIG. 41, each of front stabilizer bar 280 (i.e., indicator 652) and rear stabilizer bar 320 (i.e., indicator 654) are in the semi-active mode, and each of front stabilizer bar 280 and rear stabilizer bar 320 are shown in a locked (or partially locked) condition. That is, as shown in FIG. 41, each of front stabilizer bar 280 (i.e., indicator 652) and rear stabilizer bar 320 (i.e., indicator 654) are actively increasing the rigidity between front suspension 262 and rear suspension 264, respectively. In FIG. 41, each of indicators 652, 654 are indicating approximately 30% strain (i.e., profile 686e). In embodiments, indicators 652, 654 are configured to display different levels of strain.

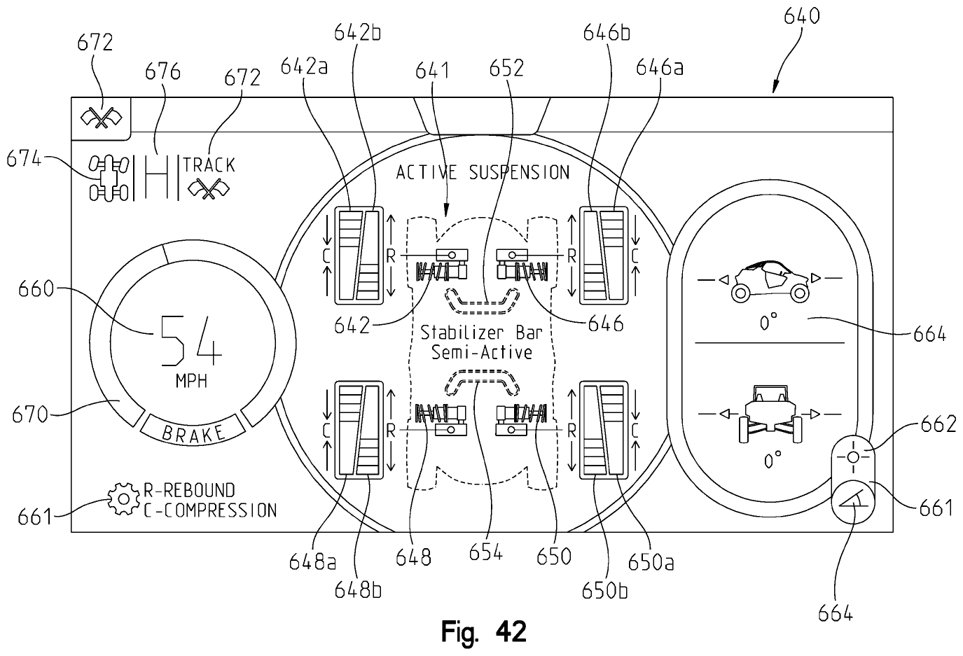

Referring to FIG. 42, each of front stabilizer bar 280 (i.e., indicator 652) and rear stabilizer bar 320 (i.e., indicator 654) are in the semi-active mode, and each of front stabilizer bar 280 and rear stabilizer bar 320 are shown in an unlocked condition.

Referring to FIG. 43, each of front stabilizer bar 280 (i.e., indicator 652) and rear stabilizer bar 320 (i.e., indicator 654) are in an unlocked state shown by indicator 656.

Referring to FIG. 44, each of front stabilizer bar 280 (i.e., indicator 652) and rear stabilizer bar 320 (i.e., indicator 654) are in a locked state shown by indicator 658. Further, because each of front stabilizer bar 280 and rear stabilizer bar 320 are in a locked state, indicators 652, 654 are configured to display the strain profile (e.g., 686a-686l, 688a-688l) associated with the stabilizer bar 280, 320, respectively. As shown in FIG. 44, each of front stabilizer bar 280 (i.e., indicator 652) and rear stabilizer bar 320 (i.e., indicator 654) are indicating approximately 30% strain (i.e., profile 686e).

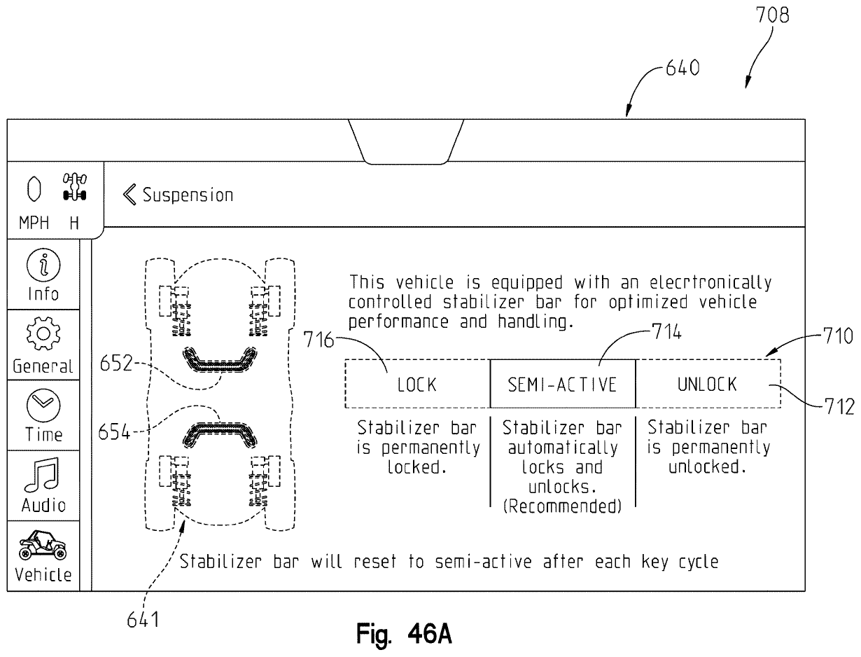

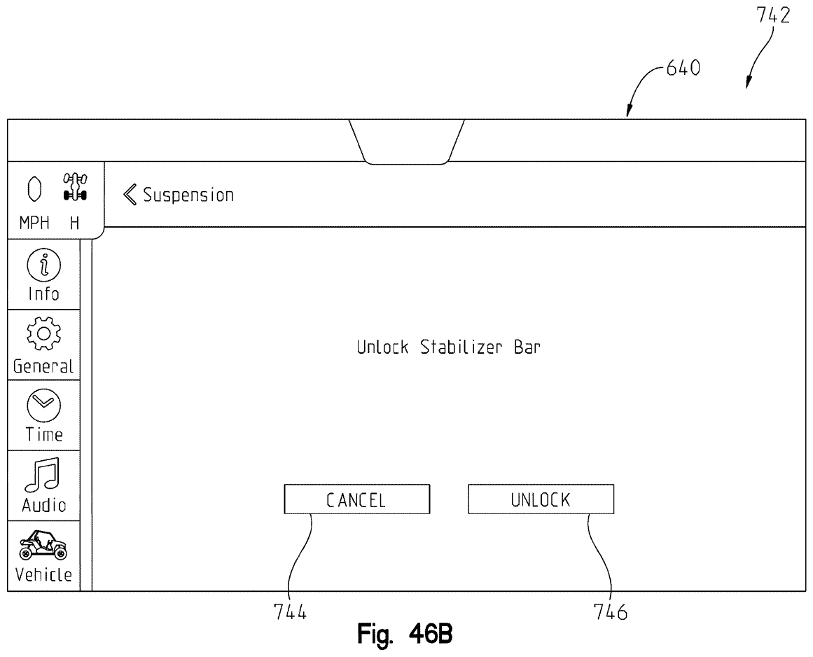

Referring to FIG. 46A, display 640 may be configured to show a first screen 708 which may be configured to show vehicle 641 along with each of stabilizer bar indicators 652, 654. Screen 708 is configured to provide a selection region 710 which includes a first portion 712, a second portion 714, and a third portion 716. Illustratively, each of portions 712, 714, 716 represent a selectable region for altering an operating mode of stabilizer bars 280, 320. In embodiments, first portion 712 is a selectable region to alter the stabilizer bar to the unlocked state, second portion 714 is a selectable region to alter the stabilizer bar to the semi-active state, and third portion 716 is a selectable region to alter the stabilizer bar to the locked state. In embodiments, the selected region of the regions 712, 714, 716 is shown as a highlighted portion, or otherwise discolored. In embodiments, each of the selectable portions 712, 714, 716 may include a description of what the selectable portion may be responsible for altering on the vehicle.

Referring now to FIG. 46B, display 640 may be configured to show a screen 742 in response to the first portion 712 being selected indicating an operators desire to alter the stabilizer bars to an unlocked state. Screen 742 includes a first input 744 and a second input 746 which may be selectable by an operator of the vehicle. First input 744 may be a ‘cancel’ button and represent the operators indicated desire to alter the stabilizer bars to an unlocked state, and based upon a selection of the first input 744 the controller 50 may provide instructions to not unlock stabilizer bars 280, 320 or may provide no instructions. Controller 50 may provide instructions to return display 640 to the first screen 708 in response to an operator selecting first input 744. Second input 746 may be a ‘unlock’ button or a ‘confirm’ button to validate that the operator desires to alter the stabilizer bars into an unlocked state. The screen 742 operates as a secondary confirmation page to ensure the user intends to unlock the stabilizer bars 280, 320. In embodiments, screen 742 may include an additional message (not shown) providing benefits and drawbacks of altering the stabilizer bars 280, 320 to an unlocked state.

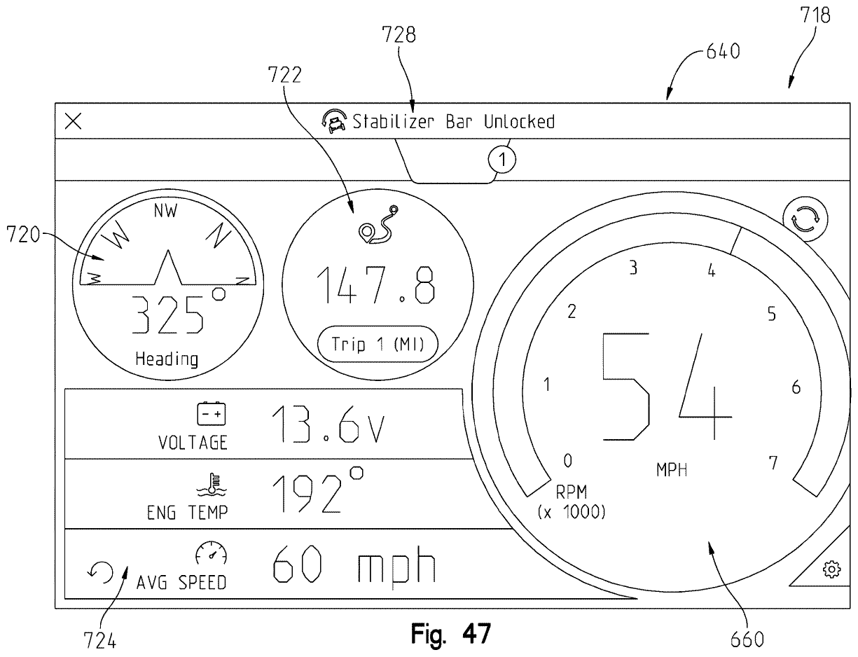

Referring to FIG. 47, display 640 may be configured to show a second screen 718 which may be a different display that does not show information related to the vehicle suspension (e.g., different than display 640 as shown in FIGS. 41-44).

Second screen 718 may include a speedometer 660, a heading indicator 720, an odometer 722, and related vehicle information 724 (e.g., battery voltage, engine temperature, average vehicle speed, etc.). In embodiments, second screen 718 is configured to provide a notification bar 726 indicating that the stabilizer bars 280, 320 are in the unlocked configuration. In embodiments, the notification bar 726 provides text such as “Stabilizer Bar Unlocked”. In embodiments, the notification bar 726 may be dismissed by providing a user input to the notification bar 726 (e.g., a press, a swipe, or the like). In embodiments, a press on the notification bar 726 may bring you to screen 708 to alter an operating condition of the stabilizer bars 280, 320. Second screen 718 may also display an icon 728 indicating that the stabilizer bars 280, 320 are in an unlocked configuration.

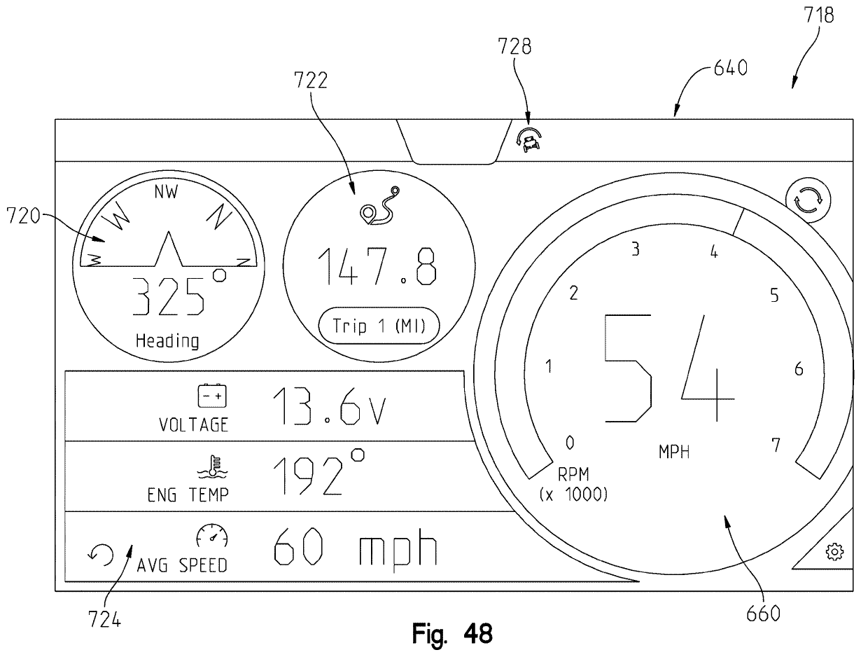

Referring now to FIG. 48, second screen 718 may be configured to replace the notification bar 726 with the icon 728 indicating that the stabilizer bars 280, 320 are in an unlocked configuration. That is, when display 640 does not show vehicle 641, display 640 is configured to show either notification bar 726 or icon 728.

### Dual Rate Coupler

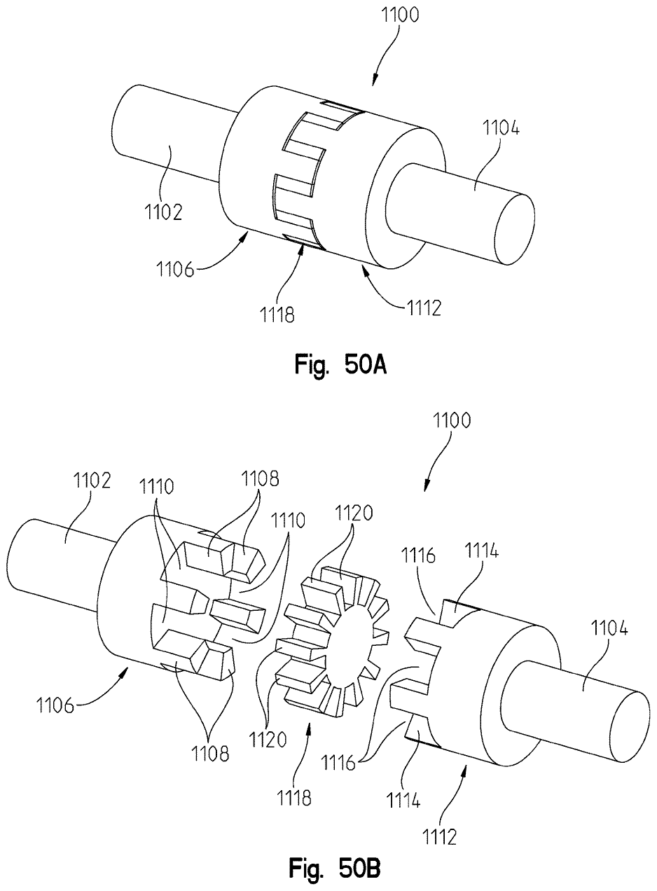

Referring now to FIGS. 50A-50B, in embodiments, stabilizer bar 280 or stabilizer bar 320 may include a coupler 1100. Coupler 1100 may include a first component 1106 rigidly coupled to a first stabilizer bar portion 1102 and a second component 1112 rigidly coupled to a second stabilizer bar portion 1104. In embodiments, first stabilizer bar portion 1102 is coupled to a drop link on a first side of vehicle 200 (e.g., link 322a on a left side of vehicle centerline 284) and second stabilizer bar portion 1104 is coupled to a drop link on a second side of vehicle 200 (e.g., link 322b on a right side of vehicle centerline 284). First component 1106 of coupler 1100 includes a plurality of teeth 1108 spaced apart to create spaces 1110. Second component 1112 of coupler 1100 includes a plurality of teeth 1114 spaced apart to create spaces 1116. An insert or torsional coupler 1118 may be coupled intermediate first component 1106 and second component 1112. Insert 1118 may be formed like a gear to have a plurality of teeth 1120. In embodiments, insert 1118 may sit intermediate first component 1106 and second component 1112 such that the plurality of teeth 1120 of insert 1118 sit between the teeth 1108 of first component 1106 and the teeth 1114 of second component 1112. In embodiments, insert 118 may be formed of a resilient material, such as a rubber, a composite, a silicone, or another deformable material.

Referring still to FIGS. 50A-50B, as rear suspension 264 articulates and each trailing arm 300 rotates relative to one another, the first stabilizer bar portion 1102 and second stabilizer bar portion 1104 are operable to rotate relative to each other, and therefore, first component 1106 of coupler 1100 and second component 1112 of coupler 1100 are operable to rotate relative to each other. Insert 1118 is operable to dampen the rotation of first component 1106 relative to second component 1112. Insert 1118 is formed of a resilient material and therefore is initially deformable under a predetermined force and continues to deform up to a certain amount of force at which point the insert 1118 no longer deforms and the coupler 1100 operates as a solid rotational link. That is, coupler 1100 operates as a dual rate rotational coupler to allow stabilizer bar 320 to operate according to two damping rates.

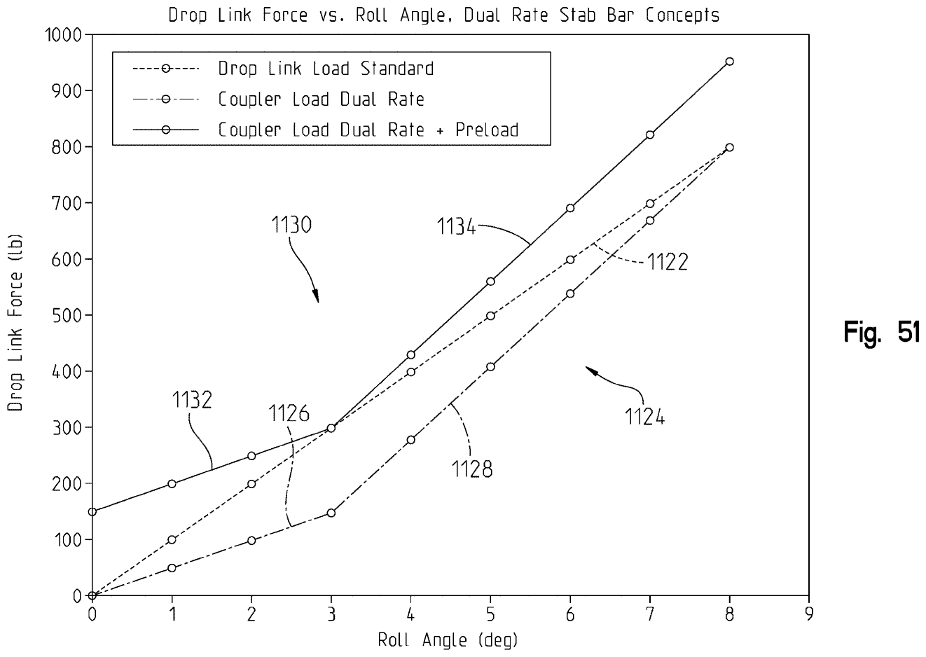

Referring now to FIG. 51, a theoretical comparison of the drop link force (either links 322a, 322b or dampers 294, 296) as a function of roll angle difference between the rear suspension 264. Curve 1122 represents a conventional stabilizer bar 320 with solid drop links 322. Curve 1122 is a linear curve. The slope of curve 1122 is based on the diameter of stabilizer bar 320 and is selected as a compromise between roll control and one or more detractors. Exemplary detractors include reduced ride comfort, reduced traction (cornering, acceleration, braking), increased head toss, reduced articulation, and increased durability requirements for mating components (e.g., bushings, bushing clamps, frame mounts, and control arms (e.g., trailing arms 300, control arms 302, 304)).

Curve 1124 represents the use of a damper with a coil over spring as one of the drop links (i.e., links 322a, 322b) for stabilizer bar 320. Curve 1124 includes a first linear component 1126 and a second linear component 1128. The slope of first linear component 1126 is based on a spring rate of a coil spring of the damper with a coil over spring and the diameter of stabilizer bar 320. The slope of second linear component 1128 is based on the diameter of stabilizer bar 320. Advantages, among others, of the lower slope of first linear component 1126 of curve 1124 for low roll angles (illustratively 0-3 degrees) compared to curve 1122 include improved ride comfort, compliance, traction, articulation of rear suspension 264, and head toss. The lower slope may result in reduced vehicle responsiveness compared to curve 1122. Advantages, among others, of the higher slope of second linear component 1128 of curve 1124 for higher roll angles (illustratively 3-8 degrees) compared to curve 1122 is it brings the characteristics of vehicle 200 closer to curve 1122 and to mimic the roll feel of solid links during harder cornering events and other high roll events.

Curve 1130 represents the use of coupler 1100 on stabilizer bar 320. Curve 1130 assumes that when trailing arms 300 are at the same height (no twisting of stabilizer bar 320) insert 1118 of coupler 1100 is positioned intermediate first component 1106 and second component 1112 such that coupler 1100 is preloaded (e.g., insert 1118 is partially compressed). This increases the initial force of coupler 1100 of stabilizer bar 320. Curve 1130 includes a first linear component 1132 and a second linear component 1134. The slope of first linear component 1132 is based on a spring rate of the resilient material of insert 1118 and the diameter of stabilizer bar 320. The slope of second linear component 1134 is based on the diameter of stabilizer bar 320. Advantages, among others, of the lower slope of first linear component 1132 of curve 1130 for low roll angles (illustratively 0-3 degrees) compared to curve 1122 include improved ride comfort, compliance, traction, articulation of rear suspension 264, and head toss. The preloading of insert 1118 maintains a responsiveness of vehicle 200. Advantages, among others, of the higher slope of second linear component 1134 of curve 1130 for higher roll angles (illustratively 3-8 degrees) manages the roll feel of vehicle 200 at higher roll angles.

### Jumper Harnesses

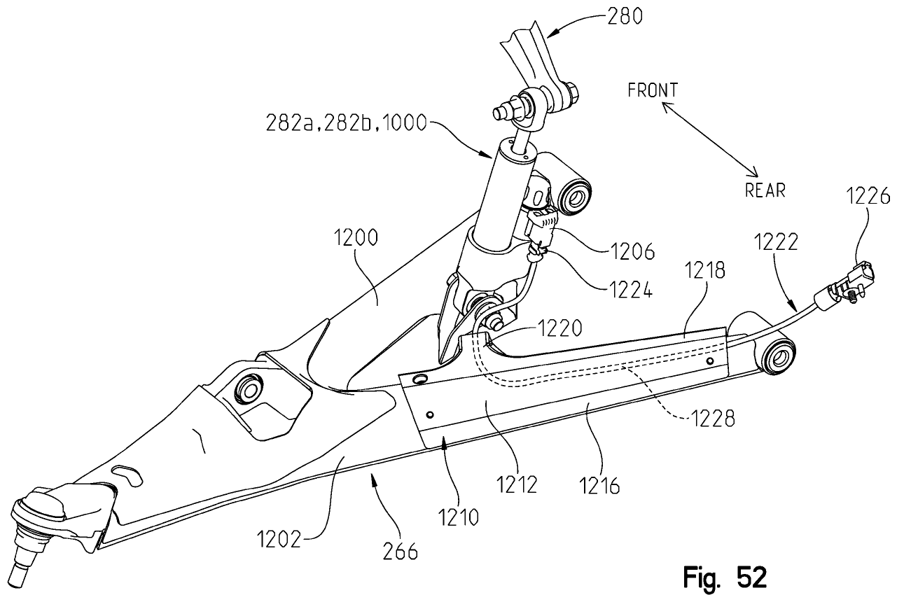

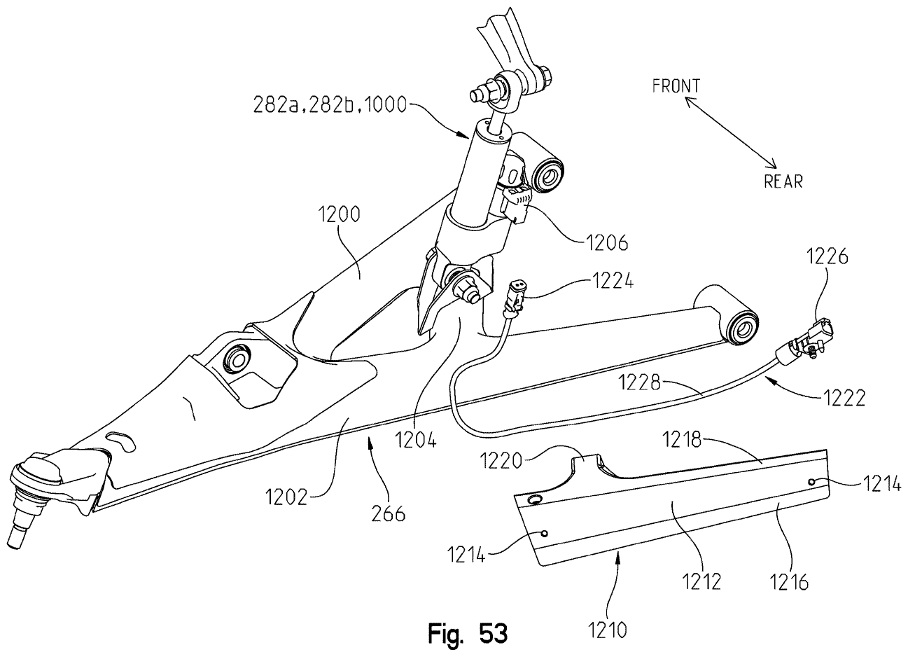

Referring now to FIGS. 52-53, a harness 1222 may be coupled between each of front links 282a, 282b and a central harness (not shown) which may be coupled to controller 50. Harness 1222 may include a first connector 1224, a second connector 1226, and an electrical wire 1228 coupled between the first connector 1224 and the second connector 1226. Control arm 266 includes a front arm 1200, a rear arm 1202, and a coupling arm 1204 extending between the front arm 1200 and rear arm 1202 to create a generally triangular structure. Front link 282a, 282b may be coupled between stabilizer bar 280 and control arm 266. Front link 282a, 282b may include a connection port 1206 positioned on a rearward side of front link 282a, 282b. A shield 1210 may include a first portion 1212 defining a plurality of apertures 1214, a first edge portion 1216 and a second edge portion 1218 positioned opposite the first edge portion 1216. The shield 1210 includes an extension portion 1220 positioned along second edge portion 1218. Shield 1210 may be placed on control arm 266 along rear arm 1202 such that first portion 1212 generally sits along a top surface of rear arm 1202 and a plurality of fasteners couple the shield 1210 to control arm 266. Extension 1220 extends over the coupling arm 1204. Shield 1210 creates a gap (not shown) which electrical wire 1228 can extend through. That is, connector 1224 couples to connection portion 1206 and electrical wire 1228 extends downwardly along link 282a, 282b, and through extension 1220 between shield 1210 and rear arm 1202 of control arm 266. Electrical wire 1228 extends along a bottom side of shield 1210 and continues inwardly toward a center of the vehicle (e.g., vehicle centerline plane 284 (FIG. 9)).

The arrangement of harness 1222 may act as a jumper harness extending outwardly to front link 282a, 282b from a central location (e.g., a harness junction (not shown) or controller 50). Harness 1222 may be more easily replaced in the event harness 1222 is damaged rather than if the harness 1222 is integral with the overall vehicle harness. Additionally, by placing connector 1224 on the rearward side of front link 282a, 282b, connector 1224 may be protected from sticks or debris and reduce the frequency of needing to replace connector 1224. Additionally, by placing electrical wire 1228 underneath shield 1210, electrical wire 1228 may be protected from debris, and may be held close to control arm 226 to prevent or mitigate electrical wire 1228 from snagging or catching on trees, bushes or other debris.

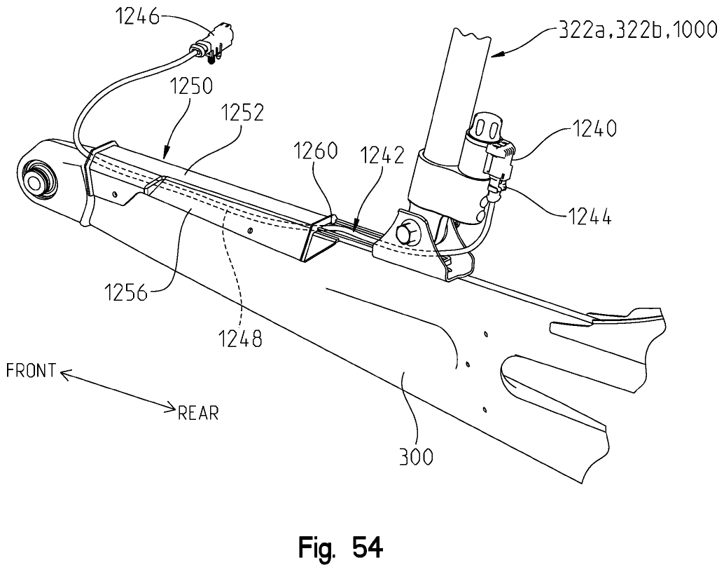

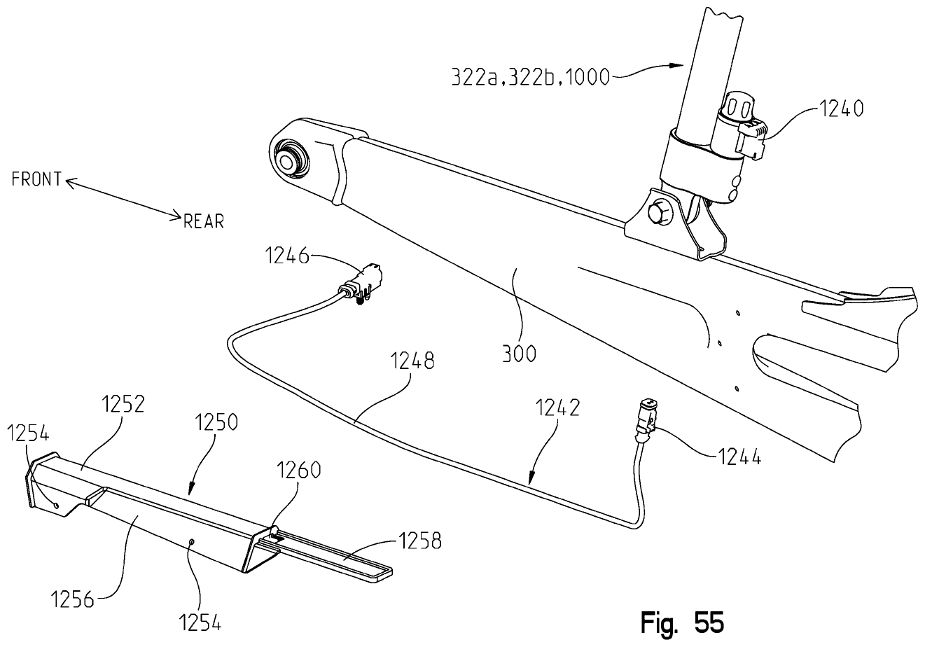

Referring now to FIGS. 54-55, a harness 1242 may be coupled between each of rear links 322a, 322b and a central harness (not shown) which may be coupled to controller 50. Harness 1242 may include a first connector 1244, a second connector 1246, and an electrical wire 1248 coupled between the first connector 1244 and the second connector 1246. Rear link 322a, 322b may be coupled between stabilizer bar 322 and trailing arm 300. Rear link 322a, 322b may include a connection port 1240 positioned on a rearward side of rear link 322a, 322b. A shield 1250 may include a first portion 1252 defining a plurality of apertures 1254, a first edge portion 1256 and a second edge portion (not shown) positioned opposite the first edge portion 1256. Shield 1250 includes a tongue portion 1258 extending generally longitudinally rearwardly from first portion 1252. Tongue portion 1258 defines an aperture 1260. Shield 1250 may be placed on trailing arm 300 such that first portion 1252 generally sits along a top surface of trailing arm 300 and a plurality of fasteners couple the shield 1250 to trailing arm 300. Shield 1250 creates a gap (not shown) which electrical wire 1248 can extend through. That is, connector 1244 couples to connection port 1240 and electrical wire 1248 extends downwardly along link 322a, 322b, and through aperture 1260 and between shield 1250 and trailing arm 300. Electrical wire 1248 extends along a bottom side of shield 1250 and continues inwardly toward a center of the vehicle (e.g., vehicle centerline plane 284 (FIG. 9)).

The arrangement of harness 1242 may act as a jumper harness extending outwardly to rear link 322a, 322b from a central location (e.g., a harness junction (not shown) or controller 50). Harness 1242 may be more easily replaced in the event harness 1242 is damaged rather than if the harness 1242 is integral with the overall vehicle harness. Additionally, by placing connector 1244 on the rearward side of rear link 322a, 322b, connector 1244 may be protected from sticks or debris and reduce the frequency of needing to replace connector 1244. Additionally, by placing electrical wire 1248 underneath shield 1250, electrical wire 1248 may be protected from debris, and may be held close to trailing arm 300 to prevent or mitigate electrical wire 1248 from snagging or catching on trees, bushes or other debris.

In embodiments, one or more of harness 1222, 1242 may include an electrical wire (not shown) for a wheel speed sensor (not shown). The wheel speed sensor may be coupled to a wheel end to measure a rotational speed of the wheels 202. In embodiments, one or more of harness 1222, 1242 may follow a brake line coupled to one or more brakes of vehicle 200.

### Travel Stoppers

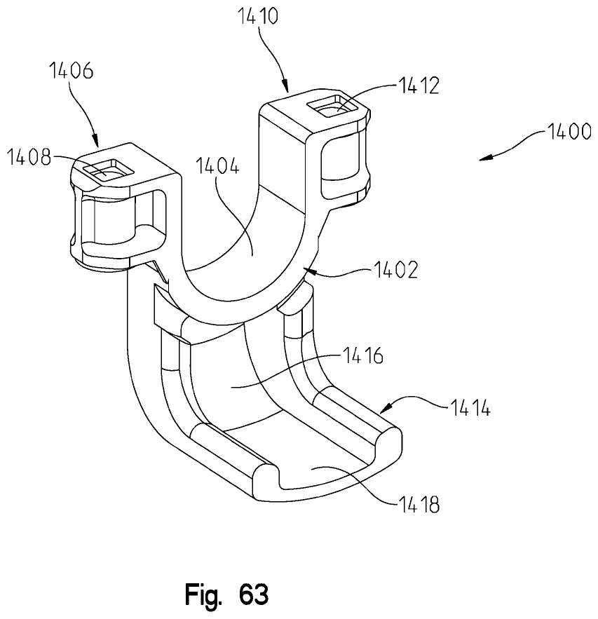

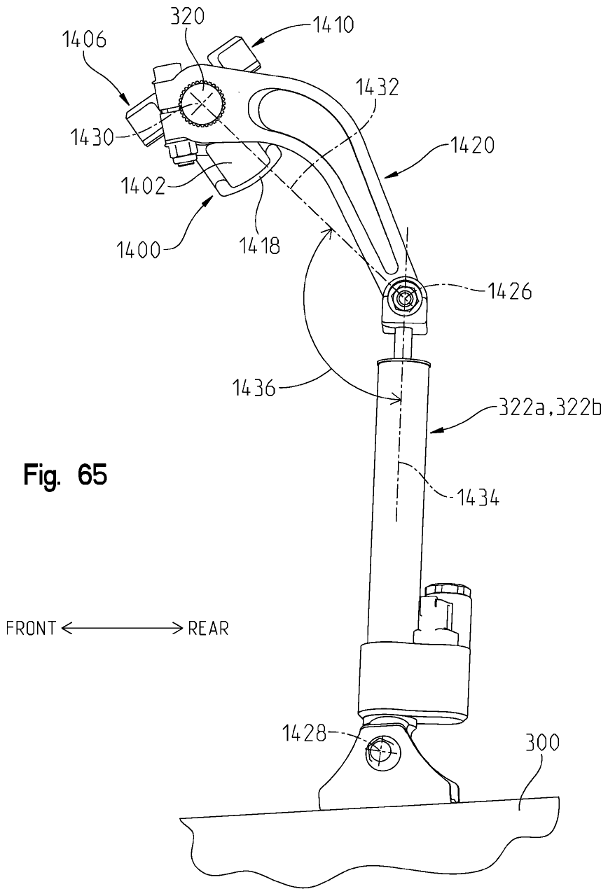

Referring now to FIGS. 63-65, a stopper 1400 includes a body 1402 defining a recess 1404. In embodiments, stopper 1400 is operable to surround rear stabilizer bar 320 such that rear stabilizer bar 320 sits within recess 1404. In embodiments, stopper 1400 may be integral with mounts 321. In embodiments, stopper 1400 is positioned adjacent mounts 321 and coupled to the vehicle frame (e.g., mid-frame portion 253). Stopper 1400 includes a first arm portion 1406 defining a first aperture 1408 and positioned on a first side of recess 1404 and a second arm portion 1410 defining a second aperture 1410 and positioned on a second side of recess 1404 opposite the first side. Stopper 1400 also includes an elbow portion 1414 extending downwardly from recess 1404 (i.e., downwardly from where stabilizer bar 320 is located). Elbow portion 1414 defines a first portion 1416 extending generally downwardly and a second portion 1418 extending generally horizontally outwardly from the first portion 1416. That is, elbow portion 1414 is generally a right angle bracket.

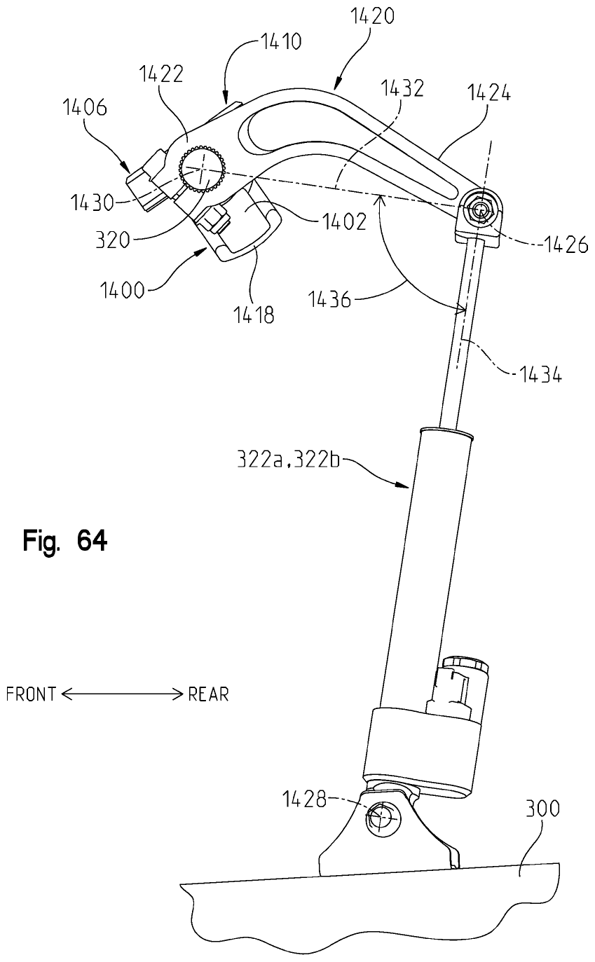

Referring now to FIGS. 63-64, a coupling link 1420 defines a first end 1422 and a second end 1424. The stopper 1400 is fixed relative to stabilizer bar 320 such that stabilizer bar 320, link 322a, 322b, and coupling link 1420 may move and rotate relative to stopper 1400. Coupling link 1420 is fixedly coupled to stabilizer bar 320 such that coupling link 1420 rotates with stabilizer bar 320 about a first rotation axis 1430. Further, coupling link 1420 is rotatably coupled to link 322a, 322b about a second rotation axis 1426, and link 322a, 322b is rotatably coupled to trailing arm 300 about a third rotation axis 1428. Trailing arm 300 moves upwardly and downwardly, and link 322a, 322b moves upwardly and downwardly with trailing arm 300. In embodiments, as previously disclosed, link 322a, 322b is a solid bar and moves upwardly and downwardly with trailing arm 300. In embodiments, as previously disclosed, link 322a, 322b is a shock absorber with a variable length and the length of link 322a, 322b is adjusted as trailing arm 300 moves upwardly and downwardly. As trailing arm 300 and link 322a, 322b move upwardly and downwardly, coupling link 1420 is rotated upwardly and downwardly, respectively, and stabilizer bar 320 is also rotated with coupling link 1420.

Referring still to FIGS. 63-64, a first axis 1432 extends through first rotation axis 1430 and second rotation axis 1426 and a second axis 1434 extends through second rotation axis 1426 and third rotation axis 1428. An angle 1436 is defined between the first axis 1432 and the second axis 1434. As trailing arm 300 moves upwardly and downwardly, link 322a, 322b and coupling link 1420 move and alter the angle 1436. In embodiments, angle 1436 may become too large such that the link 322a, 322b may toggle, or otherwise swing out of compliance. That is, if angle 1436 is greater than, for example, 180 degrees, link 322 a, 322 b may be prone to swing further toward the front of vehicle 200 which may inhibit or reduce the effectiveness of stabilizer bar 320 or cause portions of stabilizer bar 320, coupling link 1420, links 322a, 322b, or trailing arm 300 to break or otherwise deteriorate. In embodiments, if link 322a, 322b swings forward such that angle 1436 is greater than 180 degrees, link 322 a, 322 b may be prone to ‘toggle’and be positioned outside of a predetermined packaging volume.

Stopper 1400 is coupled to one of frame (e.g., mid-frame portion 253) or mounts 321 and positioned such that a range of motion of coupling link 1420 is reduced. That is, as seen in FIG. 64, stopper 1400 is positioned on a bottom side of stabilizer bar 320 such that coupling link 1420 may be prohibited from moving freely in the downward direction once angle 1436 reaches a certain value. In embodiments, as coupling link 1420 moves downwardly, coupling link 1420 will contact, or be stopped by, second portion 1418 of stopper 1400. In embodiments, the maximum value of angle 1436 is approximately 105 degrees. In embodiments, the maximum value of angle 1436 is approximately 120 degrees. In embodiments, the maximum value of angle 1436 is approximately 135 degrees. In embodiments, the maximum value of angle 1436 is less than 180 degrees. In embodiments, the maximum value of angle 1436 is between 90-180 degrees.

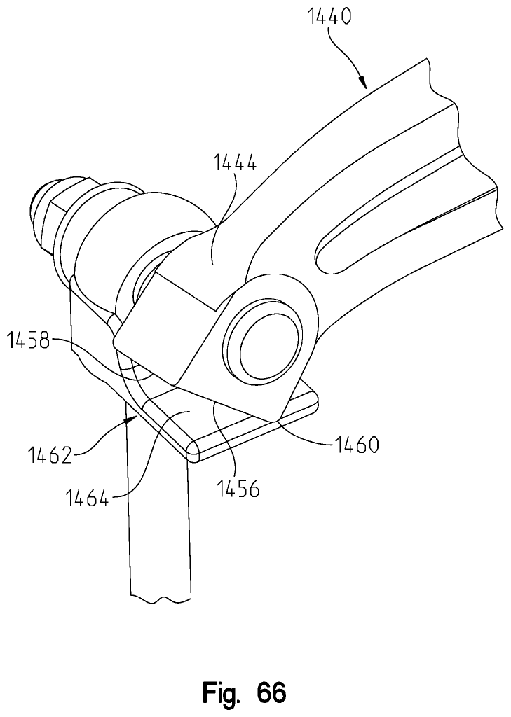

Referring now to FIGS. 66-68, an alternative coupling link 1440 may be coupled between links 322a, 322b and stabilizer bar 320. Alternative coupling link 1440 includes a first end 1442 fixedly coupled to stabilizer bar 320 and a second end 1444 rotatably coupled to link 322a, 322b. Second end 1444 includes a face 1456 defining a first corner 1458 and a second corner 1460. In embodiments, link 322a, 322b includes an upper portion 1462 defining a flange or link end stopper 1464 positioned vertically below second end 1444. Coupling link 1440 is fixedly coupled to stabilizer bar 320 such that coupling link 1440 rotates with stabilizer bar 320 about a first rotation axis 1446. Further, coupling link 1440 is rotatably coupled to link 322a, 322b about a second rotation axis 1448, and link 322a, 322b is rotatably coupled to trailing arm 300 about a third rotation axis 1450. Trailing arm 300 moves upwardly and downwardly, and link 322a, 322b moves upwardly and downwardly with trailing arm 300. In embodiments, as previously disclosed, link 322a, 322b is a solid bar and moves upwardly and downwardly with trailing arm 300. In embodiments, as previously disclosed, link 322a, 322b is a shock absorber with a variable length and the length of link 322a, 322b is adjusted as trailing arm 300 moves upwardly and downwardly. As trailing arm 300 and link 322a, 322b move upwardly and downwardly, coupling link 1440 is rotated upwardly and downwardly, respectively, and stabilizer bar 320 is also rotated with coupling link 1440.

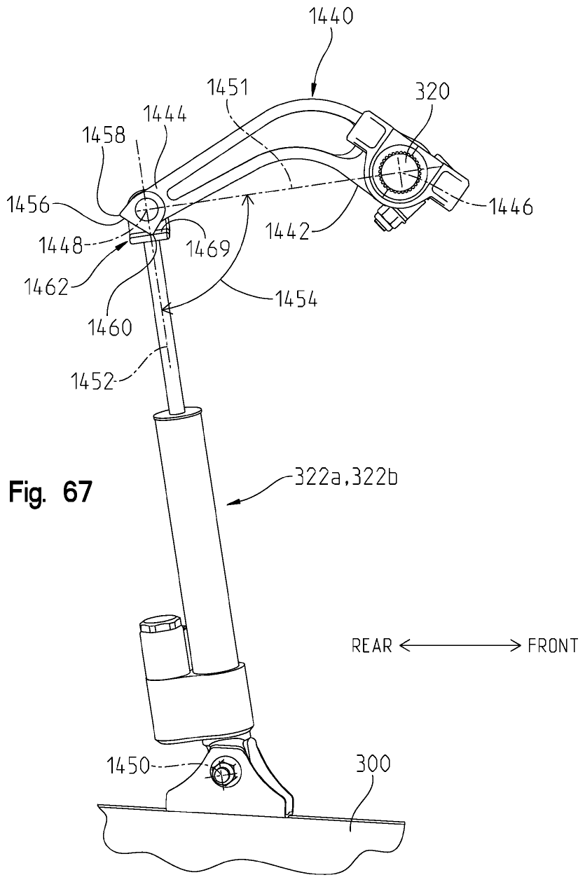

Referring now to FIGS. 67-69, a first axis 1451 extends through first rotation axis 1446 and second rotation axis 1448 and a second axis 1452 extends through second rotation axis 1448 and third rotation axis 1450. An angle 1454 is defined between the first axis 1451 and the second axis 1452. As trailing arm 300 moves upwardly and downwardly, link 322a, 322b and coupling link 1440 move and alter the angle 1454. In embodiments, angle 1454 may become too large such that the link 322a, 322b may toggle, or otherwise swing out of compliance. That is, if angle 1454 is greater than, for example, 180 degrees, link 322a, 322b may be prone to swing further toward the front of vehicle 200 which may inhibit or reduce the effectiveness of stabilizer bar 320 or cause portions of stabilizer bar 320, coupling link 1440, links 322a, 322b, or trailing arm 300 to break or otherwise deteriorate. In embodiments, if link 322a, 322b swings forward such that angle 1454 is greater than 180 degrees, link 322a, 322b may be prone to ‘toggle’and be positioned outside of a predetermined packaging volume.

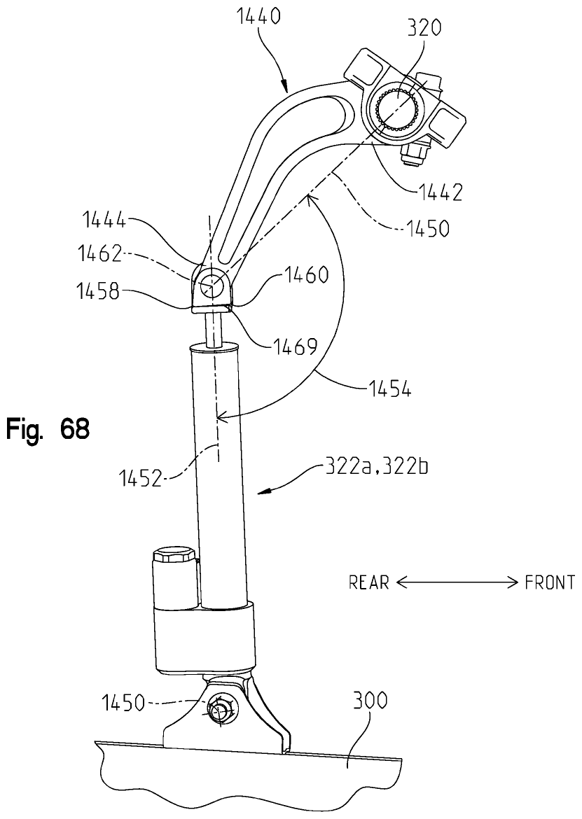

Referring still to FIGS. 67-68, as link 322a, 322b moves downwardly, coupling link 1440 is also rotated downwardly and second end 1444 rotates relative to upper portion 1462 of link 322a, 322b. Referring to FIG. 67, coupling link 1440 may rotate downwardly such that face 1456 rotates to contact flange 1464 and face 1456 may rotate no further. That is, coupling link has a rotational limit defined by the position at which face 1456 contacts, or is planar, with contact flange 1464. In embodiments, the rotational limit is defined by the position at which one of corners 1458, 1460 contacts flange 1464. In embodiments, the rotational limit of coupling link 1440 is such that the maximum value of angle 1454 is approximately 105 degrees. In embodiments, the maximum value of angle 1454 is approximately 120 degrees. In embodiments, the maximum value of angle 1454 is approximately 135 degrees. In embodiments, the maximum value of angle 1454 is less than 180 degrees. In embodiments, the maximum value of angle 1454 is between 90-180 degrees.

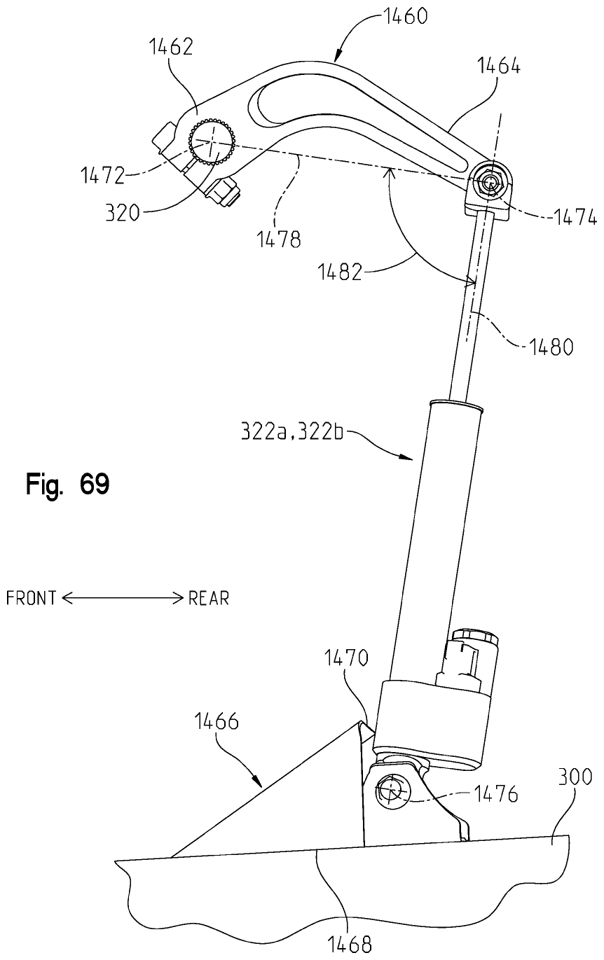

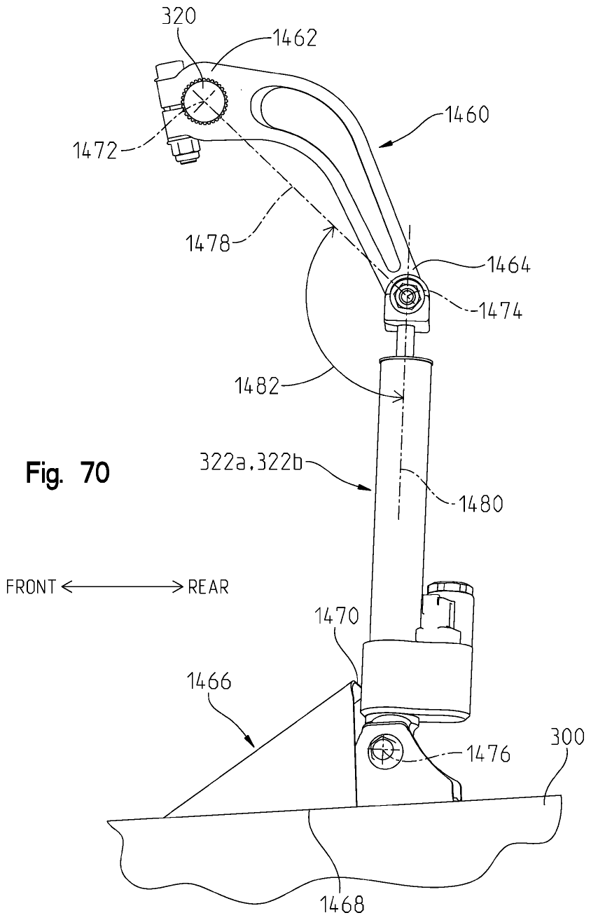

Referring now to FIG. 69-70, a stopper 1466 may be coupled to trailing arm 300. Stopper 1466 may be generally triangularly shaped and include a bottom surface 1468 coupled to trailing arm 300 and a rearward surface 1470 positioned adjacent link 322a, 322b. A coupling link 1460 may be positioned between stabilizer bar 320 and link 322a, 322b, and coupling link 1460 may define a first end 1462 and a second end 1464. The first end 1462 may be fixedly coupled to stabilizer bar 320 such that stabilizer bar 320 and coupling link 1460 rotate together. The second end 1464 may be rotatably coupled to link 322a, 322b. Coupling link 1460 is fixedly coupled to stabilizer bar 320 such that coupling link 1460 rotates with stabilizer bar 320 about a first rotation axis 1472. Further, coupling link 1460 is rotatably coupled to link 322a, 322b about a second rotation axis 1474, and link 322a, 322b is rotatably coupled to trailing arm 300 about a third rotation axis 1476. Trailing arm 300 moves upwardly and downwardly, and link 322a, 322b moves upwardly and downwardly with trailing arm 300. In embodiments, as previously disclosed, link 322a, 322b is a solid bar and moves upwardly and downwardly with trailing arm 300. In embodiments, as previously disclosed, link 322a, 322b is a shock absorber with a variable length and the length of link 322a, 322b is adjusted as trailing arm 300 moves upwardly and downwardly. As trailing arm 300 and link 322a, 322b move upwardly and downwardly, coupling link 1460 is rotated upwardly and downwardly, respectively, and stabilizer bar 320 is also rotated with coupling link 1460.

Referring still to FIGS. 69-70, a first axis 1478 extends through first rotation axis 1472 and second rotation axis 1474 and a second axis 1480 extends through second rotation axis 1474 and third rotation axis 1476. An angle 1482 is defined between the first axis 1478 and the second axis 1480. As trailing arm 300 moves upwardly and downwardly, link 322a, 322b and coupling link 1460 move and alter the angle 1482. In embodiments, angle 1482 may become too large such that the link 322a, 322b may toggle, or otherwise swing out of compliance. That is, if angle 1482 is greater than, for example, 180 degrees, link 322a, 322b may be prone to swing further toward the front of vehicle 200 which may inhibit or reduce the effectiveness of stabilizer bar 320 or cause portions of stabilizer bar 320, coupling link 1460, links 322a, 322b, or trailing arm 300 to break or otherwise deteriorate. In embodiments, if link 322a, 322b swings forward such that angle 1482 is greater than 180 degrees, link 322a, 322b may be prone to ‘toggle’and be positioned outside of a predetermined packaging volume.

Referring still to FIGS. 69-70, as link 322a, 322b moves downwardly, coupling link 1440 is also rotated downwardly and link 322a, 322b is prone to rotate generally forwardly toward the front of vehicle 200. Referring to FIG. 69, coupling link 1460 may rotate downwardly and link 322a, 322b may rotate forwardly such that link 322a, 322b contacts the rearward surface 1470 of stopper 1466. That is, link 322a, 322b has a rotational limit defined by the position at which link 322a, 322b contacts rearward surface 1470 of stopper 1466. In embodiments, the rotational limit of link 322a, 322b is such that the maximum value of angle 1482 is approximately 105 degrees. In embodiments, the maximum value of angle 1482 is approximately 120 degrees. In embodiments, the maximum value of angle 1482 is approximately 135 degrees. In embodiments, the maximum value of angle 1482 is less than 180 degrees. In embodiments, the maximum value of angle 1482 is between 90-180 degrees.

In embodiments, stopper 1466 is coupled to a forward side of link 322a, 322b such that when link 322a, 322b rotates forwardly, the bottom face 1468 of stopper 1466 contacts an upper surface of trailing arm 300 to limit the rotation of link 322a, 322b to a maximum value of angle 1482, as previously described.

In embodiments, vehicle 200 may use one or more of stopper 1400, link end stopper 1464, or stopper 1466. In embodiments, both a driver and passenger side trailing arm 300 may use one or more of stopper 1400, link end stopper 1464, or stopper 1466.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members;
a frame supported by the plurality of ground engaging members;
a prime mover supported by the frame, the prime mover operably coupled to at least one of the plurality of ground engaging members, and the prime mover operable in an a first operating condition and a second operating condition;
a first suspension coupled between at least one of the plurality of ground engaging members and the frame;
a stabilizer bar coupled between the first suspension and the frame, the stabilizer bar operable in a first stabilizer bar operating state and a second stabilizer bar operating state;
a controller configured to operate the prime mover between the first operating condition and the second operating condition and operate the stabilizer bar between the first stabilizer bar operating state and the second stabilizer bar operating state; and
the controller configured to alter the stabilizer bar from the first stabilizer bar operating state to the second stabilizer bar operating state in response to the controller changing the prime mover between the first operating condition and the second operating condition.

2. The vehicle of claim 1, wherein the first operating condition is a vehicle OFF-condition and the second operating condition is a vehicle ON-condition.

3. The vehicle of claim 2, wherein the first stabilizer bar operating state is an unlocked condition.

4. The vehicle of claim 1, wherein the first operating condition is a vehicle ON-condition and the second operating condition is a vehicle OFF-condition.

5. The vehicle of claim 4, wherein the second stabilizer bar operating state is one of a semi-active condition or a locked condition.

6. The vehicle of claim 1, wherein the stabilizer bar is a first stabilizer bar; the vehicle further comprising a second suspension coupled between at least one of the plurality of ground engaging members and the frame, and a second stabilizer bar coupled between the second suspension and the frame, the second stabilizer bar operable between the first stabilizer bar operating state and the second stabilizer bar operating state.

7. The vehicle of claim 6, wherein the controller is configured to alter the second stabilizer bar from the first stabilizer bar operating state to the second stabilizer bar operating state in response to the controller changing the vehicle between the first operating condition and the second operating condition.

8. The vehicle of claim 1, wherein the stabilizer bar comprises an adjustable link operably coupled to the first suspension, and the adjustable link is operable between a locked link state and an unlocked link state.

9. The vehicle of claim 8, wherein the first operating condition is a vehicle OFF-condition and the second operating condition is a vehicle ON-condition.

10. The vehicle of claim 9, wherein the first stabilizer bar operating state is associated with the adjustable link operating in the unlocked link state.

11. The vehicle of claim 8, wherein the first operating condition is a vehicle ON-condition and the second operating condition is a vehicle OFF-condition.

12. The vehicle of claim 11, wherein the second stabilizer bar operating state is associated with the adjustable link operating in the locked link state.

13. A method of controlling a suspension assembly for a vehicle, the method comprising:
providing a stabilizer bar configured to operate between a first stabilizer bar operating state and a second stabilizer bar operating state;
providing a prime mover configured to operate between a first operating condition and a second operating condition;
providing a controller configured to operate the prime mover between the first operating condition and the second operating condition;
changing the prime mover from the first operating condition to the second operating condition; and
altering, in response to the changing, the stabilizer bar from the first stabilizer bar operating state to the second stabilizer bar operating state.

14. The method of claim 13, wherein the first stabilizer bar operating state is an unlocked state.

15. The vehicle of claim 13, wherein the first operating condition is a vehicle OFF-condition and the second operating condition is a vehicle ON-condition.

16. The vehicle of claim 15, wherein the first stabilizer bar operating state is an unlocked condition.

17. The vehicle of claim 13, wherein the first operating condition is a vehicle ON-condition and the second operating condition is a vehicle OFF-condition.

18-35. (canceled)

36. A vehicle, comprising:
a plurality of ground engaging members;
a frame supported by the plurality of ground engaging members;
a first suspension coupled between a first ground engaging member of the plurality of ground engaging members and the frame;
a second suspension coupled between a second ground engaging member of the plurality of ground engaging members and the frame, the first ground engaging member being on a first side of a centerline vertical plane of the vehicle and the second ground engaging member being on a second side of the centerline vertical plane of the vehicle, the second side being opposite the first side;
an adjustable stabilizer bar coupled to the first suspension on a first end and coupled to the second suspension on a second end, the adjustable stabilizer bar having a first configuration with a first stiffness and a second configuration with a second stiffness, the second stiffness being higher than the first stiffness;
an adjustable shock absorber coupled between the frame and the first suspension, the adjustable shock absorber having at least one adjustable damping characteristic;
at least one sensor supported by the frame;
a controller operably coupled to the adjustable shock absorber, the adjustable stabilizer bar, and the at least one sensor, the controller operable to determine a lateral acceleration of the vehicle based upon the at least one sensor; and
wherein in response to the controller determining a first lateral acceleration of the vehicle based on the at least one sensor, the controller is operable to adjust the at least one adjustable damping characteristic of the adjustable shock absorber to a first damping value and the adjustable stabilizer bar to the first configuration, and in response to the controller determining a second lateral acceleration based on the at least one sensor greater than the first lateral acceleration, the controller is operable to adjust the adjustable stabilizer bar to the second configuration.

37. The vehicle of claim 36, wherein the second configuration of the adjustable stabilizer bar is a locked configuration.

38. The vehicle of claim 36, wherein the first configuration of the adjustable stabilizer bar is an unlocked configuration.

39. The vehicle of claim 36, wherein the lateral acceleration of the vehicle is a predicted lateral acceleration of the vehicle.

40. The vehicle of claim 39, wherein the predicted lateral acceleration of the vehicle is determined based upon a steering sensor.

41. The vehicle of claim 39, wherein the predicted lateral acceleration of the vehicle is determined based upon a yaw sensor.

42. (canceled)

43. The vehicle of claim 36, wherein the first suspension is a front suspension and the adjustable stabilizer bar is a front adjustable stabilizer bar, and further comprising:
a third suspension coupled between a third ground engaging member of the plurality of ground engaging members and the frame, the third suspension being a rear suspension;
a fourth suspension coupled between a fourth ground engaging member of the plurality of ground engaging members and the frame, the third ground engaging member being on the first side of the centerline vertical plane of the vehicle and the fourth ground engaging member being on the second side of the centerline vertical plane of the vehicle; and
a rear adjustable stabilizer bar coupled to the third suspension on a first end and coupled to the fourth suspension on a second end, the rear adjustable stabilizer bar having a first configuration with a first stiffness and a second configuration with a second stiffness, the second stiffness being higher than the first stiffness, and in response to the controller determining the second lateral acceleration, the controller is operable to adjust the rear adjustable stabilizer bar to the second configuration.

44-45. (canceled)

46. The vehicle of claim 43, wherein at a first time the controller is operable to adjust the front adjustable stabilizer bar to the second configuration of the front adjustable stabilizer bar and at a second time subsequent to the first time, the controller is operable to adjust the rear adjustable stabilizer bar to the second configuration of the rear adjustable stabilizer bar.

47. The vehicle of claim 46, wherein the second configuration of the front adjustable stabilizer bar is a locked configuration and the second configuration of the rear adjustable stabilizer bar is a locked configuration.

48. The vehicle of claim 46, wherein the second time is separated from the first time by a time delay, and a duration of the time delay is based upon a vehicle speed.

49-88. (canceled)
